(19) United States
(12) Patent Application Publication
(10) Pub. No.: US 2026/0072250 A1
(43) Pub. Date: Mar. 12, 2026

(54) OPTICAL SYSTEM AND CAMERA MODULE

(71) Applicant: LG INNOTEK CO., LTD., Seoul (KR)

(72) Inventors: Ju Yong SHIM, Seoul (KR); Chang Gyun SON, Seoul (KR)

(21) Appl. No.: 19/107,894

(22) PCT Filed: Sep. 4, 2023
(86) PCT No.: PCT/KR2023/013181

§ 371 Date: Feb. 28, 2025

(30) Foreign Application Priority Data
Sep. 2, 2022 (KR) 10-2022-0111546

(51) Int. Cl. G02B 13/00; G02B 1/04; G02B 3/00; G02B 7/02; G02B 9/64; H04N 23/55

(52) U.S. Cl. CPC G02B 13/0045; G02B 1/041; G02B 7/025; G02B 9/64; G02B 13/006; H04N 23/55; G02B 2003/0093

(57) ABSTRACT

The optical system disclosed in the embodiment of the invention includes first to seventh lenses aligned along an optical axis from an object side toward a sensor side, wherein the refractive power of the first lens is negative, a composite refractive power of the third to seventh lenses is positive, the first lens has a meniscus shape convex toward the sensor side on the optical axis, a center thickness of the first lens is larger than a center thickness of each of the second to seventh lenses, the first to seventh lenses include a plurality of spherical lenses and a plurality of aspherical lenses, wherein the spherical lenses are lenses whose object-side surface and the sensor-side surface are spherical, and the aspherical lenses are lenses whose object-side surface and the sensor-side surface are aspherical, and at least one of the plurality of aspherical lenses may be made of a different material from the spherical lens.

### TECHNICAL FIELD

An embodiment of the invention relates to an optical system for improved optical performance and a camera module including the same.

### BACKGROUND ART

ADAS (Advanced Driving Assistance System) is an advanced driver assistance system for assisting the driver to drive and is composed of sensing the situation in front, determining the situation based on the sensed result, and controlling the behavior of the vehicle based on the situation determination. For example, the ADAS sensor device detects a vehicle ahead and recognizes a lane. Then, when the target lane or target speed and the target in front are determined, the vehicle's ESC (Electrical stability control), EMS (Engine management system), MDPS (Motor driven Power steering), etc. are controlled. Typically, ADAS may be implemented as an automatic parking system, a low-speed city driving assistance system, a blind spot warning system, and the like.

The sensor devices for sensing the forward situation in ADAS are a GPS sensor, a laser scanner, a front radar, and a lidar, and the most representative ones are cameras for filming the front, rear, and sides of a vehicle. These cameras may be placed outside or inside the vehicle to detect the surroundings of the vehicle. In addition, the cameras may be placed inside the vehicle to detect the situations of the driver and passengers. For example, the camera can photograph the driver at a location adjacent to the driver and detect the driver's health status, whether he or she is drowsy, whether he or she is drinking, etc. In addition, the camera can photograph the passenger at a location adjacent to the passenger and detect the passenger's sleep status, health status, etc., and provide the driver with information about the passenger.

In particular, the most important element for obtaining an image from a camera is the imaging lens that forms the image. Recently, interest in high-definition and high-resolution, etc., has been increasing, and research on an optical system including multiple lenses is being conducted to implement this. However, there is a problem that the characteristics of the optical system change when the camera is exposed to a harsh environment, such as high temperature, low temperature, moisture, or high humidity, outside or inside the vehicle. In this case, the camera has a problem that it is difficult to uniformly derive excellent optical characteristics and aberration characteristics. Therefore, new optical systems and cameras that can solve the above-described problems are required.

### DISCLOSURE

### Technical Problem

An embodiment may provide an optical system and a camera module in which glass lenses and plastic lenses are mixed. An embodiment provides an optical system and a camera module in which spherical lenses and aspherical lenses are mixed. An embodiment provides an optical system and a camera module having improved optical characteristics. An embodiment provides an optical system and a camera module having excellent optical performance in low-temperature to high-temperature environments. An embodiment provides an optical system and a camera module capable of preventing or minimizing changes in optical characteristics in various temperature ranges.

### Technical Solution

An optical system according to an embodiment of the invention comprises: first to seventh lenses aligned along an optical axis from an object side toward a sensor side, wherein a refractive power of the first lens is negative, a composite refractive power of the third to seventh lenses is positive, the first lens has a meniscus shape convex toward the sensor side on the optical axis, a center thickness of the first lens is greater than a center thickness of each of the second to seventh lenses, the first to seventh lenses comprise a plurality of spherical lenses and a plurality of aspherical lenses, the spherical lenses are lenses whose object-side and sensor-side surfaces are spherical, and the aspherical lenses are lenses whose object-side and sensor-side surfaces are aspherical, and at least one of the plurality of aspherical lenses may be made of a different material from the spherical lens.

According to an embodiment of the invention, a number of the spherical lenses may be at least twice a number of the aspherical lenses. At least one of the plurality of aspherical lenses may be made of the same glass material as the spherical lens, and at least one of the plurality of aspherical lenses may be made of a plastic material.

According to an embodiment of the invention, the first to sixth lenses may be made of glass, and the seventh lens may be made of plastic. The first to fifth lenses may be spherical lenses, and the sixth and seventh lenses may be aspherical lenses. An effective diameter of the first lens may be larger than effective diameters of the fourth to seventh lenses. An aperture stop may be arranged on a periphery between the second lens and the third lens. The sensor-side surface of the fourth lens and the object-side surface of the fifth lens may be bonded.

According to an embodiment of the invention, a center distance between an i-th lens and an i+1 lens is CGi, a center thickness of the i-th lens is CTi, and a value of CTi/CGi may be minimum when i is 6, and the value of CTi/CGi may be maximum when i is 1. The center thickness of the first lens may be larger than a sum of center thicknesses of two adjacent lenses among the second to seventh lenses.

An optical system according to an embodiment of the invention comprises an image sensor; first to seventh lenses aligned along an optical axis from the object side toward the sensor side, wherein the first lens has negative refractive power, an object-side surface of the first lens is concave on the optical axis, and a composite refractive power of the second to seventh lenses has positive refractive power, at least one of the sixth lens and the seventh lens is a plastic lens, a lens closest to the plastic lens is made of glass, and the glass lens closest to the plastic lens may be a lens having a maximum difference in effective diameters between an object-side surface and a sensor-side surface of each of the first to seventh lenses.

According to an embodiment of the invention, a lens having a maximum difference in effective diameters between the object-side surface and the sensor-side surface may be the fifth lens. The sensor-side surface of the first lens may be convex on the optical axis. a surface having a minimum absolute value of a curvature radius on the optical axis among the object-side surface and the sensor-side surface of each of the first to seventh lenses may be the sensor-side surface of the fifth lens.

According to an embodiment of the invention, the object-side surface of the seventh lens may have a maximum absolute value of the curvature radius of the object-side surface and the sensor-side surface of each of the first to seventh lenses. The sixth lens and the seventh lens are made of a plastic material, and an average of the curvature radii of the object-side surface and the sensor-side surface of the sixth lens may be larger than the absolute value of the average curvature radii of the object-side surface and the sensor-side surface of each of the first to fifth lenses. The sixth lens and the seventh lens are made of a plastic material, and the average of the curvature radii of the object-side surface and the sensor-side surface of each of the sixth and seventh lenses may be larger than the absolute value of the average curvature radii of the object-side surface and the sensor-side surface of each of the first to fifth lenses.

A camera module according to an embodiment of the invention comprises: an image sensor; first to seventh lenses aligned along an optical axis from an object side toward a sensor side; an aperture stop disposed between spherical lenses among the first to seventh lenses; and an optical filter between the seventh lens and the image sensor, wherein the first lens has a meniscus shape convex toward the sensor side on the optical axis, a refractive power of the first and seventh lenses is negative, a composite refractive power of the third to seventh lenses is positive, the first to seventh lenses have at least one aspherical lens, the first to seventh lenses include a cemented lens disposed between the aperture stop and the image sensor among the first to seventh lenses, wherein two different lenses are cemented, and the aspherical lens may be disposed between the cemented lens and the image sensor.

### Effects of the Invention

An optical system and a camera module according to an embodiment may have improved optical characteristics. In detail, in the optical system according to an embodiment, a plurality of lenses may have set thicknesses, powers, and distances between adjacent lenses. Accordingly, the optical system and camera module according to the embodiment may have improved MTF characteristics, aberration control characteristics, resolution characteristics, etc. in the set field of view range, and may have good optical performance in the periphery of the field of view.

In addition, the optical system and camera module according to the embodiment may have good optical performance in the temperature range of low temperature (about −20° C. to −40° C.) to high temperature (85° C. to 105° C.). In detail, the plurality of lenses included in the optical system may have set materials, power, and refractive index. Accordingly, even when the focal length of each lens changes due to a change in refractive index according to a change in temperature, the lenses can mutually compensate. That is, the optical system can effectively perform power distribution in the low temperature to high temperature temperature range, and can prevent or minimize changes in optical characteristics in the low temperature to high temperature temperature range. Therefore, the optical system and camera module according to the embodiment can maintain improved optical characteristics in various temperature ranges.

In addition, the optical system and camera module according to the embodiment may satisfy the set field of view and implement excellent optical characteristics by mixing an aspherical lens and a spherical lens. This allows the optical system to provide a slimmer vehicle camera module. Accordingly, the optical system and camera module may be provided for various applications and devices, and may have excellent optical properties even in harsh temperature environments, such as when exposed to the outside of a vehicle or inside a vehicle at high temperatures in summer.

### DESCRIPTION OF DRAWINGS

FIG. 1 is a side cross-sectional view of an optical system according to a first embodiment and a camera module having the same.

FIG. 2 is a side cross-sectional view for explaining the relationship between the n-th and n−1th lenses according to FIG. 1.

FIG. 3 is a table showing lens characteristics of the optical system of FIG. 1.

FIG. 4 is a table showing aspherical coefficients of lenses in the optical system of FIG. 1.

FIG. 5 is a table showing thicknesses of each lens and distances between adjacent lenses in the optical system of FIG. 1.

FIG. 6 is a table showing CRA (Chief Ray Angle) data at room temperature, low temperature, and high temperature according to the position of the image sensor in the optical system of FIG. 1.

FIG. 7 is a graph showing data on the diffraction MTF (Modulation Transfer Function) of the optical system of FIG. 1 at room temperature.

FIG. 8 is a graph showing data on the diffraction MTF of the optical system of FIG. 1 at low temperature.

FIG. 9 is a graph showing data on the diffraction MTF of the optical system of FIG. 1 at high temperature.

FIG. 10 is a graph showing data on the aberration characteristics of the optical system of FIG. 1 at room temperature.

FIG. 11 is a graph showing data on the aberration characteristics of the optical system of FIG. 1 at low temperature.

FIG. 12 is a graph showing data on the aberration characteristics of the optical system of FIG. 1 at high temperature.

FIG. 13 is a side cross-sectional view of an optical system according to the second embodiment and a camera module having the same.

FIG. 14 is a table showing lens characteristics of the optical system of FIG. 13.

FIG. 15 is a table showing aspherical coefficients of lenses in the optical system of FIG. 13.

FIG. 16 is a table showing the thickness of each lens of the optical system of FIG. 13 and the spacing between adjacent lenses.

FIG. 17 is a table showing CRA data at room temperature, low temperature, and high temperature according to the position of the image sensor in the optical system of FIG. 13.

FIG. 18 is a graph showing data on the diffraction MTF of the optical system of FIG. 13 at room temperature.

FIG. 19 is a graph showing data on the aberration characteristics of the optical system of FIG. 13 at room temperature.

FIG. 20 is a graph showing relative illuminance according to the height of the image sensor according to an embodiment.

FIG. 21 is a side cross-sectional view of an optical system according to a third embodiment and a camera module having the same.

FIG. 22 is a side cross-sectional view for explaining the relationship between the n-th and n−1th lenses according to FIG. 21.

FIG. 23 is a table showing lens characteristics of the optical system of FIG. 21.

FIG. 24 is a table showing aspherical coefficients of lenses in the optical system of FIG. 21.

FIG. 25 is a table showing the thickness of each lens of the optical system of FIG. 21 and the spacing between adjacent lenses.

FIG. 26 is a table showing CRA data at room temperature, low temperature, and high temperature according to the position of the image sensor in the optical system of FIG. 21.

FIG. 27 is a graph showing data on the diffraction MTF of the optical system of FIG. 21 at room temperature.

FIG. 28 is a graph showing data on the diffraction MTF of the optical system of FIG. 21 at low temperature.

FIG. 29 is a graph showing data on the diffraction MTF of the optical system of FIG. 21 at high temperature.

FIG. 30 is a graph showing data on the aberration characteristics of the optical system of FIG. 21 at room temperature.

FIG. 31 is a graph showing data on the aberration characteristics of the optical system of FIG. 21 at low temperature.

FIG. 32 is a graph showing data on the aberration characteristics of the optical system of FIG. 21 at high temperature.

FIG. 33 is a graph showing relative illuminance according to the height of the image sensor according to the third embodiment.

FIG. 34 is an example of a vehicle having an optical system according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean a convex shape on the optical axis or paraxial region, and a concave surface of the lens may mean a concave shape on the optical axis or paraxial region. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to ±0.4 mm depending on the measurement method. The paraxial region refers to a very narrow region near the optical axis, and is a region where the distance a light ray falls from the optical axis OA is almost 0. Hereinafter, the optical axis may include the center of each lens or a very narrow region near the optical axis.

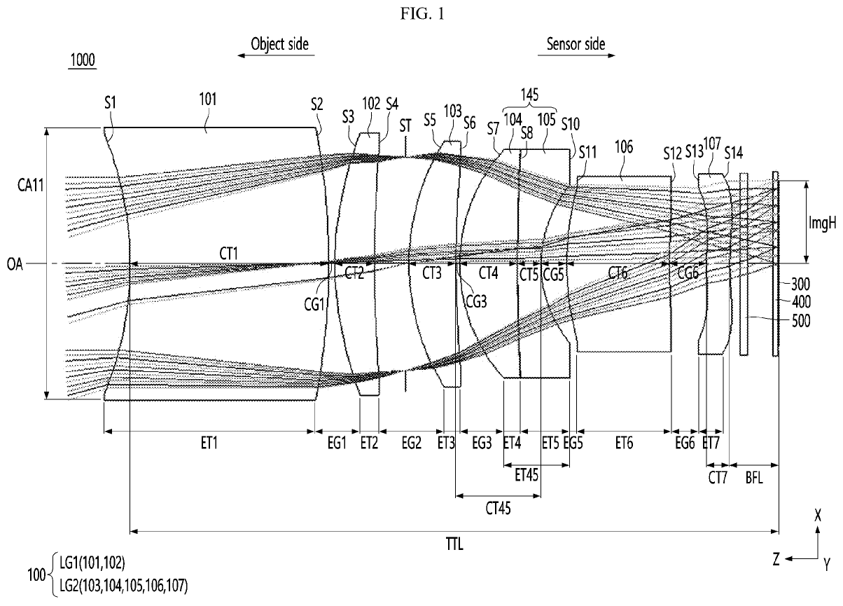

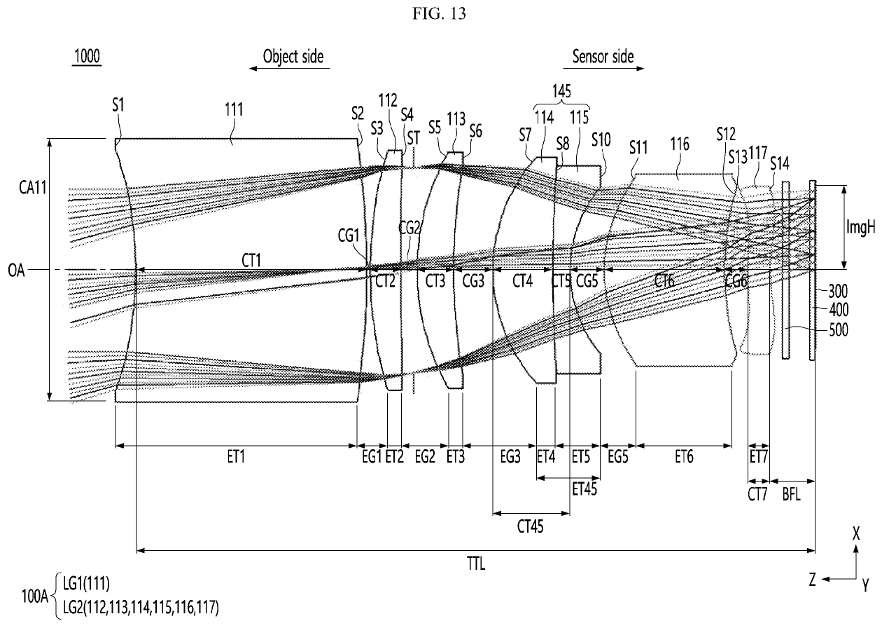

FIG. 1 is a configuration diagram of an optical system and a camera module according to a first embodiment, and FIG. 13 is a configuration diagram of an optical system and a camera module according to a second embodiment. As shown in FIG. 1 and FIG. 13, the optical system 1000 according to the first and second embodiments of the invention may include a plurality of lens groups LG1 and LG2. The plurality of lens groups LG1 and LG2 may include a first lens group LG1 and a second lens group LG2 that are sequentially arranged along an optical axis OA from an object side toward an image sensor 300. The optical system 1000 may include n lenses, where the n-th lens may be the last lens, and the n−1th lens may be the lens closest to the last lens. The n is an integer greater than or equal to 5, for example, 5 to 9. The number of lenses of each of the first lens group LG1 and the second lens group LG2 may be different from each other. The number of lenses of the second lens group LG2 may be greater than the number of lenses of the first lens group LG1, for example, may be more than twice or three times or more than the number of lenses of the first lens group LG1.

The first lens group LG1 may have three or less lenses. The first lens group LG1 may preferably have one or two lenses. The second lens group LG2 may include three or more lenses. The second lens group LG2 may have four or more or five or more lenses. If the first lens group LG1 is two lenses adjacent to the object side and the second lens group LG2 is the remaining lenses, a composite focal length of the first lens group LG1 may be defined as F_LG1 and a composite focal length of the second lens group LG2 may be defined as F_LG2, and the following condition may satisfy: F_LG2<F_LG1. In contrast, if the first lens group LG1 is one lens lens adjacent to the object side and the second lens group LG2 is the remaining lenses, the focal length of the first lens group LG1 may be defined as F_LG1 and the composite focal length of the second lens group LG2 may be defined as F_LG2, and the following condition may satisfy: F_LG2<|F_LG1|.

The first lens group LG1 may include at least one lens made of glass. The second lens group LG2 may include at least one glass lens and at least one plastic lens. The second lens group LG2 may include three or more glass lenses and at least one plastic lens, for example, four or more glass lenses and two or less plastic lenses. The glass lens has a small amount of expansion and contraction change due to external temperature changes, and the surface is not easily scratched, so it can prevent surface damage. In addition, the plastic lens is effective in improving the thin thickness and optical characteristics. Among the lenses of the second lens group LG2, one or two lenses closest to the image sensor 300 may be provided as a plastic lens or as an aspherical lens.

At least one lens closest to the object in the optical system 1000 may be made of glass. In the first and second embodiments, the lenses of the first lens group LG1 may be spherical lenses, and the lenses of the second lens group LG2 may include at least one aspherical lens and two or more spherical lenses. The aspherical lens is a lens whose object-side surface and sensor-side surface are aspherical, and the spherical lens is a lens whose object-side surface and sensor-side surface are spherical. In the second lens group LG2, the number of spherical lenses may be greater than the number of aspherical lenses. The aspherical lenses may prevent spherical aberration within the optical system 1000, and since aberration does not occur even when the effective diameter increases, miniaturization and weight reduction of the camera module may be possible. The aspherical lens may be made of a glass mold or a plastic mold material. In addition, the glass mold material may be provided as an aspherical lens. Since the change rate of shrinkage and expansion due to temperature change of the glass material lens is smaller than that of the plastic material, the glass lens may be arranged on the object side, and the plastic lens may be arranged adjacent to the image sensor 300. In addition, since at least two aspherical lenses are arranged adjacent to the image sensor 300, various aberrations may be compensated.

Among the lenses of the optical system 1000, the lens having the maximum Abbe number may be positioned in the second lens group LG2, and the lens having the maximum refractive index may be positioned in the second lens group LG2. The maximum Abbe number is 65 or more, and the maximum refractive index may be greater than 1.7. The lens having the maximum Abbe number can reduce chromatic dispersion, and the lens having the maximum refractive index can increase chromatic dispersion of incident light. In addition, the lens having the maximum refractive index may be positioned closer to the object side than the lens having the maximum Abbe number. The lens having the maximum effective diameter in the optical system 1000 may be a lens close to the object side, or one of the lenses between the two object-side lenses and the two sensor-side lenses. Preferably, the lens having the maximum effective diameter is a glass lens, and may be arranged closer to the object side than the lens having the maximum refractive index. The effective diameter of each lens may be the diameter of the effective region where effective light is incident on each lens, and is the average of the effective diameter of the object-side surface and the effective diameter of the sensor-side surface. An embodiment of the invention can reduce the weight of the camera module, provide a lower manufacturing cost, and suppress the deterioration of optical characteristics due to temperature change by mixing a spherical lens and an aspherical lens in the optical system 1000.

Each of the lenses may include an effective region and an ineffective region. The effective region may be a region through which light incident on each of the lenses passes. In other words, the effective region may be defined as an effective region or an effective diameter where incident light is refracted to implement optical characteristics. The ineffective region may be arranged around the effective region. The ineffective region may be a region where effective light is not incident from the plurality of lenses. In other words, the ineffective region may be a region irrelevant to the optical characteristics. In addition, the end of the ineffective region may be a region fixed to a lens barrel (not shown) that accommodates the lens.

In the optical system 1000, the TTL (Total top length) may be more than 2 times the ImgH, for example, more than 2 times and less than 15 times. Preferably, the following condition may satisfy: 4<TTL/ImgH≤10. The TTL (Total track length) is a distance from the center of the object-side surface of the first lens to the surface of the image sensor 300 in the optical axis OA. The ImgH is ½ of the maximum diagonal length of the image sensor 300. Within the optical system 1000, the effective focal length (EFL) is provided to be 10 mm or more and the diagonal field of view (FOV) is provided to be less than 45 degrees, so that it may be provided as a standard optical system in a vehicle camera module. For example, the optical system and camera module according to the embodiment may be applied to a camera module for an ADAS (Advanced Driving Assistance System) installed inside or outside a vehicle.

The optical system 1000 may have a condition of TTL/(2*ImgH) of 2.5 or more or 2.7 or more, for example, in the range of 2.5 to 5 or 3 to 5. By setting the value of TTL/(2*ImgH) to 2.5 or more in the optical system 1000, it is possible to provide a vehicle lens optical system. The total number of lenses of the first and second lens groups LG1 and LG2 is 9 or less or 8 or less. Accordingly, the optical system 1000 can provide an image without exaggeration or distortion for the image formed.

The number of lenses having an effective diameter larger than the length of the image sensor 300 in the optical system 1000 may be more than 50%, and the number of lenses having an effective diameter smaller than the length of the image sensor 300 may be 40% or less. At least one or all of the aspherical lenses in the optical system 1000 may have an effective diameter smaller than the length of the image sensor 300.

The effective diameter of the lens closest to the object side in the lens portion 100 and 100A may be larger than the effective diameter of the lens closest to the image sensor 300. In addition, the effective diameters of the lens arranged on the object side of the aperture stop ST and the lens arranged on the sensor side may be larger than the diagonal length of the image sensor 300. Accordingly, the brightness of the optical system may be controlled. By controlling the effective diameter of each of the lenses, the optical system 1000 can control the incident light to compensate for the deterioration of optical characteristics due to resolution and temperature change, improve chromatic aberration control characteristics, and improve the vignetting characteristics of the optical system 1000.

The optical system 1000 may include at least one cemented lens 145 therein. The cemented lens 145 may be a lens in which two lenses having different focal lengths are bonded together. The cemented lens 145 has an object-side lens and a sensor-side lens, and an effective diameter of the object-side lens may be larger than an effective diameter of the sensor-side lens. In addition, the effective diameter of the object-side lens of the cemented lens 145 may be larger than the length of the image sensor 300, and the effective diameter of the sensor-side lens may be arranged within a range of ±110% of the diagonal length of the image sensor 300. The cemented lens 145 may be a spherical lens. The effective diameters of lenses arranged closer to the object with respect to the cemented lens 145 may be larger than the length of the image sensor 300. At least one of the lenses arranged close to the sensor based on the cemented lens 145 may have an effective diameter smaller than the length of the image sensor 300. The cemented lens 145 may be disposed between a spherical lens and an aspherical lens in the optical system.

The first lens group LG1 and the second lens group LG2 may have a set interval in the optical axis OA. The optical axis distance between the first lens group LG1 and the second lens group LG2 in the optical axis OA may be an optical axis distance between the sensor-side surface of the lens closest to the sensor side among the lenses in the first lens group LG1 and the object-side surface of the lens closest to the object side among the lenses in the second lens group LG2.

The optical axis distance between the first lens group LG1 and the second lens group LG2 may be 0.5 times or less of the center distance of the first lens group LG1, for example, may be in the range of 0.01 to 0.5 times the center distance of the first lens group LG1. The optical axis distance between the first lens group LG1 and the second lens group LG2 may be 0.3 times or less of the center distance of the second lens group LG2, for example, may be in the range of 0.01 to 0.3 times the center distance of the second lens group LG2. The center distance of the second lens group LG2 is the center distance between the object-side surface of the lens closest to the object side of the second lens group LG2 and the sensor-side surface of the lens closest to the image sensor 300. Here, among the lens surfaces of the first lens group LG1 and the second lens group LG2, the two surfaces facing each other may have a shape in which the sensor-side surface of the object-side lens is concave and the object-side surface of the sensor-side lens is convex on the optical axis. Differently, the two surfaces facing each other may have a shape in which the sensor-side surface of the object-side lens is convex and the object-side surface of the sensor-side lens is concave on the optical axis. The first lens group LG1 refracts light incident through the object side to be collected, and the second lens group LG2 refracts light emitted through the first lens group LG1 to the image sensor 300.

The first lens group LG1 may have positive (+) refractive power, and the second lens group LG2 may have positive (+) refractive power. In the first lens group LG1, the lens closest to the object side may have negative (−) refractive power, and among the lenses of the second lens group LG2, the lens closest to the sensor side may have negative (−) refractive power. In addition, the refractive power of the first lens 101 and 111 on the object side may be positive (+), and the composite focal lengths of the second to seventh lenses may have positive (+) values.

When the focal length is expressed as an absolute value, the focal length of the first lens group LG1 may be 1.5 times or more, for example, 1.5 to 5 times, of the focal length of the second lens group LG2. The EFL of the optical system 1000 may be smaller than the absolute value of the focal length of the first lens group LG1. The EFL of the optical system 1000 may be smaller than the absolute value of the focal length of the second lens group LG2.

The lens portion 100 and 100A may be a mixture of spherical lenses and aspherical lenses. The number of aspherical lenses may be less than 50% of the total number of lenses, and may range from 10% to 40%. When representing the absolute value of the focal length, the average of the focal lengths of the spherical lenses may be smaller than the average of the focal lengths of the aspherical lenses. The average of the refractive indices of the aspherical lenses may be smaller than the average of the refractive indices of the spherical lenses. In addition, the average of the effective diameters of the spherical lenses may be larger than the average of the effective diameters of the aspherical lenses. Accordingly, when two or more aspherical lenses are arranged in the camera module, the weight of the camera module may be reduced and the optical characteristics may be improved. The first lens 101 and 111 closest to the object has a lower Abbe number and a higher refractive index than the second lens 102 and 112, so that color dispersion may be improved. In addition, since the n-th lens adjacent to the image sensor 300 is disposed to have a lower Abbe number and higher refractive index than the n−1th lens, color dispersion may be improved at a location adjacent to the image sensor 300.

The number of lenses having negative (−) refractive power on the optical system 1000 may be smaller than the number of lenses having positive (+) refractive power. The number of lenses having negative (−) refractive power may be less than 50% of the total number of lenses, for example, in the range of 20% to 45%.

The sum of the refractive indices of the lenses of the lens portion 100 and 100A of the embodiment may be 8 or more, for example, in the range of 8 to 15, and the average of the refractive indices may be in the range of 1.60 to 1.70. The sum of the Abbe numbers of each of the lenses may be 250 or more, for example, in the range of 250 to 370, and the average of the Abbe numbers may be 55 or less, for example, in the range of 31 to 55. The sum of the center thicknesses of the entire lens may be 15 mm or more, for example, in a range of 15 mm to 35 mm or in a range of 20 mm to 30 mm. The average of the center thicknesses of the entire lens may be 5 mm or less, for example, in a range of 2.8 mm to 5 mm. The sum of the center distances between the lenses in the optical axis OA may be 4 mm or more, for example, in a range of 4 mm to 8 mm, and may be smaller than the sum of the center thicknesses of the lenses. In addition, the average value of the effective diameter of each lens surface of the lens portion 100 and 100A may be provided as 8 mm or more, for example, in a range of 8 mm to 15 mm.

The F number of the optical system or camera module according to an embodiment of the invention may be 2.4 or less, for example, in the range of 1.4 to 2.4 or in the range of 1.5 to 1.8. The maximum field of view (diagonal FOV) of the optical system according to an embodiment of the invention may be 50 degrees or less, for example, in the range of 20 to 55 degrees or 25 to 40 degrees. The vehicle optical system may have a horizontal field of view FOV_H in the Y-axis direction that is greater than 20 degrees and less than 40 degrees, for example, in the range of 25 to 35 degrees. In addition, the vertical field of view is provided at an angle smaller than the horizontal field of view, and may be 20 degrees or less, for example, in the range of 10 to 20 degrees. At this time, the sensor length in the horizontal direction Y may be 8.064 mm±0.5 mm, and the sensor height in the vertical direction X may be 4.54 mm±0.5 mm. The horizontal field of view FOV_H is a field of view based on the horizontal length of the sensor. Accordingly, it is possible to suppress the change in the focus position due to temperature change, and provide a vehicle camera in which various aberrations are well corrected.

The optical system 1000 or camera module may include an image sensor 300. The image sensor 300 may detect light and convert it into an electrical signal. The image sensor 300 may detect light that has sequentially passed through the lens portion 100 and 100A. The image sensor 300 may include a device capable of detecting incident light, such as a CCD (Charge coupled device) or a CMOS (Complementary metal oxide semiconductor). Here, the number of lenses having an effective diameter greater than the length of the image sensor 300 may be 5 to 6, and the number of lenses having an effective diameter less than the length of the image sensor 300 may be 1 or 2.

The optical system 1000 or the camera module may include an optical filter 500. The optical filter 500 may be disposed between the second lens group LG2 and the image sensor 300. The optical filter 500 may be disposed between the lens closest to the sensor side among the lenses of the lens portion 100 and 100A and the image sensor 300. For example, the optical system 100 and 100A may be disposed between the last lens and the image sensor 300. The cover glass 400 is disposed between the optical filter 500 and the image sensor 300, and protects the upper part of the image sensor 300 and prevents the reliability of the image sensor 300 from being deteriorated. The cover glass 400 may be removed.

The optical filter 500 may include an infrared filter or an infrared cut-off filter (IR cut-off). The optical filter 500 can pass light of a set wavelength band and filter light of a different wavelength band. When the optical filter 500 includes an infrared filter, it can block radiant heat emitted from external light from being transmitted to the image sensor 300. In addition, the optical filter 500 can transmit visible light and reflect infrared light.

The optical system 1000 according to the embodiment may include an aperture stop ST. The aperture stop ST can adjust the amount of light incident on the optical system 1000. The aperture stop ST may be disposed between any two lenses in the lens portion 100 and 100A. For the lenses disposed between the object and the aperture stop ST, the effective diameter of the lenses tends to become smaller as they go from the object side to the aperture stop ST. For the lenses disposed between the aperture stop ST and the image sensor 300, the effective diameters of the lenses tend to become smaller as they go from the aperture stop ST to the sensor side. The meaning of ‘the effective diameters of the lenses tend to decrease as they go from the aperture stop ST to the sensor side’ does not only mean the case where the effective diameters of the lenses disposed between the aperture stop ST and the image sensor 300 decrease as they go from the aperture stop ST to the sensor side, but also at least one lens surface may be larger than the object-side lens surface. In the case of the lenses disposed between the aperture stop ST and the image sensor as in the embodiment of the present invention, the effective diameter of the lenses may increase and then decrease as they go from the aperture stop ST to the sensor side.

The first lens 101 and 111 and the second lens 102 and 112 may be disposed on the object side of the aperture stop ST, and the third lens 103 and 113 and the fourth lens 104 and 114 may be disposed on the sensor side of the aperture stop ST. When the aperture stop ST is disposed on the sensor-side surface of the second lens 102 and 112, the following condition satisfies: effective diameter of the object-side surface of the first lens>effective diameter of the sensor-side surface of the first lens>effective diameter of the object-side surface of the second lens>effective diameter (effective diameter of the aperture stop) of the sensor-side surface of the second lens. The following condition satisfies: effective diameter (effective diameter of the aperture stop) of the sensor-side surface of the second lens 102 and 112>effective diameter of the object-side surface of the third lens>effective diameter of the sensor-side surface of the fourth lens. The aperture stop ST may be disposed at a set position. The aperture stop ST may be arranged around the object-side surface or the sensor-side surface of any one of the lenses of the first lens group LG1. For example, the aperture stop ST may be arranged around the sensor-side surface of the sensor-side lens of the first lens group LG1, that is, around the sensor-side surface of the second lens 102. As another example, the aperture stop ST may be arranged around the object-side surface or the sensor-side surface of the lens that is closest to the object side among the lenses of the second lens group LG2. In this case, the aperture stop ST may be arranged around the object-side surface or sensor-side surface of the object-side lens of the first lens group LG1. In this case, at least one lens selected from the plurality of lenses may serve as an aperture stop. In detail, the object-side surface or sensor-side surface of one lens selected from the lenses of the optical system 1000 may serve as an aperture stop for controlling the amount of light.

Since the embodiment is an optical system applied to a vehicle camera, an aspherical lens and a spherical lens may be used together, and the first lens closest to the object side may be provided with a glass material. This has the advantage that the glass material is resistant to scratches and is not sensitive to external temperatures compared to a plastic material. In order to be placed inside a vehicle or to more effectively prevent scratches caused by foreign substances, the first lens may be used with a glass material, and the object-side surface of the first lens may have a concave shape so as not to come into contact with external structures. When the object-side surface of the first lens is designed to have a convex shape, scratches may occur due to contact with an external structure. For driver monitoring, front/rear imaging of the vehicle, lane detection, and detection of impurities around the vehicle, the field of view may be more than 20 degrees and less than 40 degrees, for example, in the range of 25 degrees to 35 degrees. This horizontal field of view may be a preset angle for an advanced driver assistance system. The optical system 1000 according to the embodiment may further include a reflective member (not shown) for changing the path of light. The reflective member may be implemented as a prism that reflects the incident light of the first lens group LG1 toward the lenses. Hereinafter, the optical system according to the embodiment will be described in detail.

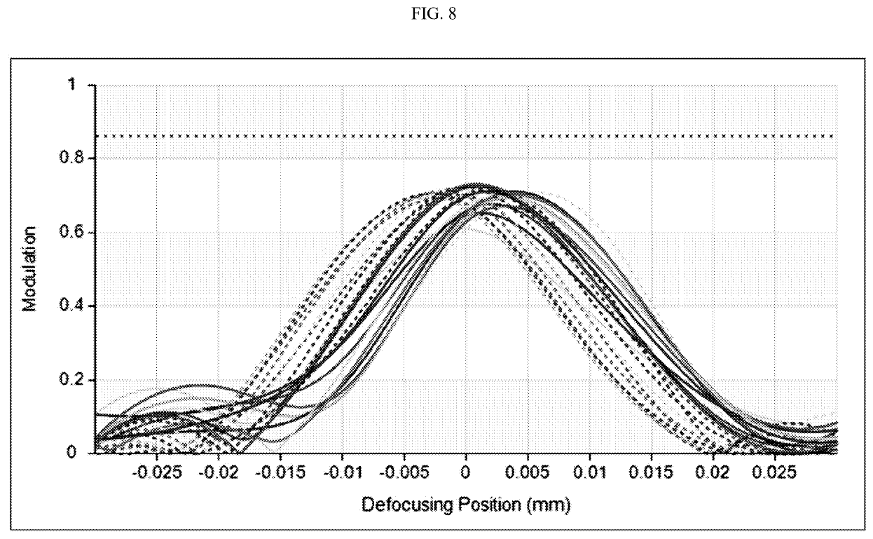

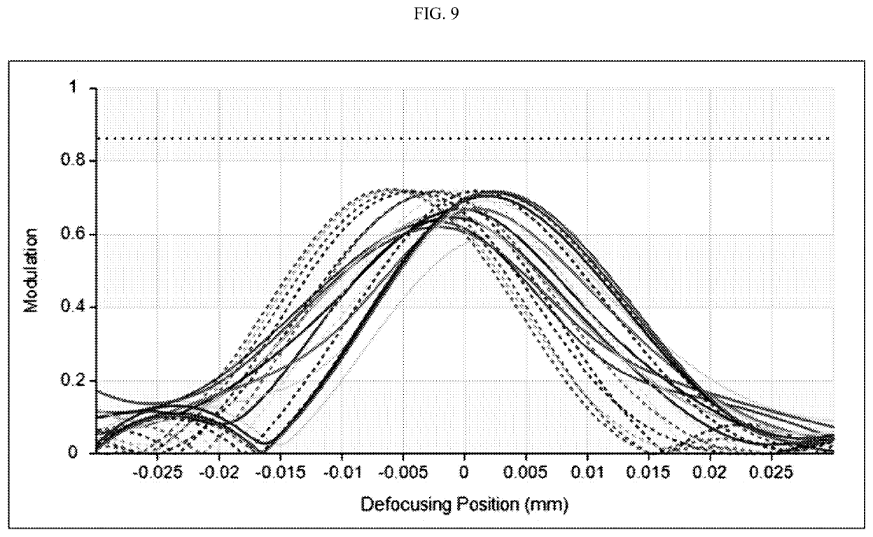

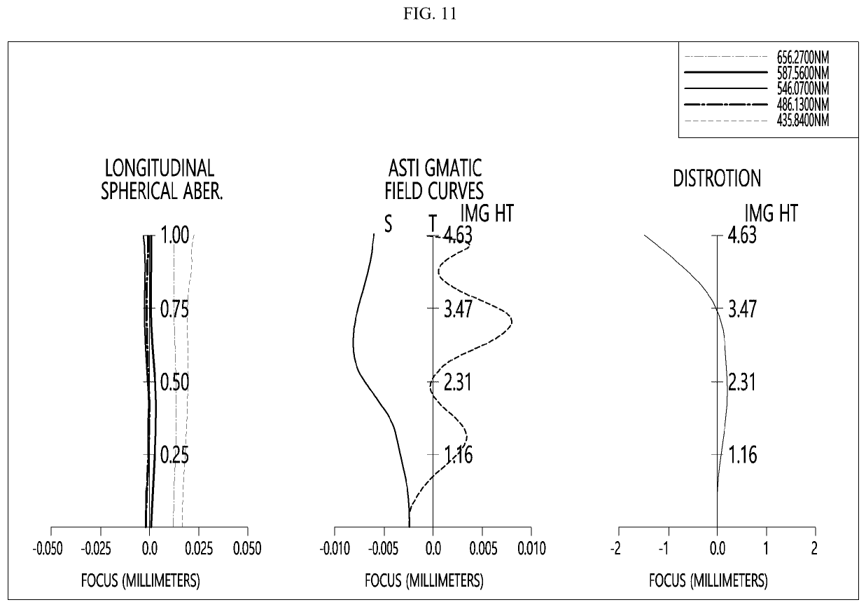

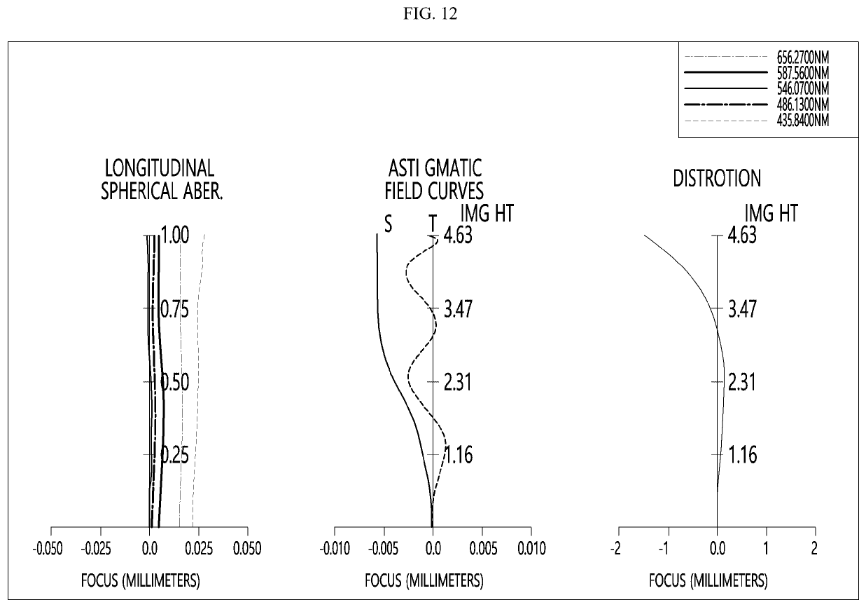

The optical system and camera module according to the first embodiment of the invention will be described with reference to FIGS. 1 to 12. Referring to FIGS. 1 to 3, an optical system 1000 according to a first embodiment includes a lens portion 100, and the lens portion 100 may include a first lens 101 to a seventh lens 107 sequentially arranged along an optical axis OA. Light corresponding to information about an object may pass through the first lens 101 to the seventh lens 107 and the optical filter 500 to be incident on an image sensor 300. The first lens 101 is the lens closest to the object side in the first lens group LG1. The seventh lens 107 is the lens closest to the image sensor 107 in the second lens group LG2 or the lens portion 100. The first and second lenses 101 and 102 may be a first lens group LG1, and the third to seventh lenses 103, 104, 105, 106, and 107 may be a second lens group LG2.

The first lens 101 may have positive (+) or negative (−) refractive power on the optical axis OA. The first lens 101 may have negative (−) refractive power. The first lens 101 may include a plastic material or a glass material, and may be, for example, a glass material. The first lens 101 made of a glass material can reduce changes in the center position and the curvature radius due to temperature changes according to the surrounding environment, and can protect the incident side surface of the optical system 1000. The object-side first surface S1 of the first lens 101 based on the optical axis may be concave, and the sensor-side second surface S2 may be convex. The first lens 101 may have a meniscus shape that is convex toward the sensor side. In contrast, the first surface S1 may have a convex shape on the optical axis OA, and the second surface S2 may have a concave shape. In contrast, the first lens 101 may have shapes in which both sides are concave on the optical axis OA. The first lens 101 may be provided as a spherical lens made of glass. The effective radius of the first surface S1 of the first lens 101 may be larger than the effective radii of the object-side surface and the sensor-side surface of the second to seventh lenses 102-107. Since the first surface S1 is concave and the second surface S2 has a convex shape, the incident light is refracted in a direction away from the optical axis OA, and the distance between the first lens 101 and the second lens 102 may be reduced. The first surface S1 of the first lens 101 may be provided without a critical point from the optical axis OA to the end of the effective region, i.e., the edge. The second surface S2 of the first lens 101 may be provided without a critical point.

The second lens 102 may be disposed between the first lens 101 and the third lens 103. The second lens 102 may have positive (+) or negative (−) refractive power on the optical axis OA. The second lens 102 may have positive (+) refractive power. The second lens 102 may include a plastic or glass material. For example, the second lens 102 may be made of glass. The object-side third surface S3 of the second lens 102 on the optical axis OA may have a convex shape, and the fourth surface S4 on the sensor side may have a concave shape. The second lens 102 may have a meniscus shape that is convex toward the object side on the optical axis. Alternatively, the second lens 102 may have a convex shape on both sides. Alternatively, the third surface S3 may be concave, and the fourth surface S4 may be convex. Alternatively, the second lens 102 may have a concave shape on both sides. The second lens 102 may be provided as a spherical lens made of glass. The third surface S3 and the fourth surface S4 may be spherical. At least one or both of the third surface S3 and the fourth surface S4 may be provided without a critical point from the optical axis OA to the end of the effective region.

The third lens 103 may have positive (+) or negative (−) refractive power on the optical axis OA. The third lens 103 may have positive (+) refractive power. The third lens 103 may include a plastic or glass material. For example, the third lens 103 may be made of glass. The object-side fifth surface S5 of the third lens 103 on the optical axis may have a convex shape, and the sixth surface S6 on the sensor side may have a concave shape. The third lens 103 may have a meniscus shape convex toward the object side on the optical axis. Differently, the third lens 103 may have a meniscus shape convex toward the sensor side. Alternatively, the third lens 103 may have a concave shape on both sides in the optical axis. The third lens 103 may be provided as a spherical lens made of glass. The fifth surface S5 and the sixth surface S6 may be spherical. At least one or both of the fifth surface S5 and the sixth surface S6 may be provided without a critical point from the optical axis OA to the end of the effective region.

The aperture stop ST may be disposed around the sensor-side surface of the second lens 102. Alternatively, the aperture stop ST may be arranged around the object-side or sensor-side surface of the first lens 101, or around the object-side surface of the second lens 102. Since the third lens 103 adjacent to the sensor side of the aperture stop ST has positive refractive power (F3>0), the third lens 103 can refract incident light in the direction of the optical axis and suppress the increase in the effective diameter of the sensor-side or rear-side lenses of the third lens 103. Accordingly, the yield by weight of the optical system may be prevented from decreasing by the third lens 103 and the production efficiency may be improved. Here, the composite focal length of the third to seventh lenses 103-107 arranged on the sensor side of the aperture stop ST may have a positive value and can reduce the TTL within the field of view range.

The fourth lens 104 may have positive (+) or negative (−) refractive power on the optical axis OA. The fourth lens 104 may have positive (+) refractive power. The fourth lens 104 may include a plastic or glass material. For example, the fourth lens 104 may be provided as a glass material. The object-side seventh surface S7 of the fourth lens 104 on the optical axis may be convex, and the eighth surface S8 on the sensor side may have a concave shape. The fourth lens 104 may have a meniscus shape that is convex toward the object side. Alternatively, the fourth lens 104 may have a meniscus shape that is convex on both sides of the optical axis OA or convex toward the sensor side. Alternatively, the seventh surface S7 may have a concave shape, and the eighth surface S8 may have a concave shape on the optical axis OA. Alternatively, the fourth lens 104 may have a meniscus shape that is convex toward the object side. The fourth lens 104 may be provided as a spherical lens made of glass. The seventh surface S7 and the eighth surface S8 may be spherical. The seventh surface S7 and the eighth surface S8 may be provided without a critical point from the optical axis OA to the end of the effective region.

The fifth lens 105 may have positive (+) or negative (−) refractive power on the optical axis OA. The fifth lens 105 may have negative (−) refractive power. The fifth lens 105 may include a plastic or glass material. For example, the fifth lens 105 may be made of glass. On the optical axis OA, the object-side ninth surface of the fifth lens 105 may be convex, and the sensor-side tenth surface S10 may have a concave shape. The fifth lens 105 may have a meniscus shape convex toward the object side on the optical axis OA. Alternatively, the fifth lens 105 may have a meniscus shape convex toward the sensor side. Alternatively, the ninth surface may have a convex shape at both sides on the optical axis OA. Alternatively, the fifth lens 105 may have a concave shape at both sides on the optical axis. The ninth surface and the tenth surface S10 of the fifth lens 105 may be spherical. At least one or both of the ninth surface and the tenth surface S10 may be provided without a critical point from the optical axis OA to the end of the effective region.

The fourth lens 104 and the fifth lens 105 may be bonded and may be defined as a cemented lens 145. The bonding surface between the fourth lens 104 and the fifth lens 105 may be defined as an eighth surface S8. The eighth surface S8 may be the same surface as the ninth surface of the fifth lens 105. When the distance between the fourth and fifth lenses 104 and 105 is G4, G4 may be less than 0.01 mm. The distance G4 between the fourth and fifth lenses 104 and 105 may be less than 0.01 mm from the optical axis OA to the end of the effective region. The fourth and fifth lenses 104 and 105 may have opposite refractive powers. The composite refractive power of the fourth and fifth lenses 104 and 105 may have negative (−) refractive power. When the composite refractive power of the cemented lens 145 is F45, the composite refractive power of the first and second lenses 101 and 102 is F12, and the composite refractive power of the third to seventh lenses 103-107 is F37, the following condition in absolute value may satisfies: F27<F45<F12. In the first and second embodiments, F27 may be 13.986 mm and 13.889 mm, and F45 may be −31.451 mm and −43.854 mm.

The product of the refractive power of the fourth lens 104 and the refractive power of the fifth lens 105 of the cemented lens 145 may be less than 0. The product of the focal length of the fourth lens 104 and the focal length of the fifth lens 105 of the cemented lens 145 may be less than 0. Accordingly, the aberration characteristics of the optical system may be improved. If the refractive powers of the two lenses of the cemented lens 145 are the same, there is a limit to the improvement of aberration. The composite refractive power of the cemented lens 145 has negative refractive power, and the third lens 103 close to the object side and the sixth lens 106 close to the sensor side based on the cemented lens 145 may have positive refractive power. Accordingly, the third lens 103, the cemented lens 145, and the sixth lens 106 can refract some of the incident light in the direction of the optical axis.

The effective diameter of the fourth lens 104 may be larger than the effective diameter of the fifth lens 105 and may be larger than the diagonal length of the image sensor 300. The effective diameter of the fourth lens 104 is an average of the effective diameters of the seventh surface S7 and the eighth surface S8. The effective diameter of the fifth lens 105 may be smaller than the effective diameter of the fourth lens 104 and may have a length within a range of ±110% or ±105% of the diagonal length of the image sensor 300. Preferably, the effective diameter of the fifth lens 105 may be larger than the diagonal length of the image sensor 300, for example, may be 110% or less or 105% or less of the diagonal length of the image sensor 300.

The effective diameter of the eighth surface S8 of the fifth lens 105 may be greater than the diagonal length of the image sensor 300, and the effective diameter of the tenth surface S10 may be less than the diagonal length of the image sensor 300.

When the fifth lens 105 is a spherical lens and the sixth lens 106 is an aspherical lens, the difference between the effective diameter of the seventh surface S7 on the object side and the effective diameter of the tenth surface S10 on the sensor side of the cemented lens 145 may be provided as large as possible within the lens portion 100. When the effective diameter of the ninth surface of the fifth lens 105 and the effective diameter of the tenth surface S10 on the sensor side are set to CA51 and CA52, the following condition satisfies: CA51>CA52, and the difference between CA51 and CA52 may be the largest among the differences in effective diameters between the object-side surface and the sensor-side surface of each lens. In addition, when the effective diameter of the seventh surface S7 of the fourth lens 104 and the effective diameter of the eighth surface S8 on the sensor side are set to CA41 and CA42, the following condition may satisfy: CA41>CA42. Accordingly, the increase in the effective diameter of the aspherical lens may be prevented by the fifth lens 105 having a relatively small effective diameter and a concave sensor-side surface.

Since the cemented lens 145 is bonded with spherical glass lenses having different refractive indices, and at least one lens positioned on the sensor side than the cemented lens 145 is positioned as an aspherical lens, spherical aberration may be compensated for by the aspherical lens. In addition, since at least one or two or more of the lenses positioned on the sensor side than the cemented lens 145 are aspherical lenses and have small effective diameters, light may be refracted to the entire region of the image sensor 300 through the aspherical lens. When the refractive index of the fourth lens 104 is Nd4, the refractive index of the fifth lens 105 is Nd5, the Abbe number of the fourth lens 104 is Vd4, and the Abbe number of the fifth lens 105 is Vd5, the following condition may satisfy: Nd5*Vd5<Nd4*Vd4.

When the curvature radius of the object-side seventh surface S7 of the cemented lens 145 is L4R1, and the curvature radius of the sensor-side tenth surface S10 of the cemented lens 145 is L5R2, the following condition may satisfy: |L4R1−L5R2|<10 mm, and preferably, |L4R1−L5R2|≤5 mm may be satisfied. The shape of the object-side surface and the sensor-side surface of the cemented lens 145 has a meniscus shape that is convex toward the object side, and by setting the difference in the curvature radius of the object-side surface and the sensor-side surface to be small, the amount of incident light may be increased and the emitted light may be guided to the effective region of the sixth lens 106 with a small effective diameter.

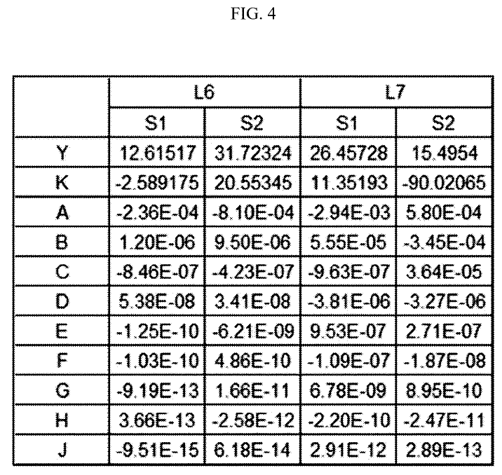

The sixth lens 106 may have positive (+) or negative (−) refractive power on the optical axis OA. The sixth lens 106 may have positive (+) refractive power. The sixth lens 106 may include a plastic or glass material. For example, the sixth lens 106 may be provided as a glass material or a glass mold material. On the optical axis OA, the object-side eleventh surface S11 of the sixth lens 106 may be convex, and the sensor-side twelfth surface S12 may be concave. The sixth lens 106 may have a meniscus shape convex toward the object on the optical axis OA. Alternatively, the sixth lens 106 may have a meniscus shape convex toward the sensor, or a biconvex shape. Alternatively, the sixth lens 106 may have a biconcave shape. The eleventh surface S11 and the twelfth surface S12 may be aspherical, and the aspherical coefficients of the eleventh and twelfth surfaces S11 and S12 may be provided as L6S1 and L6S2 of FIG. 4. Since the sixth lens 106 is provided with an aspherical glass material, the number of lenses in the optical system may be reduced. The eleventh surface S11 of the sixth lens 106 may be provided without a critical point from the optical axis OA to the end of the effective region. The twelfth surface S12 may be provided without a critical point from the optical axis OA to the end of the effective region. Alternatively, at least one of the object-side surface and the sensor-side surface of the sixth lens 106 may have at least one critical point from the optical axis to the end of the effective region.

Since the object-side surface and the sensor side of the sixth lens 106 are provided without a critical point, the effective diameter of the seventh lens 107 may not be increased. In addition, the difference between the effective diameter of the seventh lens 107 and the diagonal length of the image sensor 300 may not be large due to the sixth lens 106.

When the effective diameter of the object-side eleventh surface S11 of the sixth lens 106 is CA61 and the effective diameter of the sensor-side twelfth surface S12 of the sixth lens 106 is CA62, the following condition may satisfy: CA62<CA61. If the curvature radius of the object-side eleventh surface S11 of the sixth lens 106 is L6R1 and the curvature radius of the sensor-side twelfth surface S12 of the sixth lens 106 is L6R2, the following condition may satisfy: CA61*L6R1<CA62*L6R2. If the refractive index of the sixth lens 106 is Nd6 and the Abbe number is Vd6, and the refractive index of the first lens 101 is Nd1 and the Abbe number is Vd1, the following condition may satisfy: Nd6<Nd1, Nd1*Vd1<Nd6*Vd6. This means that the center thickness of the sixth lens 106 is larger than the center thickness of the seventh lens 107 and the refractive index is lowered to suppress color dispersion.

The seventh lens 107 may have positive (+) or negative (−) refractive power on the optical axis OA. The seventh lens 107 may have negative (−) refractive power. The seventh lens 107 may include a plastic or glass material. For example, the seventh lens 107 may be a plastic material. The object-side thirteenth surface S13 of the seventh lens 107 may have a convex shape on the optical axis, and the sensor-side fourteenth surface S14 may have a concave shape. The seventh lens 107 may have a meniscus shape that is convex toward the object side on the optical axis. Alternatively, the thirteenth surface S13 may have a concave shape on the optical axis, and the fourteenth surface S14 may have a convex shape. Alternatively, the seventh lens 107 may have a concave shape on both sides. The seventh lens 107 is made of a plastic material and may have aspherical surfaces on both sides. The thirteenth surface S13 and the fourteenth surface S14 have aspherical surfaces, and the aspherical coefficients may be provided as L7S1 and L7S2 of FIG. 4. The seventh lens 107 may be an aspherical lens closest to the image sensor 300. By arranging the aspherical lens closest to the image sensor 300, it is possible to prevent deterioration of optical performance, and control the effect on aberration characteristics and resolution. In addition, by arranging the aspherical lens as the lens closest to the image sensor 300, it may be insensitive to assembly tolerances compared to spherical lenses. In other words, being insensitive to assembly tolerances means that even if assembled with a slight difference compared to the design during assembly, it may not significantly affect optical performance.

In the sixth lens 106, if the Sag value of the object-side surface is Sag61 and the Sag value of the sensor-side surface is Sag62, the following condition may satisfy: 0<Sag61-Sag62<0.7 mm. Accordingly, the difference in thickness between the center and edge of the sixth lens 106 is not large, and the influence on the optical characteristics may be suppressed. In the seventh lens 107, if the Sag value of the object-side surface is Sag71 and the Sag value of the sensor-side surface is Sag72, the following condition may satisfy: 0<|Sag71|Sag72|<0.4 mm. Accordingly, the difference in thickness between the center and edge of the seventh lens 107 is not large, and the curvature radius is not large, and the influence on the optical characteristics may be suppressed. Since the sixth and seventh lenses 106 and 107 are arranged as aspherical lenses, optical performance degradation may be prevented, the number of lenses may be reduced, and the TTL of the optical system may be reduced.

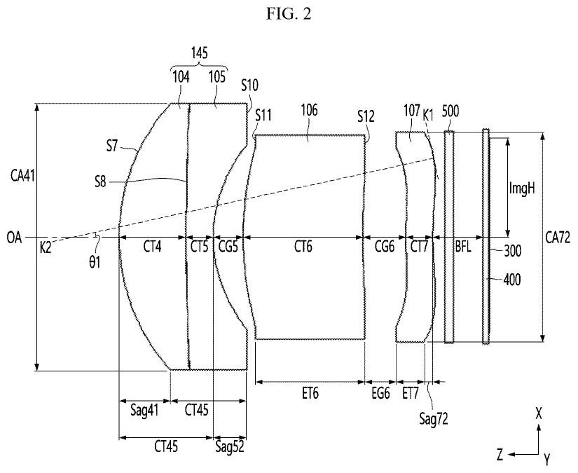

Referring to FIG. 2, at least one or both of the thirteenth surface S13 and the fourteenth surface S14 of the seventh lens 107 may have a critical point. The thirteenth surface S13 of the seventh lens 107 may have at least one critical point from the optical axis OA to the end of the effective region. Since the thirteenth surface S13 and the fourteenth surface S14 of the seventh lens 107 have critical points, light may be provided to the entire region of the image sensor 300. The critical point of the thirteenth surface S13 may be located at a position of 2.3 mm or less from the optical axis OA, for example, in a range of 1.7 mm to 2.4 mm. As another example, the thirteenth surface S13 may be provided without a critical point.

The fourteenth surface S14 of the seventh lens 107 may have at least one critical point from the optical axis OA to the end of the effective region. The critical point of the fourteenth surface S14 may be located at a position of 2.5 mm or more from the optical axis OA, for example, in the range of 2.5 mm to 3.1 mm. Since the critical point of the fourteenth surface S14 is located closer to the edge than the critical point of the thirteenth surface S13 with respect to the optical axis, the fourteenth surface S14 may refract light to the periphery of the image sensor 300. BFL (Back focal length) is the center distance from the surface of the image sensor 300 to the center of the sensor-side surface of the last lens. A tangent line K1 passing through any point of the fourteenth surface S14 of the seventh lens 107 and a normal line K2 perpendicular to the tangent line K1 may have a predetermined angle θ1 with the optical axis OA. The maximum tangent angle θ1 on the fourteenth surface S14 in the first direction X may be 45 degrees or less, for example, in a range of 5 degrees to 45 degrees or in a range of 15 degrees to 35 degrees. CT7 is the center thickness of the seventh lens 107, and ET7 is the edge thickness of the seventh lens 107. CT6 is the center thickness of the sixth lens 106, and ET6 is the edge thickness of the sixth lens 106. The edge thickness is the distance in the direction of the optical axis between the object-side surface and the sensor-side surface at the end of the effective region of each lens. CG6 is a center distance (i.e., center distance) from the center of the sixth lens 106 to the center of the seventh lens 107. That is, CG6 is a distance from the center of the twelfth surface S12 to the center of the thirteenth surface S13. EG6 is a distance (i.e., edge distance) in the direction of the optical axis from the edge of the sixth lens 106 to the edge of the seventh lens 107. The center thickness of the cemented lens 145 is CT45, which is the center distance from the center of the object-side surface of the fourth lens 104 to the center of the sensor-side surface of the fifth lens 105. The edge thickness of the cemented lens 145 is ET45, which is the center distance from the edge of the object-side surface of the fourth lens 104 to the edge of the sensor-side surface of the fifth lens 105.

When the Sag value of the object-side surface of the fourth lens 104 is Sag41, the Sag value of the sensor-side surface of the fifth lens 105 is Sag51, the Sag value of the object-side surface of the sixth lens 106 is Sga61, the Sag value of the sensor-side surface of the sixth lens 106 is Sag62, the Sag value of the object-side surface of the seventh lens 107 is Sag71, and the Sag value of the sensor-side surface of the seventh lens 107 is Sag72, the following condition in the absolute value may satisfy: Max_Sag52<Max_Sag41, the following condition may satisfy: Max_Sag61<Max_Sag52, and the following condition may satisfy: Max_Sag72<Max_Sag 71<Max_Sag52<Sag41. In this way, by adjusting the lens surface from the center to the edge of the fifth to seventh lenses 105-107, the incident light may be guided to the entire region of the image sensor 300. Here, Max_Sag value is the maximum distance in the direction of the optical axis from a straight line perpendicular to the center of the object-side surface or the sensor-side surface of each lens to the lens surface, and the Sag value may have a negative value when it is located on the object-side surface rather than the center, and may have a positive value when it is located on the sensor-side surface rather than the center.

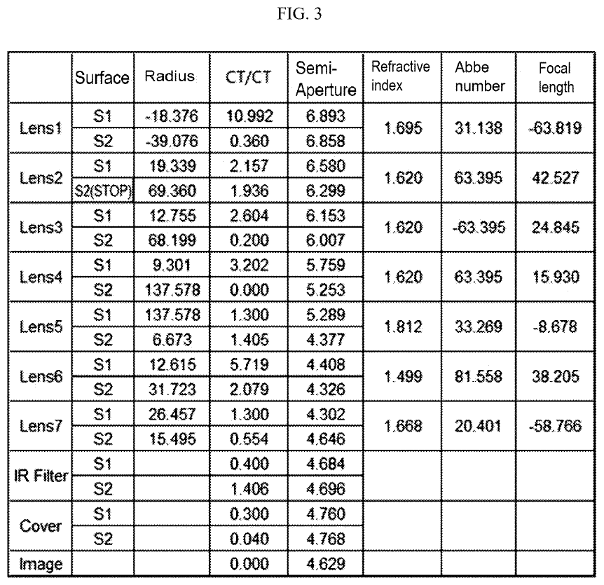

FIG. 3 is an example of lens data of the optical system of the embodiment of FIG. 1. As shown in FIG. 3, the curvature radius of the first to seventh lenses 101-107 in the optical axis OA, the center thickness CT of each lens, the center distance CG between adjacent lenses, the refractive index in the d-line, the Abbe number, and the size of the semi-aperture may be set. When the curvature radius of each lens in the optical axis is expressed as an absolute value, the curvature radius of the eighth surface S4 of the fourth lens 104 in the optical axis OA may be the largest among the lenses, and the curvature radius of the tenth surface S10 of the fifth lens 105 may be the smallest among the lenses. The difference between the maximum curvature radius and the minimum curvature radius may be 10 times or more, for example, 15 times or more. When the curvature radius of each lens on the optical axis is expressed as an absolute value, the curvature radius of the first lens 101 on the optical axis may be smaller than the curvature radius of the second lens 102 arranged on the sensor side of the aperture stop ST and the curvature radius of the third lens 103 arranged on the object side. Here, the curvature radius is an average of the absolute values of the radii of curvature of the object-side surface and the sensor-side surface of each lens. The absolute value of the curvature radius of the object-side surface of the i-th lens is Roi, the absolute value of the curvature radius on the sensor side is Rsi, and the absolute value of the average of the object-side surface and the sensor-side surface is Ri, and the value of (Roi−Rsi)/Ri may be minimum when i is 7 and maximum when i is 5. Here, when i is 6 or 7, the value of (Roi−Rsi)/Ri may be less than 1. Accordingly, each of the plurality of aspherical lenses may have a difference in the average of the curvature radii of the object-side surface and the sensor-side surface of each aspherical lens smaller than that of the spherical lenses.

The curvature radius of the sixth lens 106 on the optical axis may be smaller than that of the first lens 101. Since the sixth lens 106 is aspherical and has a curvature radius smaller than that of the first lens 101, the entire region may be provided with a uniform light distribution. The curvature radius of the seventh lens 107 on the optical axis may be smaller than that of the first lens 101. Since the seventh lens 107 is aspherical and has a curvature radius smaller than that of the first lens 101, the entire region may be provided with a uniform light distribution. The absolute value of the curvature radius of the object-side surface of the i-th lens is Roi, the absolute value of the sensor-side curvature radius is Rsi, and the absolute value of the average of the object-side surface and the sensor-side surface means Ri, and the value of Roi/Rsi may be the largest when i is 5 and the smallest when i is 4.

The curvature radii of the first and second surfaces S1 and S2 of the first lens 101 are defined as L1R1 and L1R2, the curvature radii of the thirteenth and fourteenth surfaces S13 and S14 of the seventh lens 107 are defined as L7R1 and L7R2, and the curvature radii of the respective lens surfaces of the second to sixth lenses 102-106 may be defined as L2R1, L2R2, L3R1, L3R2, L4R1, L4R2 (L5R1), L5R2, L6R1, and L6R2. The ratio of the curvature radius of the object-side surface of each lens to the curvature radius of the sensor-side surface may satisfy the following conditions:

$$0 < \vert L 1 R 1 / L 1 R 2 \vert < 0.6 , \qquad Condition 1$$

$$0 < \vert L 2 R 1 / L 2 R 2 \vert < 0.5 \qquad Condition 2$$

$$0 < L 3 R 1 / L 3 R 2 < 0.4 , \qquad Condition 3$$

$$0 < L 4 R 1 / L 4 R 2 < 0.2 \qquad Condition 4$$

$$10 < L 5 R 1 / L 5 R 2 < 30 , \qquad Condition 5$$

$$0 < L 6 R 1 / L 6 R 2 < 0.6 \qquad Condition 6$$

$$1 < L 7 R 1 / L 7 R 2 < 2.2 , \qquad Condition 7$$

If the center thicknesses of the first to seventh lenses 101-107 are defined as CT1-CT7, and the edge thicknesses of the first to seventh lenses 101-107 are defined as ET1-ET7, the sum of the center thicknesses of the first to seventh lenses 101-107 may be defined as ΣCT, and the sum of the edge thicknesses of the first to seventh lenses 101-107 may be defined as LET. When explaining the thickness of the lenses, the center thickness CT1 of the first lens 101 may be greater than the center thicknesses CT2-CT7 of the second to seventh lenses 102-107, and may have the maximum thickness within the lens portion 100. At least one of the fifth and seventh lenses 105 and 107 may have the smallest center thickness CT5 and CT7 within the lens portion 100. The aspherical lens includes the sixth lens 106 and the seventh lens 107, and may satisfy the following condition: CT7<CT4<CT6<CT1. The ratio of the center thickness and the edge thickness of each lens may satisfy the following conditions.

$$0.6 < CT 1 / ET 1 < 1.2 , \qquad Condition 1$$

$$1 < CT 2 / ET 2 < 2 \qquad Condition 2$$

$$1.2 < CT 3 / ET 3 < 2.5 , \qquad Condition 3$$

$$1.5 < CT 4 / ET 4 < 3 \qquad Condition 4$$

$$0 < CT 5 / ET 5 < 1 , \qquad Condition 5$$

$$0.6 < CT 6 / ET 6 < 2 \qquad Condition 6$$

$$0.4 < CT 7 / ET 7 < 1.2 , \qquad Condition 7$$

$$0.5 < \sum CT / \sum ET < 1.2 \qquad Condition 8$$

By the conditions, the difference between the center thickness and the edge thickness of each lens may be effectively guided without increasing the light. In addition, the difference between the maximum center thickness and the minimum center thickness of the lenses may be 7 mm or more, for example, in the range of 7 mm to 10.3 mm or 8 mm to 10 mm. That is, even if the center thickness of the last aspherical lens is provided thinly, the optical performance may not be degraded, and the thickness of the camera module may be provided slimly.

The relationship between the center of each lens and the TTL may satisfy the following conditions.

$$0.15 < CT 1 / TTL < 0.5 or 0.25 \leq CT 1 / TTL \leq 0.35 \qquad Condition 1$$

$$0 < CT 2 / TTL < 0.1 , \qquad Condition 2$$

$$0 < CT 3 / TTL < 0.1 \qquad Condition 3$$

$$0.1 < CT 4 / TTL < 0.25 , \qquad Condition 4$$

$$0 < CT 5 / TTL < 0.1 \qquad Condition 5$$

$$0 < CT 6 / TTL < 0.2 , \qquad Condition 6$$

$$0 < CT 7 / TTL < 0.1 \qquad Condition 7$$

The ratio of CT1/TTL of Condition 1 may be greater than the values of Conditions 2 to 7.

The center thickness CT1 of the first lens 101 may be greater than the sum of the center thicknesses of two adjacent lenses. In addition, the center thickness CT1 of the first lens 101 may be greater than the sum of the center thicknesses of three adjacent lenses. For example, CT5+CT6<CT1, and CT2+CT3+CT4<CT1 may be satisfied.

The relationship between the cemented lens 145 and the first and sixth lenses 101 and 106 may satisfy the following conditions: Condition 1:2<CT1/CT45<3, Condition 2: 1<CT1/CT6<1.8, Condition 3:0.3<CT1/ΣCT<0.55, Condition 4:0.10<CT45/ΣCT<0.25, and Condition 5:0.15<CT6/ΣCT<0.35.

ΣCT is the sum of the center thicknesses of the lenses, and CT45 is the sum of the center thicknesses of the fourth and fifth lenses. By setting the center thickness and edge thickness of the first to seventh lenses 101-107 to the conditions, light may be guided to an optimal path according to the refractive index, Abbe number, and curvature radius of each lens within the optical system 1000.

The center distance between the first to seventh lenses 101-107 is defined as CG1-CG6, and the sum of the center distances between the first to seventh lenses 101-107 may be defined as ΣCG. Here, the center distance between the lenses is described excluding the gap between two lenses in the cemented lens. Either the center distance CG2 between the second and third lenses 102 and 103 or the center distance CG6 between the sixth and seventh lenses 106 and 107 is the maximum, and for example, the center distance CG6 between the sixth and seventh lenses 106 and 107 may be the maximum. The center distance CG3 between the third and fourth lenses 103 and 104 is minimum. The center distance between the aspherical lenses is greater than the center distance between the spherical lenses. The center thickness between each lens and the center distance between adjacent lenses may satisfy the following conditions.

$$20 < CT 1 / CG 1 < 60 , \qquad Condition 1$$

$$0 < CT 2 / CG 2 < 2 \qquad Condition 2$$

$$5 < CT 3 / CG 3 < 20 , \qquad Condition 3$$

$$3 < CT 45 / CG 5 < 10 \qquad Condition 4$$

$$0.1 < CG 6 / \sum CG < 0.6 \qquad Condition 5$$

By providing the maximum center thickness to be more than 3 times the maximum center distance between the lenses, for example, in the range of 3.5 to 7 times, it is possible to provide a camera module that applies an aspherical lens to the output side of the optical system without increasing the center distance compared to the center thickness of each lens. Here, if the center distance of the i-th center between adjacent two lenses is defined as CGi, and the center thickness of the i-th lens positioned closer to the object than CGi is defined as CTi, the following conditions may be satisfied (here, the center thickness of the cemented lens and the distance between the cemented lenses are excluded). CGi is the center distance between the i-th lens and the i+1 lens. The ratio of CTi/CGi may be minimum when i is 5 and maximum when i is 1.

Regarding the effective diameter, the lens having the maximum effective diameter may be the first lens 101 closest to the object. The first lens 101 having the maximum effective diameter may be a spherical lens. The lens having the minimum effective diameter may be the lens closest to the image sensor 300, for example, the seventh lens 107. The effective diameters of the first lens 101 to the seventh lens 107 may be defined as CA1, CA2, CA3, CA4, CA5, CA6, and CA7, the effective diameters of the first and second surfaces S1 and S2 of the first lens 101 may be defined as CA11 and CA12, the effective diameters of the thirteenth and fourteenth surfaces S13 and S14 of the seventh lens 107 may be defined as CA71 and CA72, and the effective diameters of the object-side surface and the sensor-side surface of the second to sixth lenses may be defined as CA21, CA22, CA31, CA32, CA41, CA42, CA51, CA52, CA61, and CA62. The effective diameter of each lens may satisfy the following conditions.

$$CA 22 < CA 12 , \qquad Condition 1$$

$$CA 71 < CA 72 \qquad Condition 2$$

$$CA 31 < CA 22 , \qquad Condition 3$$

$$CA 61 < CA 51 < CA 41 \qquad Condition 4$$

If the refractive index is explained, the refractive index of the fifth lens 105 is the largest among the lenses and may be greater than 1.70, for example, greater than 1.75. The refractive index of the sixth lens 106 is the smallest among the lenses. The difference between the maximum refractive index and the minimum refractive index may be greater than 0.20, for example, greater than 0.25. By adjusting the refractive indices of the spherical lens and the aspherical lens, the incident efficiency may be increased and the incident light may be guided to the image sensor 300. If the Abbe number is explained, the Abbe number of the sixth lens 106 is the largest among the lenses and may be greater than 60. The Abbe number of the seventh lens 107 is the smallest among the lenses. The difference between the maximum Abbe number and the minimum Abbe number may be greater than 30. The Abbe number of the third and fourth lenses 103 and 104 adjacent to the aperture stop ST is made larger than the Abbe number of the first lens 101 and the fifth lens 105, and the Abbe number of the seventh aspherical lens 107 closest to the image sensor 300 is made smallest, thereby controlling the color dispersion of light traveling between the lenses made of glass, and increasing the color dispersion between the spherical lens and the aspherical lens to guide it to the image sensor 300.

The average effective diameter of the spherical lens is SSL_CA_Aver, and when the average effective diameter of the aspherical lens is ASL_CA_Aver, the following condition may satisfy: ASL_CA_Aver<SSL_CA_Aver. The average of the center thickness of the spherical lens is SSL_CT_Aver, and when the average of the center thickness of the aspherical lens is ASL_CT_Aver, the following condition may satisfy: ASL_CT_Aver<SSL_CT_Aver. The average refractive index of the spherical lens is SSL_Nd_Aver, and the average refractive index of the aspherical lens is ASL_Nd_Aver, so that the following condition may satisfy: ASL_Nd_Aver<SSL_Nd_Aver. The average Abbe number of the spherical lens is SSL_Ad_Aver, and the average Abbe number of the aspherical lens is ASL_Ad_Aver, so that the following condition may satisfy: SSL_Ad_Aver<ASL_Ad_Aver.

The focal lengths F1, F5, and F7 of the first, fifth, and seventh lenses 101, 105, and 107 have negative refractive power, and the focal lengths F2, F3, F4, and F6 of the second, third, fourth, and sixth lenses 102, 103, 104, and 106 may have positive refractive power. In addition, the sixth and seventh lenses 106 and 107, which are adjacently arranged lenses, may satisfy the following condition.

Refractive index of lens with positive refractive power<Refractive index of lens with negative refractive power Condition 1:

Dispersion of lens with positive refractive power>Dispersion of lens with negative refractive power Condition 2:

Here, since the sixth lens 106 has positive refractive power and the seventh lens 107 has negative refractive power, according to the conditions 1 and 2, the refractive index of the sixth lens 106 is smaller than the refractive index of the seventh lens 107, and the dispersion value of the sixth lens 106 is larger than the dispersion value of the seventh lens 107. The chromatic aberration occurring in the fourth and fifth lenses may be corrected with aspherical lenses. In addition, by satisfying the refractive index difference between the sixth and seventh lenses 106 and 107 arranged sequentially being 0.2 or more and 0.6 or less and the Abbe number difference being 30 or more and 70 or less, the chromatic aberration occurring in the spherical lens may be compensated for with the aspherical lens.

The optical system 1000 generates chromatic aberration and corrects the chromatic aberration by using a cemented lens 145 or two lenses arranged in series. The lens contracts and expands repeatedly as the temperature changes from low to high. Since the lens characteristics of lenses of the same material change in accordance with the temperature change in the same amount, it is effective to correct the chromatic aberration between lenses of the same material even when the temperature changes. The chromatic aberration between the spherical lens and the aspherical lens may be mutually corrected by using the fourth and fifth lenses 104 and 105 and the sixth and seventh lenses 106 and 107. The refractive index difference between the fourth lens 104 and the fifth lens 105, which are the cemented lenses, is 0.01 or more and 0.30 or less, and the Abbe number difference is 20 or more and 40 or less, and the chromatic aberration generated in the spherical lenses may be compensated for by the spherical lens. The refractive index difference is rounded off to the third decimal place, and the Abbe number difference is rounded off to the first decimal place, and the values are compared. In addition, by arranging glass lenses with a relatively high Abbe number on the object side of the aspherical seventh lens 107, chromatic dispersion may be reduced by the glass lenses and chromatic dispersion may be increased by the aspherical lenses.

When the focal length is expressed as an absolute value, the focal length of the first lens 101 is the largest among the lenses, and may be 45 or more. The focal length of the fifth lens 105 is the smallest among the lenses. The difference between the maximum focal length and the minimum focal length may be 35 or more. By making the focal length of the lens closest to the object the largest, and providing the focal length of the fifth lens 105 adjacent to the aspherical lens the smallest, the optical system may have improved MTF characteristics, aberration control characteristics, resolution characteristics, etc. in the set field of view range, and may have good optical performance in the periphery of the field of view. The sensor-side surface of the seventh lens 107 has a Sag value that increases from the optical axis to a point of 2.8 mm±0.4 mm in a direction perpendicular to the optical axis, and then decreases toward the edge from a point of 2.8 mm±0.4 mm. If a critical point exists on the sensor side of the seventh lens 107, that is, on the sensor side of the last lens, that is, on the lens surface closest to the sensor, TTL may be reduced, which facilitates miniaturization and weight reduction of the optical system.

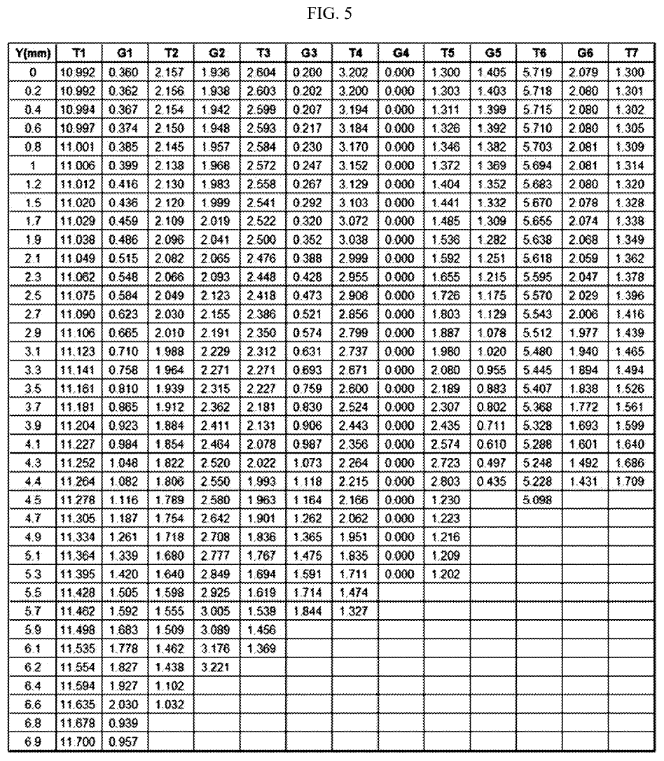

As shown in FIG. 4, among the lenses of the lens portion 100 in the first embodiment, the lens surfaces of the sixth and seventh lenses 106 and 107 may include aspherical surfaces having a 30th aspherical coefficient. For example, the sixth and seventh lenses 106 and 107 may include lens surfaces having a 30th aspherical coefficient. As described above, since an aspherical surface having a 30th aspherical coefficient (a value other than “0”) can significantly change the aspherical shape of the peripheral portion, the optical performance of the peripheral portion of the FOV may be well compensated. As shown in FIG. 5, the thicknesses T1-T7 of the first to seventh lenses 101-107 and the distances G1-G6 between adjacent two lenses may be set. As shown in FIG. 5, the thickness T1-T7 of each lens in the Y-axis direction perpendicular to the optical axis may be expressed at intervals of 0.1 mm or 0.2 mm or more from the optical axis, and the distance G1-G6 between each lens may be expressed at intervals of 0.1 mm or 0.2 mm or more from the optical axis.

The center thickness CT45 of the cemented lens 145 may be greater than the edge thickness ET45. The center thickness CT45 of the cemented lens 145 is the distance in the optical axis direction from the center of the object-side seventh surface S7 of the fourth lens 104 to the center of the tenth surface S10 of the fifth lens 105, and the edge thickness ET45 is the distance in the optical axis direction from the end of the effective region of the seventh surface S7 to the tenth surface S10. The maximum thickness of the cemented lens 145 is at the center, the minimum thickness is at the edge, and the maximum thickness may be at least 1 time the minimum thickness, for example, in the range of 1 to 1.5 times. The maximum thickness of the sixth lens 106 is at the center, the minimum thickness is at the edge, and the maximum thickness may be 1.5 times or less the minimum thickness. The maximum thickness of the seventh lens 107 is at the edge, the minimum thickness is at the center, and the maximum thickness may be 1.5 times or less the minimum thickness.

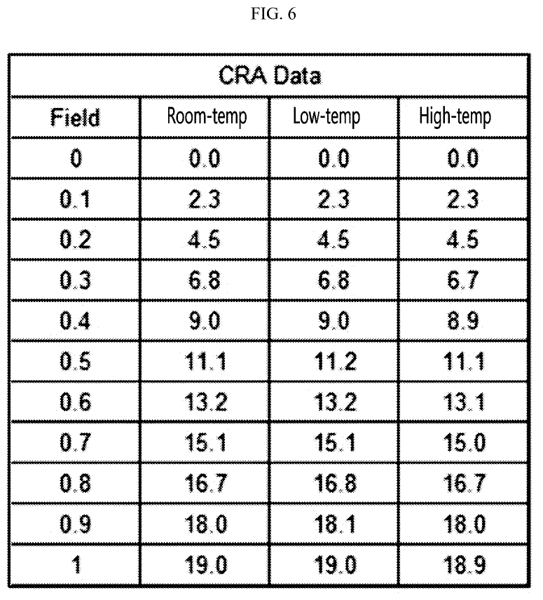

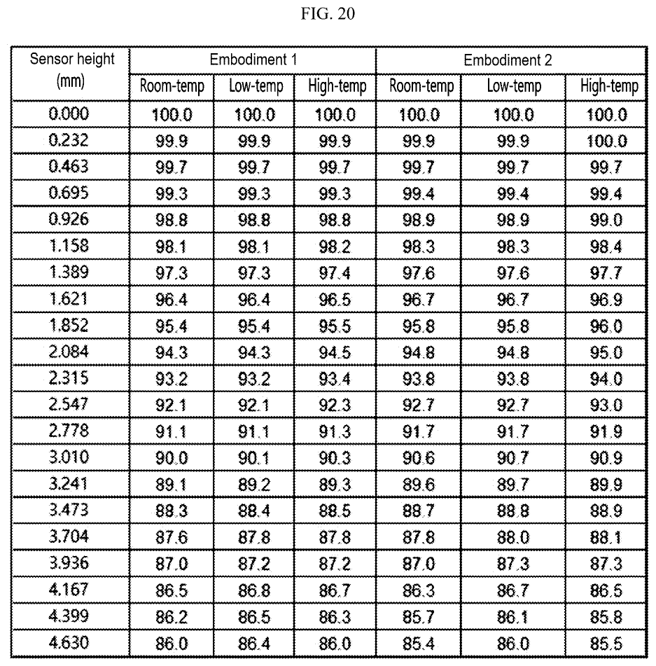

As shown in FIG. 6, the chief ray angle (CRA) of the optical system and camera module of FIG. 1 may be 10 degrees or more, for example, in the range of 10 to 35 degrees or 10 to 25 degrees. As shown in FIG. 20, a graph showing the relative illumination or the ambient light ratio according to the image height in the optical system according to the embodiment may be seen that the ambient light ratio is 80% or more, for example, 84% or more from the center of the image sensor to the diagonal end according to the temperature changes of room temperature, low temperature, and high temperature. That is, it may be seen that the difference in the ambient illumination according to the temperature change is almost the same up to 4.6 mm from the optical axis.

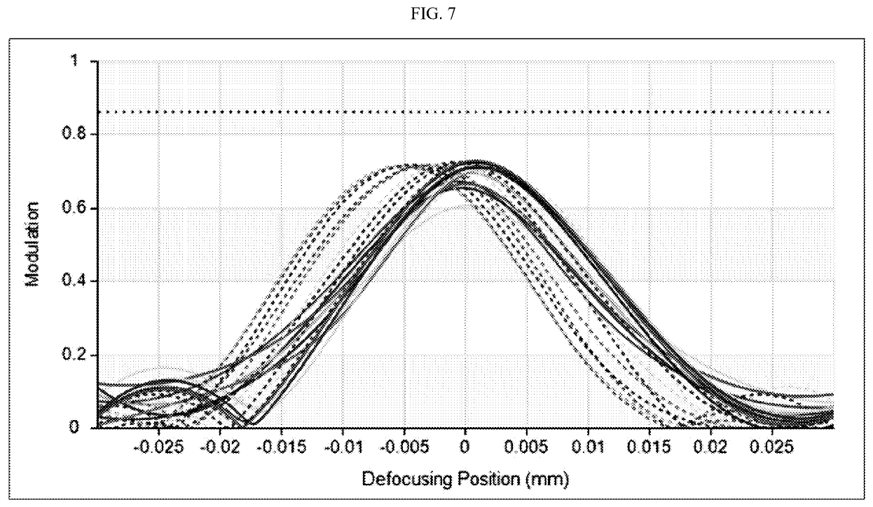

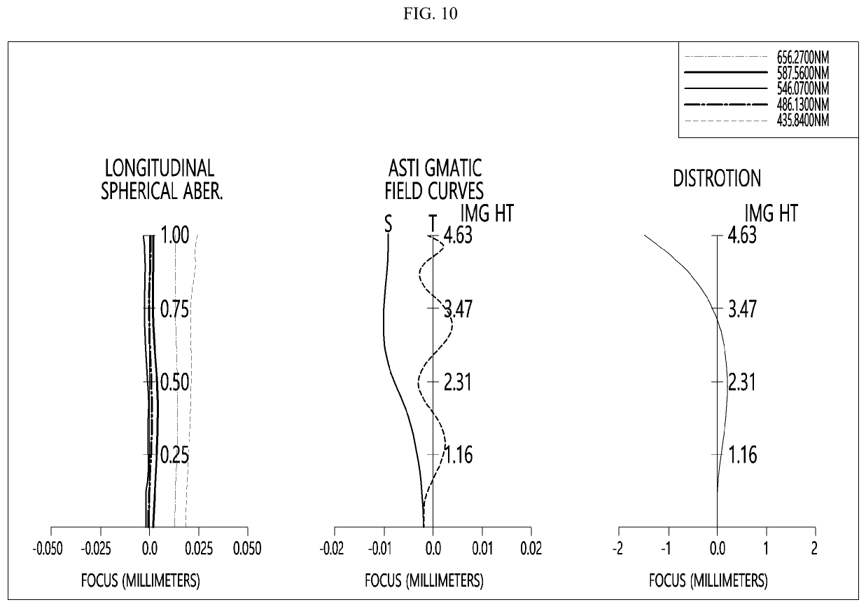

FIGS. 7 to 9 are graphs showing the diffraction MTF at room temperature, low temperature, and high temperature in the optical system of FIG. 1, and are graphs showing the modulation according to the spatial frequency. As shown in FIGS. 7 to 9, in the first embodiment of the invention, the deviation of MTF at low temperature or high temperature with respect to room temperature may be less than 10%, that is, 7% or less. FIGS. 10 to 12 are graphs showing aberration characteristics at room temperature, low temperature, and high temperature in the optical system of FIG. 1. The aberration graphs of FIGS. 10 to 12 are graphs measuring spherical aberration (Longitudinal Spherical Aberration), astigmatic field curves, and distortion from left to right. In FIGS. 10 to 12, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graph for astigmatism and distortion is a graph for light in wavelength bands of about 546 nm. In the aberration diagrams of FIGS. 10 to 12, it may be interpreted that the closer each curve at room temperature, low temperature, and high temperature is to the Y-axis, the better the aberration correction function is. It may be seen that the optical system 1000 according to the embodiment has measurement values close to the Y-axis in almost all areas. That is, the optical system 1000 according to the embodiment has improved resolution and may have good optical performance not only in the center portion of the FOV but also in the periphery portion. Here, the low temperature is −20 degrees or less, for example, −20 to −40 degrees, the room temperature is 22 degrees±5 degrees or 18 to 27 degrees, and the high temperature may be 85 degrees or more, for example, 85 to 105 degrees. Accordingly, it may be seen that the reduction in the modulation from the low temperature to the high temperature in FIGS. 10 to 12 is less than 10%, for example, 5% or less, or is almost unchanged.

Table 1 compares the changes in optical characteristics such as EFL, BFL, F number, TTL, and diagonal FOV at room temperature, low temperature, and high temperature in the optical system according to the first embodiment, and it may be seen that the change rate of the optical characteristics at low temperature is 5% or less, for example, 3% or less, based on room temperature, and it may be seen that the change rate of the optical characteristics at low temperature is 5% or less, for example, 3% or less, based on room temperature.

TABLE 1

| | | | | Low | High |
|---|---|---|---|---|---|
| | Room | Low | High | temperature/Room | temperature/Room |
| | temperature | temperature | temperature | temperature (%) | temperature (%) |
| EFL | 15.1 | 15.1 | 15.2 | 99.9% | 100.2% |
| BFL | 2.7 | 2.7 | 2.7 | 99.9% | 100.1% |
| F# | 1.6 | 1.6 | 1.6 | 100.0% | 100.0% |
| TTL | 36 | 35.9 | 36 | 99.9% | 100.1% |
| FOV | 24.1 | 24.2 | 24.1 | 100.1% | 99.9% |

Therefore, as shown in Table 1, the change in optical characteristics according to the temperature change from low temperature to high temperature, for example, the change rate of the EFL, TTL, BFL, F number (F #), and diagonal FOV is 10% or less, that is, 5% or less, for example, in the range of 0 to 5%. This means that even if at least one or two or more aspherical lenses are used, the temperature compensation for the aspherical lens may be designed to prevent the reliability of the optical characteristics from deteriorating. In addition, it may be seen that even if the temperature changes from room temperature to low or high temperature, the EFL, TTL, BFL, F number (F #), and diagonal FOV hardly change. The optical system of the embodiment disclosed above can effectively control aberration characteristics such as chromatic aberration and distortion aberration, and may have good optical performance not only in the center portion but also in the periphery portion of the FOV.

The optical system and camera module according to the second embodiment of the invention will be described with reference to FIGS. 13 to 19. The configuration of the second embodiment will be described with reference to the first embodiment, and the configurations different from the first embodiment will be described.

Referring to FIGS. 13 and 14, the optical system 1000 according to the second embodiment includes a lens portion 100A, and the lens portion 100A may include a first lens 111 to a seventh lens 117. The first and second lenses 111 and 112 may be a first lens group LG1, and the third to seventh lenses 113, 114, 115, 116, and 117 may be a second lens group LG2.

The first lens 111 may have negative (−) refractive power and may be made of glass. The object-side first surface S1 of the first lens 111 on the optical axis may be concave, and the sensor-side second surface S2 may have a convex shape. The first lens 111 may have a meniscus shape that is convex toward the sensor side. The first lens 111 is made of a spherical glass material, has high transmittance and refractive index, and is provided with a thick thickness, thereby preventing deterioration of the optical characteristics of the incident-side lens and protecting the surface. The second lens 112 has positive (+) refractive power on the optical axis OA and may be made of a spherical glass material. The third surface S3 of the second lens 112 on the optical axis OA may be convex, and the fourth surface S4 may have a concave shape. An aperture stop ST may be arranged on the periphery of the sensor-side surface of the second lens 112. The third lens 113 has positive (+) refractive power on the optical axis OA and may include a glass material. The object-side fifth surface S5 of the third lens 113 on the optical axis may be convex, and the sensor-side sixth surface S6 may have a concave shape. The third lens 113 may be provided as a spherical lens made of glass.

The fourth lens 114 has positive (+) refractive power on the optical axis OA and may include a spherical glass material. The object-side seventh surface S7 of the fourth lens 114 on the optical axis may be convex, and the sensor-side eighth surface S8 may have a concave shape. The fifth lens 115 has negative (−) refractive power on the optical axis OA and may be provided as a spherical glass material. Based on the optical axis OA, the ninth surface on the object side of the fifth lens 115 may have a convex shape, and the tenth surface S10 on the sensor side may have a concave shape. The fourth lens 114 and the fifth lens 115 may be bonded and may be defined as a cemented lens 145. The fourth and fifth lenses 114 and 115 may have opposite refractive powers. The composite refractive power of the fourth and fifth lenses 114 and 115 may have positive refractive power. When the composite refractive power of the cemented lens 145 is F45, the composite refractive power of the first and second lenses 101 and 102 is F12, and the composite refractive power of the third to seventh lenses 103-107 is F37, the following condition in absolute value may satisfy: F37<F45<F12.

The effective diameter of the fourth lens 114 may be larger than the diagonal length of the image sensor 300. The effective diameter of the fifth lens 115 may be smaller than the effective diameter of the fourth lens 114 and may have a length within a range of ±110% or ±105% of the diagonal length of the image sensor 300. For example, the effective diameter of the tenth surface S10 of the fifth lens 115 may be larger than the diagonal length of the image sensor 300. Since the cemented lens 145 is located between the spherical lens and the aspherical lens, chromatic aberration correction may be more efficient.

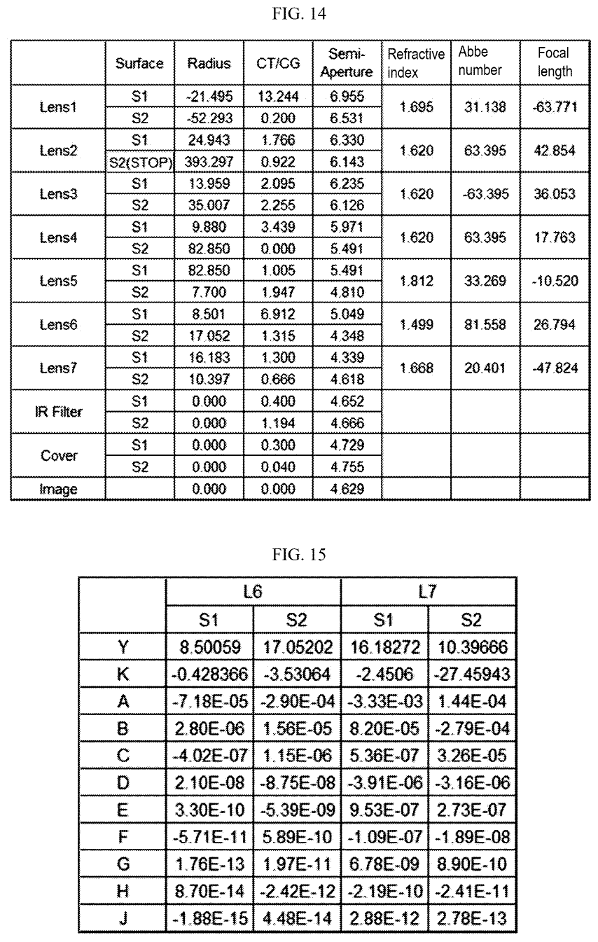

The sixth lens 116 may have positive (+) refractive power on the optical axis OA and may be provided with a glass material. Based on the optical axis OA, the eleventh surface S11 on the object side of the sixth lens 116 may be convex, and the twelfth surface S12 on the sensor side may be concave. The sixth lens 116 may be made of glass and may have aspherical surfaces on both sides. The eleventh surface S11 and the twelfth surface S12 may have aspherical surfaces, and aspherical coefficients may be provided as S1 and S2 of L6 of FIG. 15. Since the sixth lens 116 is made of an aspherical glass material, the refractive efficiency of light may be improved, and the thickness may be increased to improve the assembly problem caused by the aspherical lens. In addition, the sixth lens 116 made of a glass material with a thick thickness can perform heat compensation according to temperature change, thereby preventing deterioration of optical characteristics. The sixth lens 116 is disposed between the spherical lens and the aspherical lens, so that the deterioration of optical performance may be prevented, and the influence on the improvement of aberration characteristics and resolution may be controlled.

The seventh lens 117 has a negative (−) refractive power on the optical axis, and may be provided as an aspherical plastic lens. The object-side thirteenth surface S13 of the seventh lens 117 on the optical axis may have a convex shape, and the sensor-side fourteenth surface S14 may have a concave shape. The seventh lens 117 may be made of a plastic material and have aspherical surfaces on both sides. The thirteenth surface S13 and the fourteenth surface S14 have aspherical surfaces, and the aspherical coefficients may be provided as S1 and S2 of L7 of FIG. 15. The thirteenth surface S13 of the seventh lens 117 may have at least one critical point from the optical axis OA to the end of the effective region. The critical point of the thirteenth surface S13 may be located at a position less than or equal to 2.7 mm from the optical axis OA, for example, in a range of 2 mm to 2.7 mm. As another example, the thirteenth surface S13 may be provided without a critical point. The fourteenth surface S14 of the seventh lens 117 may have at least one critical point from the optical axis OA to an end of the effective region. The critical point of the fourteenth surface S14 may be located closer to the edge than the critical point of the thirteenth surface S13, and may be located at a position more than or equal to 2.9 mm from the optical axis OA, for example, in a range of 2.9 mm to 3.7 mm. Since the fourteenth surface S14 and the thirteenth surface S13 have critical points, they can refract incident light to the periphery of the image sensor 300. In the seventh lens 117, if the Sag value of the object-side surface is Sag71 and the Sag value of the sensor-side surface is Sag72, the following condition may satisfy: 0<|Sag71|−|Sag72|<0.3 mm. Accordingly, since the difference in the thickness between the center and the edge of the seventh lens 117 is not large and the curvature radius is not large, the influence on the optical characteristics may be suppressed. Since the sixth and seventh lenses 116 and 117 are arranged as aspherical lenses, they are resistant to temperature changes, can reduce the number of lenses, and can reduce the TTL of the optical system.

FIG. 14 is an example of lens data of the optical system of the embodiment of FIG. 13. As shown in FIG. 14, the absolute value of the curvature radius of the first lens 111 on the optical axis may be smaller than the absolute value of the curvature radius of the second lens 112 arranged on the object side of the aperture stop ST. The absolute value of the curvature radius of the object-side surface of the i-th lens is Roi, the absolute value of the curvature radius of the sensor side is Rsi, and the absolute value of the average of the object-side surface and the sensor-side surface is Ri. The value of (Roi−Rsi)/Ri may be minimum when i is 7 and maximum when i is 2. Here, when i is 6 or 7, the value of (Roi−Rsi)/Ri may be less than 1, for example, 0.8 or less. Accordingly, each of the plurality of aspherical lenses may have a difference between the curvature radius of the object-side surface and the sensor-side surface and the average of the curvature radius of each aspherical lens smaller than that of the spherical lenses. Since the first lens 111 is provided as a spherical lens having a thick thickness, the curvature radius in the optical axis may be increased, the difference between the curvature radius of the object-side surface and the sensor-side surface cannot be greatly reduced, and the assemblability may be improved.

The curvature radius of the sixth and seventh lenses 116 and 117 on the optical axis may be smaller than the curvature radius of the first spherical lens 111. Accordingly, the aspherical sixth and seventh lenses 116 and 117 may guide light incident through the first to fifth lenses 111-115 to the entire region of the image sensor 300. The ratio of the curvature radius of each lens may satisfy the following conditions.

$$0 < \vert L 1 R 1 / L 1 R 2 \vert < 1 , \qquad Condition 1$$

$$0 < \vert L 2 R 1 / L 2 R 2 \vert < 0.2 \qquad Condition 2$$

$$0 < L 3 R 1 / L 3 R 2 < 0.5 , \qquad Condition 3$$

$$0 < L 4 R 1 / L 4 R 2 < 0.5 \qquad Condition 4$$

$$5 < L 5 R 1 / L 5 R 2 < 15 , \qquad Condition 5$$

$$0.1 < L 6 R 1 / L 6 R 2 < 1 \qquad Condition 6$$

$$1 < L 7 R 1 / L 7 R 2 < 2.2 \qquad Condition 7$$

When explaining the thickness of the lenses, the center thickness CT1 of the first lens 111 may have the maximum thickness within the lens portion 100A. The center thickness CT6 of the sixth lens 116 may be greater than the center thicknesses of the second to fifth lenses 112-115 and greater than the center thickness of the seventh lens 117. The center thickness CT5 of the fifth lens 115 may have the minimum thickness within the lens portion 100A. The center thickness CT1 of the first lens 111 may be greater than the center thickness CT45 of the cemented lens 145. The edge thickness ET1 of the first lens 111 may be greater than the edge thickness ET45 of the cemented lens 145. The center thickness and the edge thickness of each lens may satisfy the following conditions.

$$0.6 < CT 1 / ET 1 < 1.2 , \qquad Condition 1$$

$$1 < CT 2 / ET 2 < 3 \qquad Condition 2$$

$$1 < CT 3 / ET 3 < 3 , \qquad Condition 3$$

$$1 < CT 4 / ET 4 < 3 \qquad Condition 4$$

$$0 < CT 5 / ET 5 < 1 , \qquad Condition 5$$

$$0.6 < CT 6 / ET 6 < 1.5 \qquad Condition 6$$

$$0 < CT 7 / ET 7 < 1.2 , \qquad Condition 7$$

$$1 < \sum CT / \sum ET < 1.5 \qquad Condition 8$$

The center distance CG3 between the third lens 113 and the fourth lens 114 is maximum and is larger than the center distance between the spherical lens and the aspherical lens. The center distance CG6 between the sixth lens 116 and the seventh lens 117 may satisfy the following condition: CG1<CG2<CG6. The center thickness between each of the lenses and the center distance between adjacent lenses may satisfy the following conditions.

$$20 < CT 1 / CG 1 < 80 , \qquad Condition 1$$

$$2 \leq CT 2 / CG 2 < 5 \qquad Condition 2$$

$$0.5 < CT 3 / CG 3 < 2 , \qquad Condition 3$$

$$3 < CT 45 / CG 5 < 10 \qquad Condition 4$$

$$0.1 < CG 3 / \sum CG < 0.6 , \qquad Condition 5$$

$$0.1 < CT 1 / CG 3 < 0.6 \qquad Condition 6$$

By providing the maximum center thickness to be at least 3 times the maximum center distance between the lenses, for example, in the range of 3 to 7 times, it is possible to provide a camera module that applies aspherical lenses to the incident side and the output side of the optical system without increasing the center distance compared to the center thickness of each lens. Here, if the center distance of the i-th lens among the center distances of two adjacent lenses is defined as CGi, and the center thickness of the i-th lens positioned closer to the object than CGi is defined as CTi, the following conditions may be satisfied. The ratio of CTi/CGi may be maximum when i is 1, and minimum when i is 5 (excluding the thickness of the cemented lens and the distance between the cemented lenses).

The relationship between the center thickness of each lens and the TTL may satisfy the following conditions.

$$0.2 < CT 1 / TTL < 0.5 or 0.3 < CT 1 / TTL < 0.37 \qquad Condition 1$$

$$0 < CT 2 / TTL < 0.2 or 0 < CT 1 / TTL < 0.1 \qquad Condition 2$$

$$0 < CT 3 / TTL < 0.1 , \qquad Condition 3$$

$$0.1 < CT 4 / TTL < 0.25 \qquad Condition 4$$

$$0 < CT 5 / TTL < 0.1 , \qquad Condition 5$$

$$0.1 < CT 6 / TTL < 0.3 \qquad Condition 6$$

$$0 < CT 7 / TTL < 0.1 \qquad Condition 7$$

The ratio of CT1/TTL of Condition 1 may be greater than the values of Conditions 2 to 7.

In terms of the effective diameter, the lens having the maximum effective diameter may be the first lens 111. The first lens 111 having the maximum effective diameter may be a spherical lens. The lens having the minimum effective diameter may be the lens closest to the image sensor 300, for example, the seventh lens 117. The effective diameter of each lens may satisfy the following conditions.

$$CA 22 < CA 12 , \qquad Condition 1$$

$$CA 71 < CA 72 \qquad Condition 2$$

$$CA 22 < CA 31 , \qquad Condition 3$$

$$CA 61 < CA 51 < CA 41 \qquad Condition 4$$

$$CA 4 < CA 2 < CA 1 , \qquad Condition 5$$

$$CA 5 < CA 4 < CA 3 \qquad Condition 6$$

Regarding the refractive index, the refractive index of the fifth lens 115 is the maximum among the lenses, and may be greater than 1.70, for example, greater than 1.80. The refractive index of the sixth lens 116 is the minimum among the lenses. The difference between the maximum refractive index and the minimum refractive index may be greater than 0.25, for example, greater than 0.30. By adjusting the refractive indices of the spherical lens and the aspherical lens, the incident efficiency may be increased, and the incident light may be guided to the image sensor 300. In explaining the Abbe number, the Abbe number of the sixth lens 116 is the largest among the lenses and may be 60 or more. The Abbe number of the seventh lens 117 is the smallest among the lenses. The difference between the maximum refractive index and the minimum Abbe number may be 30 or more.

The optical system 1000 causes chromatic aberration and corrects the chromatic aberration by using a cemented lens 145 or two lenses arranged in series. The lens repeatedly contracts and expands as the temperature changes from low to high. Since the lens characteristics of the same material change the same amount according to the temperature change, it is effective to correct the chromatic aberration between the lenses of the same material even when the temperature changes. The chromatic aberration between the spherical lens and the aspherical lens may be mutually corrected by using the fourth and fifth lenses 114 and 115 and the sixth and seventh lenses 116 and 117, and the TTL of the optical system may be reduced. The refractive index difference between the fourth lens 114 and the fifth lens 115, which are the joined lenses, is 0.01 or more and 0.30 or less, and the Abbe number difference is 20 or more and 40 or less, and the chromatic aberration occurring in the spherical lenses may be compensated for by the spherical lens.

If the focal length is expressed as an absolute value, the focal length of the first lens 111 is the largest among the lenses and may be 45 or more. The focal length of the fifth lens 115 is the smallest among the lenses. The difference between the maximum focal length and the minimum focal length may be 35 or more. By making the focal length of the lens closest to the object the largest and providing the focal length of the fifth lens 115 adjacent to the aspherical lens the smallest, the optical system may have improved MTF characteristics, aberration control characteristics, resolution characteristics, etc. in the set field of view range, and may have good optical performance in the periphery of the field of view. The critical point and Sag value of the object-side surface and the sensor-side surface of the seventh lens 117 above shall refer to the description of the first embodiment.

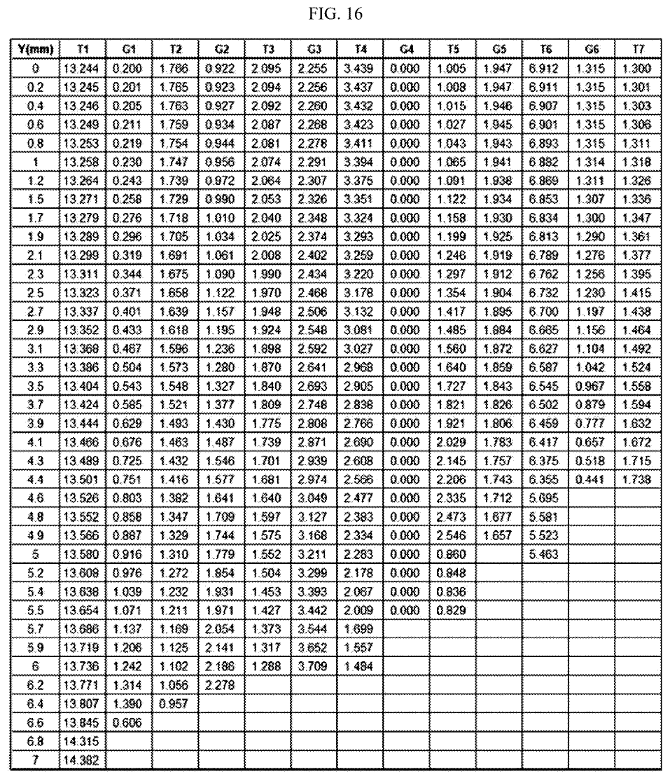

As shown in FIG. 15, among the lenses of the lens portion 100A in the embodiment, the lens surfaces of the sixth and seventh lenses 116 and 117 may include aspherical surfaces having a 30th aspherical coefficient. For example, the sixth and seventh lenses 116 and 117 may include lens surfaces having a 30th aspherical coefficient. As described above, since the aspherical surface having a 30th aspherical coefficient (a value other than “0”) can significantly change the aspherical shape of the peripheral portion, the optical performance of the peripheral portion of the FOV may be well corrected. As shown in FIG. 16, the thickness T1-T7 of the first to seventh lenses 121-127 and the distance G1-G6 between adjacent two lenses may be expressed at intervals of 0.1 mm or 0.2 mm or more in the Y-axis direction from the optical axis.

The center thickness CT45 of the cemented lens 145 may be greater than the edge thickness ET45. The center thickness CT45 of the cemented lens 145 is the distance from the center of the object-side seventh surface S7 of the fourth lens 114 to the center of the tenth surface S10 of the fifth lens 115, and the edge thickness ET45 is the distance from the end of the effective region of the seventh surface S7 to the tenth surface S10 in the optical axis direction. The maximum thickness of the cemented lens 145 is at the center, the minimum thickness is at the edge, and the maximum thickness may be 1.1 times or more of the minimum thickness, for example, in the range of 1.1 to 2.5 times.

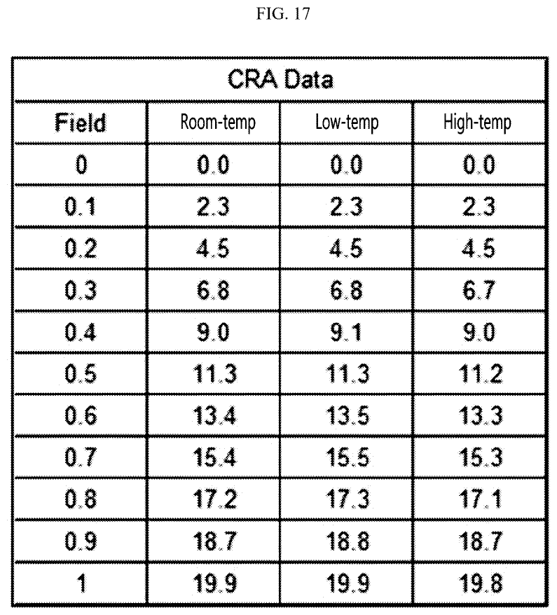

As shown in FIG. 17, CRA in the optical system and camera module of FIG. 13 may be 10 degrees or more, for example, in the range of 10 to 35 degrees or in the range of 10 to 25 degrees. As shown in FIG. 20, a graph showing the relative illumination or the ambient light ratio according to the image height in the optical system according to the embodiment may be seen that the ambient light ratio is 70% or more, for example, 75% or more, from the center of the image sensor to the diagonal end depending on the temperature change between low and high temperatures.

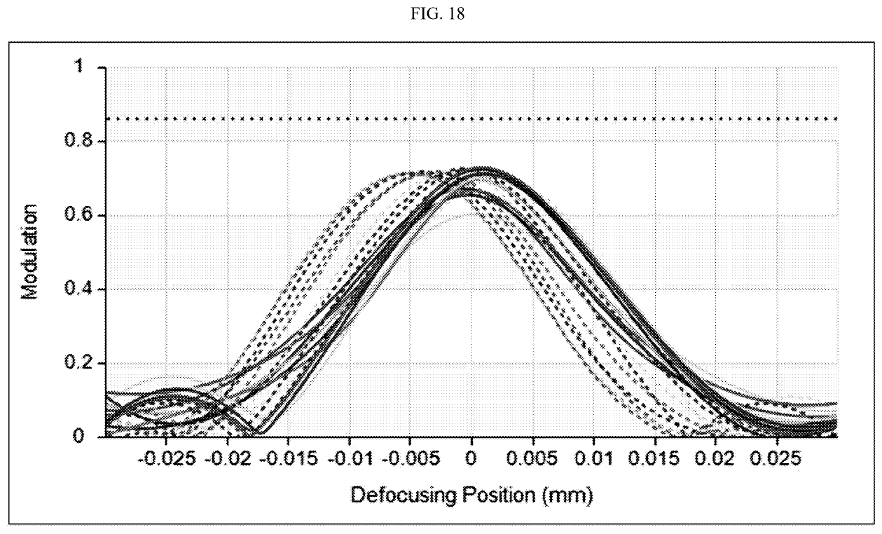

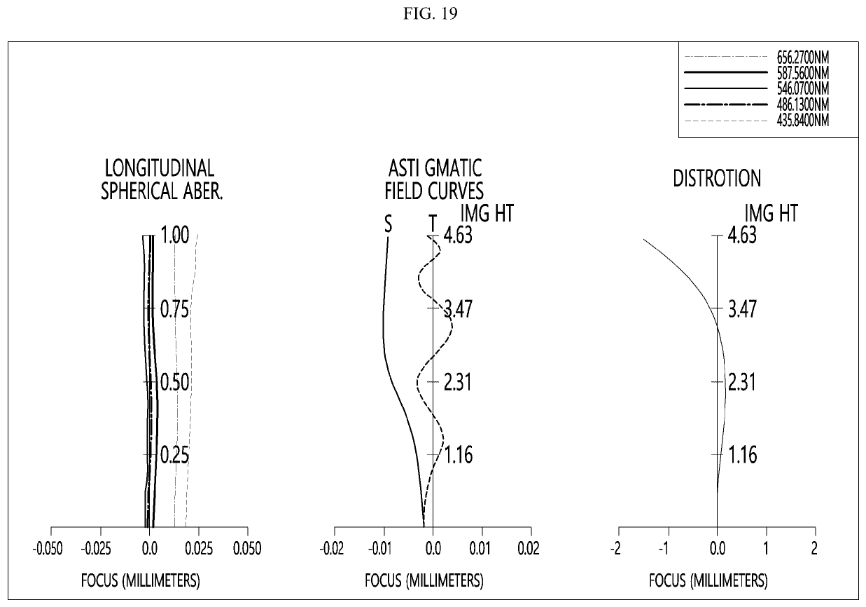

FIG. 18 is a graph showing a diffraction MTF at room temperature in the optical system of FIG. 13, and is a graph showing a modulation ratio according to spatial frequency. In the second embodiment of the invention, the deviation of the MTF with respect to the low temperature or high temperature based on the room temperature may be less than 10%, that is, 7% or less. FIG. 19 is a graph showing aberration characteristics at room temperature in the optical system of FIG. 13. In the aberration diagram of FIG. 19, it may be interpreted that the closer each curve at room temperature is to the Y-axis, the better the aberration correction function is. It may be seen that in the optical system 1000 according to the embodiment, the measured values are close to the Y-axis in almost all areas. That is, the optical system 1000 according to the embodiment has improved resolution and may have good optical performance not only in the center portion of the FOV but also in the periphery portion. Here, the low temperature is −20 degrees or less, for example, in the range of −20 to −40 degrees, the room temperature is in the range of 22 degrees±5 degrees or in the range of 18 degrees to 27 degrees, and the high temperature may be 85 degrees or more, for example, in the range of 85 to 105 degrees. Accordingly, it may be seen that the decrease in the luminance ratio (modulation) from the low temperature to the high temperature in FIGS. 10 to 12 is less than 10%, for example, 5% or less, or is hardly changed. Accordingly, it may be seen that the optical system according to the second embodiment has changes in optical characteristics, for example, changes in the EFL, TTL, BFL, F number, and diagonal FOV, according to the temperature change from the low temperature to the high temperature of 10% or less, that is, 5% or less, for example, in the range of 0 to 5%. This makes it possible to design temperature compensation for the aspherical lens even when at least one or two or more aspherical lenses are used, thereby preventing a decrease in the reliability of the optical characteristics. The optical system of the embodiment disclosed above can effectively control aberration characteristics such as chromatic aberration and distortion aberration, and may have good optical performance not only at the center portion of the FOV but also at the periphery portion.

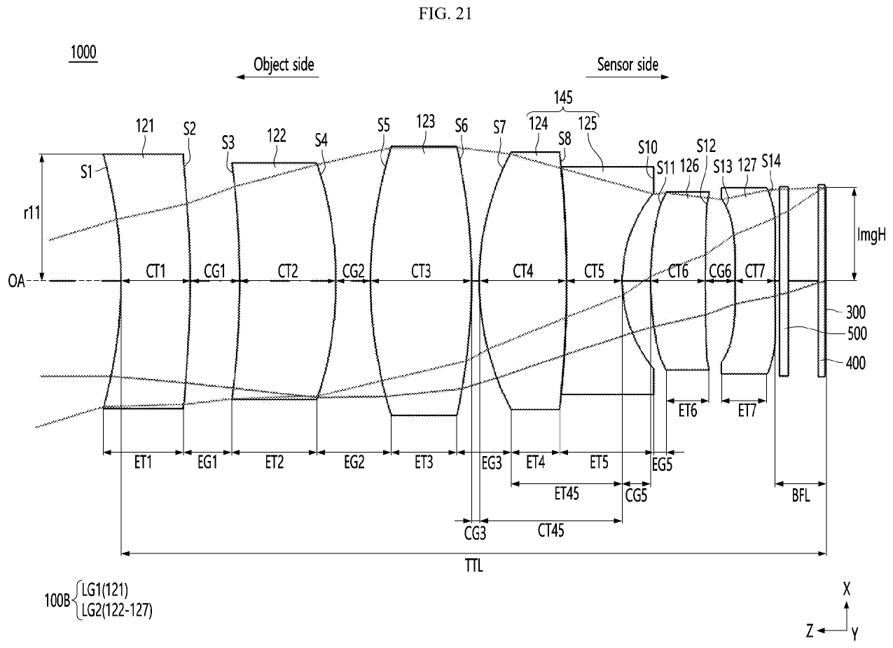

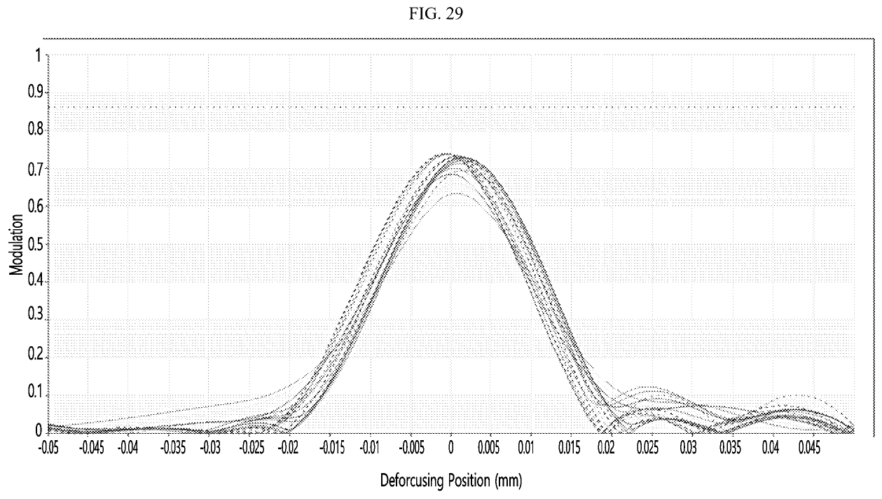

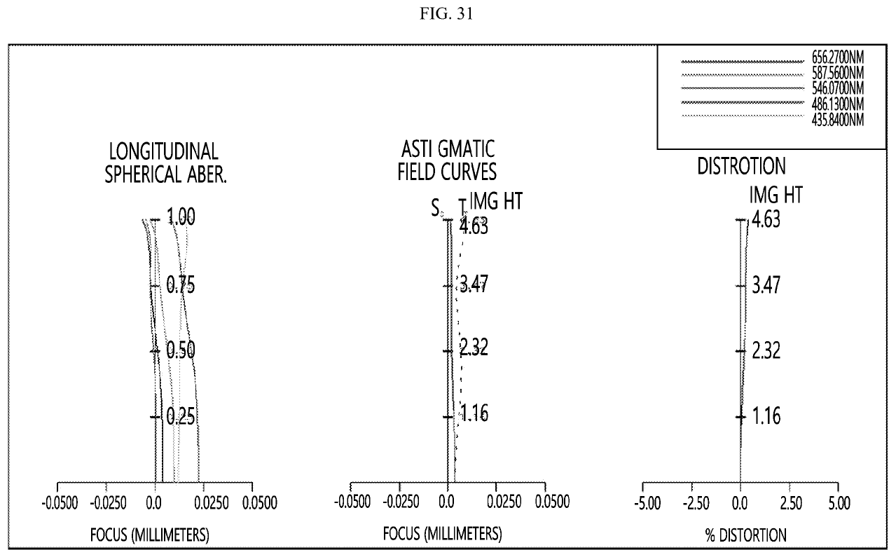

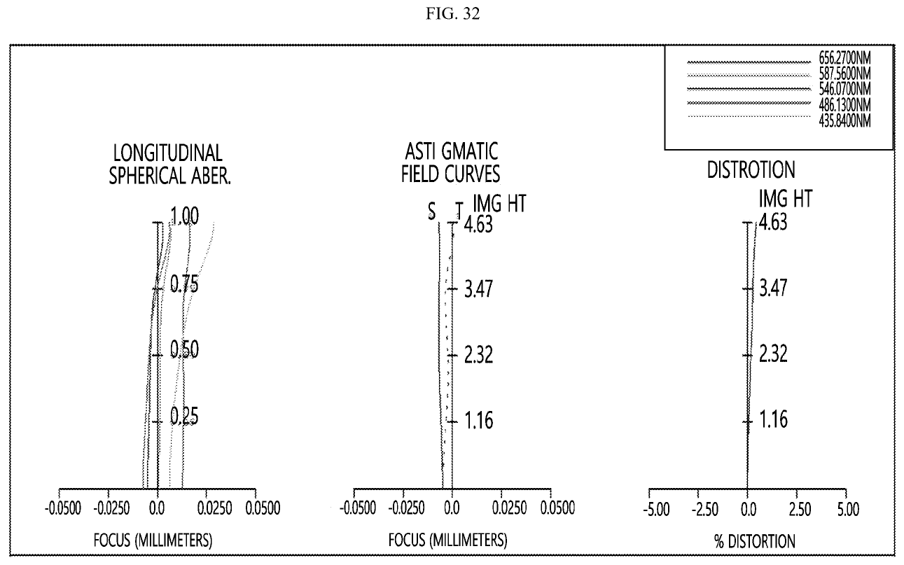

The optical system and camera module according to the third embodiment of the invention will be described with reference to FIGS. 21 to 33. In the third embodiment, the same configuration as that of the first and second embodiments will be described with reference to the description of the first and second embodiments.

Referring to FIG. 21, the lens portion 100B includes first and second lens groups LG1 and LG2, and the number of lenses of the second lens group LG2 may be more than four times or more than five times the number of lenses of the first lens group LG1. The second lens group LG2 may include two or more lenses made of glass, and may include, for example, two to five lenses made of glass. The second lens group LG2 may include one or more plastic lenses, for example, one to three plastic lenses.

At least two lenses closest to the sensor side in the optical system 1000 may be plastic lenses. The lens having the maximum Abbe number may be located in the second lens group LG2, and the lens having the maximum refractive index may be located in the first lens group LG1. The maximum Abbe number may be 65 or more, and the maximum refractive index may be 1.75 or more. The lens having the maximum effective diameter may be a lens close to the object side, or one of the lenses between the two object-side lenses and the two sensor-side lenses. Preferably, the lens having the maximum effective diameter may be disposed between the glass-side lenses.

The TTL may be more than 2 times, for example, more than 4 times and less than 10 times, of the ImgH. The EFL is provided as 10 mm or more and the FOV is less than 45 degrees, so that it may be provided as a standard optical system in a vehicle camera module. The condition of TTL/(2*ImgH) may be 2.5 or more or 2.7 or more, for example, may be in the range of 2.5 to 4.5. By setting the value of TTL/(2*ImgH) to 2.5 or more in the optical system 1000, a vehicle lens optical system may be provided.

The effective diameter of at least one or all plastic lenses in the optical system 1000 may be smaller than the length of the image sensor 300. The effective diameter is the diameter or length of the effective region where light is incident. The length of the image sensor 300 is the maximum length of the diagonal in the direction orthogonal to the optical axis OA. The number of lenses having an effective diameter larger than the length of the image sensor 300 in the optical system 1000 may be 50% or more, and the number of lenses having an effective diameter smaller than the length of the image sensor 300 may be less than 50%.

The effective diameters of the lenses arranged on the object side based on the cemented lens 145 in the lens portion 100B may be larger than the length of the image sensor 300. The effective diameters of the lenses arranged on the sensor side based on the cemented lens 145 may be smaller than the length of the image sensor 300. In addition, the object-side lens among the cemented lenses 145 may be larger than the length of the image sensor 300, and the sensor-side lens may be arranged within a range of #110% of the length of the image sensor 300.

The optical axis distance between the first lens group LG1 and the second lens group LG2 may be 1 time or less of the center distance of the first lens group LG1, and may be, for example, in a range of 0.5 to 1 time of the center distance of the first lens group LG1. The center distance between the first lens group LG1 and the second lens group LG2 may be 0.2 times or less of the center distance of the second lens group LG2, and may be, for example, in a range of 0.01 to 0.2 times. Here, among the lens surfaces of the first lens group LG1 and the second lens group LG2, two surfaces facing each other, for example, the sensor-side surface of the object-side lens, may be convex and the object-side surface of the sensor-side lens may be concave. That is, in the first lens group LG1, the sensor-side surface closest to the sensor side may be convex, and in the second lens group LG2, the object-side surface closest to the object side may be concave. The first lens group LG1 may refract light incident through the object side to gather, and the second lens group LG2 may refract light emitted through the first lens group LG1 to the image sensor 300.

The first lens group LG1 may have negative (−) refractive power, and the second lens group LG2 may have positive (+) refractive power. Among the lenses of the first lens group LG1, the lens closest to the object side may have negative (−) refractive power, and among the lenses of the second lens group LG2, the lens closest to the sensor side may have negative (−) refractive power. When the focal length is expressed as an absolute value, the focal length of the first lens group LG1 may be at least twice the focal length of the second lens group LG2, for example, in a range of 2 to 10 times. The EFL of the optical system 1000 may be smaller than the absolute value of the focal length of the first lens group LG1. The EFL of the optical system 1000 may be smaller than the absolute value of the focal length of the first lens group LG1 and larger than the absolute value of the focal length of the second lens group LG2. The number of lenses having negative (−) refractive power on the optical system 1000 may be smaller than the number of lenses having positive (+) refractive power. The number of lenses having negative (−) refractive power may be 50% or less compared to the total number of lenses, for example, in a range of 25 to 50% or 32 to 49%.

The number of lenses of the plastic material lens in the lens portion 100B may be 60% or less of the total number of lenses, and may be in the range of 20% to 50% or 25% to 45%. The effective diameter of the lens closest to the object side in the lens portion 100B may be larger than the effective diameter of the lens closest to the image sensor 300. Accordingly, the brightness of the optical system may be controlled. The lens portion 100B may include a first lens 121, a second lens 122, a third lens 123, a fourth lens 124, a fifth lens 125, a sixth lens 126, and a seventh lens 127 aligned from the object side toward the sensor side along the optical axis.

When the focal length is an absolute value, the focal length of the lens closest to the object may be larger than the focal length of the plastic lens. Here, the plastic lens may be at least one lens arranged on the sensor side of the cemented lens, or at least one lens adjacent to the image sensor. The focal length F1 of the first lens 121 may be the largest in the optical system, and may be larger than the focal length (absolute value) of the second lens group LG2. That is, the following condition may satisfy: |FLG2|<F1.

In terms of the center thickness CT of the lenses, for example, at least two or more of the glass lenses may have a center thickness greater than that of the plastic lenses. If the average of the center thicknesses of the glass lenses in the lens portion 100B is GLCT_Aver and the average of the center thicknesses of the plastic lenses is PLCT_Aver, the following condition may satisfy: GLCT_Aver>PLCT_Aver. In addition, the following condition may satisfy: 1.2<GLCT_Aver/PLCT_Aver<2.3. The lens closest to the object in the lens portion 100B may have the highest refractive index, which is greater than 1.7, for example, 1.8 or more. The refractive index of the lens closest to the object may be greater than the refractive index of the plastic lens. The number of lenses having a lower refractive index than the average of the refractive indices of the plastic lenses in the lens portion 100B may be 2 or less, for example, 1. The plastic lens may have an aspherical object-side surface and a sensor-side surface and a refractive index of less than 1.7.

If the average refractive index of the glass lenses in the lens portion 100B is GLn_Aver and the average refractive index of the plastic lenses is PLn_Aver, the following condition may satisfy: PLn_Aver<GLn_Aver. In addition, the following condition may satisfy: 1<GLn_Aver/PLn_Aver<1.2. The lens(es) having a high refractive index may be positioned on the object side of the plastic lens to increase color dispersion.

The average Abbe number of the glass lenses in the lens portion 100B may be greater than the average Abbe number of the plastic lenses. The average Abbe number of the plastic lenses may be 45 or less. The number of glass lenses having an Abbe number lower than the average Abbe number of the plastic lenses in the lens portion 100B may be 2 or less, for example, 1. When the average Abbe number of the glass material lenses is GLv_Aver and the average Abbe number of the plastic lenses is PLv_Aver, the following condition may satisfy: PLv_Aver<GLv_Aver. In addition, the following condition may satisfy: 1<GLv_Aver/Plv_Aver<1.5. Lenses with low Abbe numbers can improve color dispersion at a location adjacent to the image sensor 300.

In the lens portion 100B, the number of lenses larger than the average effective diameter of the plastic lenses may be 3 or more, for example, 4 or more. When the average effective diameter of the plastic material lenses is CA_PL_Aver and the average effective diameter of the glass material lenses is CA_GL_Aver, the following condition may satisfy: CA_PL_Aver<CA_GL_Aver. In addition, the following condition may satisfy: 1<CA_GL_Aver/CA_PL_Aver<1.5. In addition, the relationship between the length of the image sensor 300 and the average effective diameter CA_PL_Aver of the plastic lens may satisfy the following condition: 1≤(ImgH*2)/CA_PL_Aver<1.5. In addition, the relationship between the average effective diameter of the glass material and the length of the image sensor 300 may satisfy the following condition: 1≤CA_GL_Aver/(ImgH*2)<1.5. The difference between the maximum length of the image sensor 300 and the effective diameter of the plastic lens may be arranged not to be large.

Accordingly, by arranging a plastic lens with a small effective diameter adjacent to the image sensor 300, the plastic lenses can disperse color from the center to the periphery of the image sensor 300.

In the third embodiment, the fifth lens is arranged on the object side of the plastic lens, and since it is the lens closest to the plastic lens among the glass lenses, the effective diameter ratio of the object-side surface of the fifth lens and the sensor-side surface may satisfy Equation 18 or 18-1. In contrast, if the plastic lens closest to the object side is arranged as the n−3rd, n−4th, or n−5th (n=6 to 8), the effective diameter ratio of the object-side surface GL1_S1 and the sensor-side surface GL1_S2 of the glass lens closest to the plastic lens while being arranged on the object-side surface of the n−3rd, n−4th, or n−5th plastic lens may satisfy: 1<CA_GL1_S1/CA_GL1_S2<2, or the effective diameter difference (mm) of these may satisfy: 1.7<CA_GL1_S1-CA_GL_S2<3.

$$1.1 \leq Last\_GL \_CAS1 / Last\_GL \_CAS2 \leq 1.4 \qquad Condition 1$$

In the condition, Last_GL_CAS1 means the effective diameter CAS1 of the object-side surface of the last glass lens GL in the optical system, and Last_GL_CAS2 means the effective diameter CAS2 of the sensor-side surface of the last glass lens GL in the optical system.

$$2 < L 3 R 1 / ( C A 31 / 2 ) < 5 \qquad Condition 2$$

In the condition 2, L3R1 represents the curvature radius of the object-side fifth surface S5 of the third lens 123, and CA31 represents the effective diameter of the object-side surface of the third lens 123. When the biconvex third lens 123 satisfies Condition 2, the optical system 1000 can improve chromatic aberration. If it is less than the lower limit value of condition 2, the occurrence of aberration by the fifth surface S5 increases, and if it is greater than the upper limit value, the occurrence of aberration by the fifth surface decreases, but since the curvature radius of the sixth surface must be smaller, the occurrence of aberration by the sixth surface increases, and there is a problem of affecting the aberration of the fourth to seventh lenses. Preferably, if 3<L3R1/(CA31/2)<4 is satisfied, the curvature radius of the sixth surface S6 may be designed to be large while reducing the aberration occurring in the fifth surface S5, so that the production of the third lens 123 is easy. The aberration occurring in the optical system may be reduced, and the production of the third lens 123 may be made easier, thereby increasing the yield.

The average effective diameter of the glass materials may be 10 mm or more, for example, in the range of 10 mm to 15 mm. The lens having the minimum effective diameter among the lenses made of the glass material may be placed closest to the plastic lens. Within the lens portion 100B, the minimum effective diameter may be in the range of 8 mm to 10 mm, and the maximum effective diameter may be in the range of 11 mm to 15 mm. When the curvature radius is described as an absolute value, the lens surface having the minimum curvature radius based on the optical axis OA within the lens portion 100B may be the sensor-side surface of the lens closest to the plastic lens. The lens surface having the minimum curvature radius may be the sensor-side surface of the glass lens closest to the plastic lens. For example, the n−2th sensor-side surface may have the minimum curvature radius within the lens portion 100B. When the lens surface having the minimum curvature radius is the sensor side of the glass lens closest to the plastic lens, light may be refracted into the effective region of the plastic lens having a relatively small effective diameter.

Within the lens portion 100B, the lens surface having the maximum curvature radius may be the sensor-side surface or the object-side surface of the plastic lens disposed between the glass lens and the image sensor 300. In the case of two or more plastic lenses, the lens surface having the maximum curvature radius may be a lens surface closer to the sensor side among the plastic lenses. For example, the object-side surface of the n-th lens may have the maximum curvature radius within the lens portion 100B. Here, the minimum curvature radius may be 20 or less, for example, 10 or less. The maximum curvature radius may be 10 times or more the minimum curvature radius. When expressed in absolute values, if the average of the radii of curvature of the glass lenses is Aver_GLr and the average of the radii of curvature of the plastic lenses is Aver_PLr, the following condition may satisfy: Aver_GLr<Aver_PLr. In addition, the following condition may satisfy: 3<Aver_PLr/Aver_GLr<7. The radii of curvature (absolute value) of the glass lenses and the plastic lenses may satisfy the conditions: 10<Aver_GLr<50 and 100<Aver_PLr<200. Accordingly, by arranging plastic lenses with a large average curvature radius adjacent to the image sensor 300, the light distribution that proceeds to the image sensor 300 may be controlled.

The lens portion 100B may include at least one cemented lens 145. Here, the number of lenses having an effective diameter greater than the length of the image sensor 300 may be 4 to 5, and the number of lenses having an effective diameter smaller than the length of the image sensor 300 may be 2 to 3.

When the aperture stop ST is arranged on the sensor surface of the second lens, the following condition satisfies: effective diameter of the object-side surface of the first lens>effective diameter of the sensor-side surface of the first lens>effective diameter of the object-side surface of the second lens>effective diameter (effective diameter of the aperture stop) of the sensor-side surface of the second lens. It satisfies the following condition: effective diameter (effective diameter of the aperture stop) of the sensor-side surface of the second lens<effective diameter of the object-side surface of the third lens<effective diameter of the sensor-side surface of the third lens>effective diameter of the object-side surface of the fourth lens>effective diameter of the sensor-side surface of the fourth lens. The aperture stop may be arranged on the periphery of the object-side surface or the sensor-side surface of the lens closest to the object side among the lenses of the second lens group LG2.

In the optical system 1000 of the third embodiment, the sum of the refractive indices of the lenses of the lens portion 100B may be 8 or more, for example, in the range of 8 to 15, and the average of the refractive indices may be in the range of 1.6 to 1.72. The sum of the Abbe numbers of each of the lenses may be 220 or more, for example, in the range of 220 to 350, and the average of the Abbe numbers may be 55 or less, for example, in the range of 31 to 55. The sum of the center thicknesses of the entire lens may be 15 mm or more, for example, in the range of 20 to 28 mm, and the average of the center thicknesses may be in the range of 2.8 to 4 mm. The sum of the center distances between the lenses at the optical axis OA may be 4.5 mm or more, for example, in the range of 4.5 to 9 mm, and may be smaller than the sum of the center thicknesses of the lenses. In addition, the average value of the effective diameter of each lens surface S1-S14 of the lens portion 100B may be provided in the range of 8 mm or more, for example, 8 mm to 15 mm. In the optical system according to the third embodiment of the invention, the field of view and the sensor size will be described in the first embodiment.

Since the third embodiment is an optical system applied to a vehicle camera, the first lens may be provided as a glass material even though it is designed using a plastic lens and a glass lens together. This has the advantage that the glass material is more scratch-resistant and less sensitive to external temperature than the plastic material. In order to more effectively prevent scratches caused by foreign substances or placed inside a vehicle, a glass lens is used as the first lens, and the object-side surface of the first lens may have a concave shape so as not to come into contact with external structures. If the object-side surface of the first lens is designed to have a convex shape, scratches may occur due to contact with external structures. The field of view may be greater than 20 degrees and less than 40 degrees, for example, in the range of 25 degrees to 35 degrees, for driver monitoring, front/rear photography of the vehicle, or lane detection and detection of impending objects around the vehicle while the vehicle is being driven. This horizontal field of view may be a preset angle for an advanced driver assistance system (ADAD). The optical system 1000 according to the third embodiment may further include a reflective member (not shown) for changing the path of light. The reflective member may be implemented as a prism that reflects the incident light of the first lens group LG1 toward the lenses. Hereinafter, the optical system according to the embodiment will be described in detail.

Referring to FIGS. 21 to 23, the first lens 121 may be a first lens group LG1, and the second to seventh lenses 122, 123, 124, 125, 126, and 127 may be a second lens group LG2. An aperture stop may be arranged on one of the peripheries of the object-side or sensor-side surface of the first lens 121, or the object-side surface or sensor-side surface of the second lens 122.

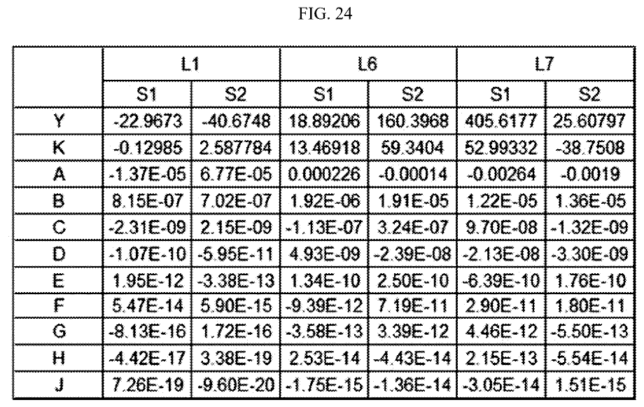

The first lens 121 may have negative (−) refractive power. The first lens 121 may be made of, for example, glass. The object-side first surface S1 of the first lens 121 on the optical axis may be concave, and the sensor-side second surface S2 may be convex. The aspherical coefficients of the first and second surfaces S1 and S2 may be provided as S1 and S2 in L1 of FIG. 24. The first lens 121 may be manufactured as a lens having an aspherical surface by injection molding a glass material. Since the first lens 121 is provided as an aspherical glass material, the glass material having high transmittance and refractive index has an aspherical surface, which may reduce the number of lenses in the optical system. The optical system 1000 may include at least one, for example, 1 to 3, glass lenses having an aspherical surface. The effective radius r11 of the first lens 121 may be larger than the effective radius of the plastic lens. Since the first surface S1 is concave and the second surface S2 is convex, the incident light may be refracted in a direction away from the optical axis OA, and the distance between the first and second lenses 121 and 122 may be reduced. The first surface S1 of the first lens 121 may be provided without a critical point from the optical axis OA to the end of the effective region, i.e., the edge. The second surface S2 of the first lens 121 may be provided without a critical point.

The second lens 122 may have positive (+) refractive power. The second lens 122 may be provided with a glass material. The object-side third surface S3 of the second lens 122 on the optical axis OA may be concave, and the sensor-side fourth surface S4 may be convex. The second lens 122 may be provided with a spherical lens made of glass. The third lens 123 may have positive (+) refractive power. The third lens 123 may be provided with a glass material. The object-side fifth surface S5 of the third lens 123 on the optical axis may be convex, and the sensor-side sixth surface S6 may be convex. The third lens 123 may be provided as a spherical lens made of glass.

An aperture stop may be arranged around the sensor-side fourth surface S4 of the second lens 122. Since the third lens 123 adjacent to the sensor side of the aperture stop has positive refractive power (F3>0), the third lens 123 may refract incident light in the direction of the optical axis, and may suppress an increase in the effective diameter of the sensor-side or rear-side lenses of the third lens 123. Accordingly, a decrease in the yield by weight of the optical system may be prevented by the third lens 123, and production efficiency may be improved. Here, the composite focal length of the third to seventh lenses 123-127 arranged on the sensor side of the aperture stop may have a positive value, and may reduce the TTL within the field of view range.

The fourth lens 124 may have positive (+) refractive power. The fourth lens 124 may be provided with a glass material. The seventh surface S7 on the object side of the fourth lens 124 on the optical axis may be convex, and the eighth surface S8 on the sensor side may be convex. The fourth lens 124 may have a convex shape on both sides. The fourth lens 124 may be provided with a spherical lens made of glass. The fifth lens 125 may have negative (−) refractive power. The fifth lens 125 may be provided with a glass material. On the optical axis OA, the ninth surface of the fifth lens 125 on the object side may be concave, and the tenth surface S10 on the sensor side may be concave. Both the ninth surface and the tenth surface S10 may be spherical.

The bonding surface between the fourth lens 124 and the fifth lens 125 may be defined as the eighth surface S8. The composite refractive power of the fourth and fifth lenses 124 and 125 may have positive refractive power. The product of the refractive power of the fourth lens 124 on the object side and the refractive power of the fifth lens 125 on the sensor side of the cemented lens 145 may be less than 0. The composite refractive power of the cemented lens 145 has positive refractive power, and the third lens 123 on the object side and the sixth lens 126 on the sensor side may have positive refractive power based on the cemented lens 145. Accordingly, the third lens 123, the cemented lens 145, and the sixth lens 126 can refract some of the incident light in the direction of the optical axis.

The effective diameter of the fourth lens 124 may be larger than the diagonal length of the image sensor 300. The effective diameter of the fourth lens 124 is an average of the effective diameters of the seventh surface S7 and the eighth surface S8, and may be larger than the diagonal length of the image sensor 300. The effective diameter of the fifth lens 125 may be smaller than the effective diameter of the fourth lens 124 and have a length within a range of ±110% or ±125% of the diagonal length of the image sensor 300. When the fifth lens 125 is a glass lens and the sixth and seventh lenses 126 and 127 are plastic lenses, the effective diameter CA difference between the object-side ninth surface and the sensor-side tenth surface S10 of the fifth lens 125 may be provided to be the largest. For example, when the effective diameters of the object-side surface and the sensor-side surface of the fifth lens 125 are CA51 and CA52, CA51>CA52 is satisfied, and the difference between CA51 and CA52 may be the largest among the effective diameter differences between the object-side surfaces and the sensor-side surfaces of the lenses. Accordingly, the difference in the effective diameter of the lens closest to the plastic lens, i.e., the fifth lens 125, may be set to be maximized so as to effectively guide light traveling to the plastic lens having a relatively small effective diameter. The effective diameter of the fifth lens 125 may satisfy the following condition: 1.1<CA51/CA52<1.5.

The cemented lens 145 is bonded with glass lenses having different refractive indices and has a spherical refractive surface. When the lenses positioned on the sensor side than the cemented lens 145 are aspherical lenses or plastic lenses, spherical aberration may be compensated. In addition, since the lenses positioned on the sensor side than the cemented lens 145 are plastic lenses and are arranged as lenses with small effective diameters, light traveling through the plastic lenses to the image sensor 300 may be set to be effectively guided. Since the cemented lens 145 is positioned on the object side than the plastic lenses or is positioned between two consecutive lenses among the first to fourth lenses, chromatic aberration correction may be more efficient.

The sixth lens 126 may have positive (+) refractive power. The sixth lens 126 may be provided with a plastic material. On the optical axis OA of the sixth lens 126, the object-side eleventh surface S11 may be a convex shape and the sensor-side eleventh surface S12 may be a convex shape. The sixth lens 126 may have a shape in which both sides are convex on the optical axis OA. The eleventh surface S11 and the twelfth surface S12 may be aspherical. The aspherical coefficients of the eleventh and twelfth surfaces S11 and S12 may be provided as S1 and S2 of L6 of FIG. 24. The eleventh and twelfth surfaces S11 and S12 of the sixth lens 126 may be provided without a critical point from the optical axis OA to the end of the effective region. When the twelfth surface S12 has a critical point, it may be located at 70% or more of the effective radius r62 from the optical axis OA, or may be located at a range of 70% to 90%, or a range of 75% to 85%.

The seventh lens 127 may have negative (−) refractive power. The seventh lens 127 may be made of a plastic material. The object-side thirteenth surface S13 of the seventh lens 127 on the optical axis may be convex, and the sensor-side fourteenth surface S14 may be concave. The seventh lens 127 may have a meniscus shape convex toward the object side. The thirteenth surface S13 and the fourteenth surface S14 may be aspherical. The aspherical coefficients of the thirteenth and fourteenth surfaces S13 and S14 may be provided as S1 and S2 of L7 of FIG. 24. The seventh lens 127 may be a plastic lens closest to the image sensor 300.

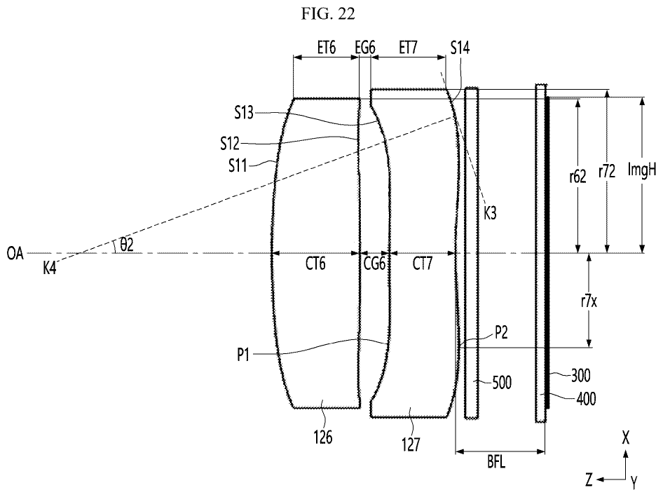

Referring to FIG. 22, the thirteenth surface S13 of the seventh lens 127 may have at least one critical point from the optical axis OA to the end of the effective region. The critical point of the thirteenth surface S13 may be located at 50% or less of the effective radius from the optical axis OA, or in the range of 0.1% to 30%, or in the range of 0.1% to 20%. The critical point of the thirteenth surface S13 may be located at a position of 2 mm or less from the optical axis OA, for example, in the range of 0.1 mm to 2 mm, or in the range of 0.1 mm to 1 mm. As another example, the thirteenth surface S13 may be provided without a critical point. The fourteenth surface S14 of the seventh lens 127 may have at least one critical point P2 from the optical axis OA to the end of the effective region. The critical point P2 of the fourteenth surface S14 may be located at a distance r7x of 44% or more of the effective radius r72 from the optical axis OA, or in a range of 44% to 64% or in a range of 49% to 59%. The critical point P2 of the fourteenth surface S14 may be located at a position of 2.1 mm or more from the optical axis OA, for example, in a range of 2.1 mm to 3 mm.

The tangent line K3 passing through any point of the fourteenth surface S14 of the seventh lens 127 and the normal line K4 perpendicular to the tangent line K3 may have a predetermined angle θ2 with the optical axis OA. The maximum tangent angle θ2 on the fourteenth surface S14 in the first direction X may be 45 degrees or less, for example, in the range of 5 degrees to 43 degrees or 13 degrees to 33 degrees.

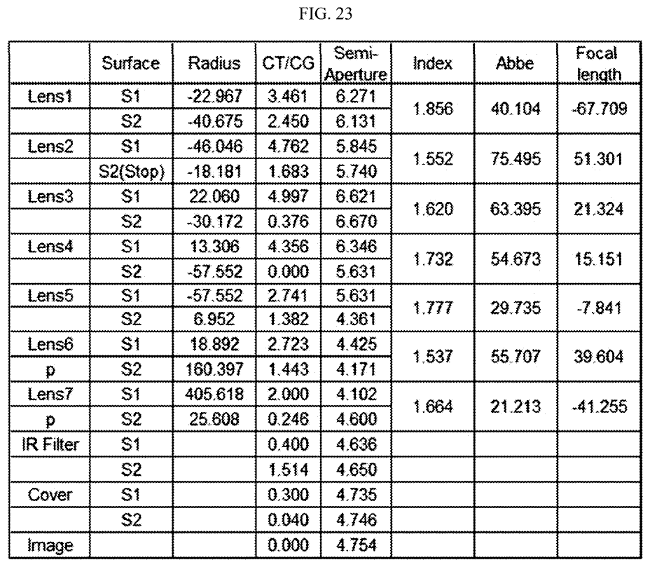

FIG. 23 is an example of lens data of the optical system of the third embodiment of FIG. 21. As shown in FIG. 23, when expressed as an absolute value of the curvature radius, the curvature radius of the thirteenth surface S13 of the seventh lens 127 on the optical axis OA may be the largest among the lenses, and the curvature radius of the tenth surface S10 of the fifth lens 125 may be the smallest among the lenses. The difference between the maximum curvature radius and the minimum curvature radius may be 30 times or more, for example, 50 times or more. The curvature radii of the plastic material sixth lens 126 and seventh lens 127 may be larger than the curvature radii of the glass material first to fifth lenses 121, 122, 123, 124, and 125. Here, the curvature radii are the average of the curvature radii (absolute values) of the object-side surface and the sensor-side surface of each lens.

In terms of the center thickness (CT) of the lenses, the center thicknesses of the second lens 122 and fourth lens 124 may be larger than the center thicknesses of the plastic lens(es). For example, at least two or more of the glass material lenses may have a center thickness larger than the center thickness of the plastic lens. The center thicknesses of each of the sixth lens 126 and seventh lens 127 may be smaller than the center thicknesses of each of the first to fourth lenses 121-124. The center thickness of the second lens 122 or the third lens 123 is the largest among the lenses, and the center thickness of the seventh lens 127 is the smallest among the lenses. The difference between the maximum center thickness and the minimum center thickness may be 2 mm or more. That is, even if the plastic material lenses provide a thin center thickness, the optical performance may not be degraded, and the thickness of the camera module may be provided slimly.

In explaining the center distance CG between the lenses, the center distance between the first lens 121 and the second lens 122 is the largest and is larger than the distance between the plastic lenses. The center distance between the third and fourth lenses 123 and 124 is the smallest and may be smaller than the gap between the plastic lenses. Here, the minimum center distance excludes the bonding surface of the cemented lens 145. The difference between the maximum center distance and the minimum center distance may be 1.5 mm or more, for example, in the range of 1.5 mm to 2.5 mm. In addition, by providing the maximum center distance between the lenses to be 80% or less of the maximum center distance, for example, in the range of 50% to 80%, the thickness of the camera module applying the plastic lens having a thin thickness without increasing the center distance compared to the center thickness of each lens may not be increased.

Regarding the effective diameter, the lens having the maximum effective diameter may be disposed between the first lens 121 closest to the object and the seventh lens 127 closest to the image sensor 300. The lens having the maximum effective diameter may be a glass lens. The lens having the maximum effective diameter may be disposed between the first lens 121 closest to the object and the plastic lens. The lens having the maximum effective diameter may be disposed between the glass lenses, and may be, for example, the third lens. Here, the effective diameter is the average of the effective diameter of the object-side surface and the effective diameter of the sensor-side surface of each lens. The effective diameter of the lenses made of glass may be larger than that of the lenses made of plastic. For example, the effective diameters of the first to fifth lenses 121-125 may be larger than the effective diameters of the sixth and seventh lenses 126 and 127. The effective diameters of the first to fifth lenses 121-125 may be larger than the diagonal length of the image sensor 300. The average effective diameters of the sixth and seventh lenses 126 and 127 may be smaller than the diagonal length of the image sensor 300. Accordingly, the plastic lens may guide light incident through the glass lens to the image sensor 300. Here, the average of the center thicknesses of the first to seventh lenses 121-127 may be larger than the center thickness of each of the plastic lenses, for example, the sixth and seventh lenses 126 and 127. The average effective diameter of the first to seventh lenses 121-127 may be greater than the effective diameter of each of the plastic lenses, for example, the sixth and seventh lenses 126 and 127.

In terms of the refractive index, the refractive index of the first lens 121 is the largest among the lenses and may be 1.75 or more. The refractive index of the sixth lens 126 is the smallest among the lenses. The difference between the maximum refractive index and the minimum refractive index may be 0.23 or more. By making the refractive index of the lens closest to the object the largest and providing the refractive index of the sixth lens 126 made of plastic material closest to the glass material lens the smallest, the incidence efficiency is increased, and the refractive power between the glass material and the plastic material lenses may be adjusted to guide the image sensor 300. In terms of the Abbe number, the Abbe number of the second lens 122 is the largest among the lenses and may be 65 or more. The Abbe number of the seventh lens 127 is the smallest among the lenses. The difference between the maximum refractive index and the minimum Abbe number may be 45 or more. By making the Abbe number of the lens adjacent to the aperture stop the largest and providing the Abbe number of the seventh lens 127 made of plastic material closest to the image sensor the smallest, the color dispersion of light traveling between the glass lenses may be controlled, and the color dispersion between the glass and plastic lenses may be increased to guide it to the image sensor 300.

The focal lengths F1, F5, and F7 of the first, fifth, and seventh lenses 121, 125, and 127 may have negative refractive power, and the focal lengths F2, F3, F4, and F6 of the second, third, fourth, and sixth lenses 122, 123, 124, and 126 may have positive refractive power. Here, among the plastic lenses, the sixth lens 126 has positive refractive power, and the seventh lens 127 has negative refractive power. Accordingly, according to the conditions 1 and 2, the refractive index of the sixth lens 126 is smaller than the refractive index of the seventh lens 127, and the dispersion value of the sixth lens 126 is larger than the dispersion value of the seventh lens 127. Chromatic aberration occurring in the plastic lens may be corrected by the plastic lens. In addition, by satisfying the refractive index difference between the sixth and seventh lenses 126 and 127, which are plastic lenses arranged in series, to be 0.1 or more and 0.15 or less and the Abbe number difference to be 20 or more and 60 or less, the chromatic aberration occurring in the plastic lens may be compensated for with the plastic lens.

The optical system 1000 causes chromatic aberration and corrects the chromatic aberration by using a cemented lens 145 or two lenses arranged in series. The lens repeatedly contracts and expands as the temperature changes from low to high. Since the lens characteristics of the same material change the same amount according to the temperature change, it is effective to correct the chromatic aberration between the lenses of the same material even when the temperature changes.

Therefore, in the third embodiment of the invention, the chromatic aberration occurring in the glass material lens may be mutually corrected by the fourth lens 124 and the sixth lens 125, and the chromatic aberration occurring in the plastic lens may be mutually corrected by using the sixth lens 126 and the seventh lens 127. The refractive index difference between the fourth lens 124 and the fifth lens 125, which are the joined lenses, is 0.1 or more and 0.15 or less, and the Abbe number difference is 20 or more and 60 or less, and the chromatic aberration occurring in the plastic lenses may be compensated for by the plastic lenses. In addition, by arranging glass lenses having relatively high Abbe numbers on the object side of the plastic lenses, the chromatic dispersion by the glass lenses may be reduced and the chromatic dispersion by the plastic lenses may be increased.

When the focal length is expressed as an absolute value, the focal length of the first lens 121 is the maximum among the lenses and may be 55 or more. The focal length of the fifth lens 125 is the minimum among the lenses. The difference between the maximum focal length and the minimum focal length may be 50 or more. By making the focal length of the lens closest to the object the largest and providing the focal length of the glass lens 125 adjacent to the plastic lens the smallest, it is possible to have improved MTF characteristics, aberration control characteristics, resolution characteristics, etc. in the set field of view range in the optical system, and to have good optical performance in the periphery of the field of view.

The sensor-side surface of the seventh lens 127 has a critical point. The critical point is a point where the trend of the sag value changes. That is, it is a point where the sag value increases and then decreases, or a point where the sag value decreases and then increases. Referring to FIG. 6, it may be seen that the critical point of the sensor-side surface of the seventh lens 127 exists between a point spaced 2.1 mm apart from the optical axis in a direction perpendicular to the optical axis and a point spaced 2.9 mm apart from the optical axis. For example, the sag value of the sensor-side surface of the seventh lens 127 increases to a point of 2.5 mm±0.4 mm in a direction perpendicular to the optical axis, and then decreases toward the edge from a point of 2.5 mm±0.4 mm in a direction perpendicular to the optical axis. If a critical point exists on the sensor-side surface of the seventh lens 127, that is, the sensor-side surface of the last lens, that is, the lens surface closest to the sensor, TTL may be reduced, making it easy to miniaturize and lighten the optical system.

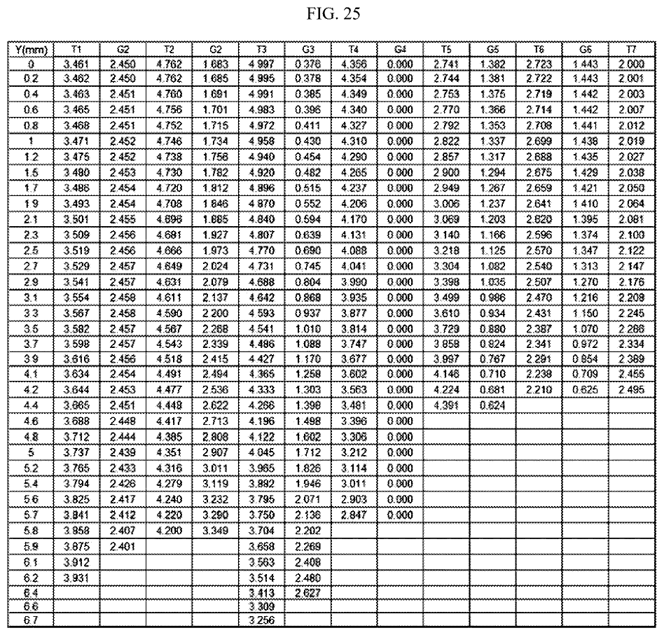

As shown in FIG. 24, among the lenses of the lens portion 100B in the third embodiment, the lens surfaces of the first, sixth, and seventh lenses 121, 126, and 127 may include an aspherical surface having a 30th aspherical coefficient. As shown in FIG. 25, the thicknesses T1-T7 of the first to seventh lenses 121-127 and the distances G1-G6 between adjacent two lenses may be expressed at intervals of 0.1 mm or 0.2 mm or more in the Y-axis direction based on the optical axis. The thickness T1 of the first lens 121 may have a difference between the maximum thickness and the minimum thickness of 1 or more times, for example, 1 to 1.5 times, and the center thickness may be the minimum and the edge thickness may be the maximum. The thickness T2 of the second lens 122 may have a maximum thickness of 1 or more times the minimum thickness, for example, 1 to 1.5 times. The center of the second lens 122 may have the maximum thickness and the edge may have the minimum thickness. The thickness T3 of the third lens 123 may be the maximum at the center and the minimum at the edge. The center thickness of the third lens 123 may be the thickest among the centers of the lenses. The maximum thickness of the fourth lens 124 may be 1.2 times or more of the minimum thickness, for example, in a range of 1.2 to 1.8 times, and may be smaller than the difference between the maximum thickness and the minimum thickness of the fifth lens 125. The maximum thickness of the fifth lens 125 may be at the edge, and the minimum thickness may be at the center, and the maximum thickness may be 1.2 times or more of the minimum thickness, for example, in a range of 1.2 to 1.8 times.

The center thickness CT45 of the cemented lens 145 may be greater than the edge thickness ET45. The center thickness CT45 of the cemented lens 145 is the distance from the center of the object-side seventh surface S7 of the fourth lens 124 to the center of the tenth surface S10 of the fifth lens 125, and the edge thickness ET45 is the distance from the end of the effective region of the seventh surface S7 to the tenth surface S10 in the optical axis direction. The maximum thickness of the cemented lens 146 is at the center, the minimum thickness is at the edge, and the maximum thickness may be at least 1 time the minimum thickness, for example, in the range of 1 to 1.5 times.

The maximum thickness of the sixth lens 126 is at the center, the minimum thickness is at the edge, and the maximum thickness is at least 1 time the minimum thickness, for example, in the range of 1 to 1.5 times. The maximum thickness of the seventh lens 127 is at the edge, the minimum thickness is at the center, and the maximum thickness is at least 1 time of the minimum thickness, for example, in the range of 1 to 1.5 times. Among the distances G1 to G6 between the lenses, the fourth distance G3 between the third and fourth lenses 123 and 124 may have the maximum at the edge and the minimum at the center, and the difference between the maximum distance and the minimum distance may be the largest among the distances, and may be at least 5 times, for example, in the range of 5 to 10 times. Among the distances G1 to G6 between the lenses, the first distance G1 between the first and second lenses 121 and 122 may have the smallest difference between the maximum distance and the minimum distance among the distances G1 to G6. That is, the difference between the maximum distance and the minimum distance of the first distance G1 may be 1.10 or less.

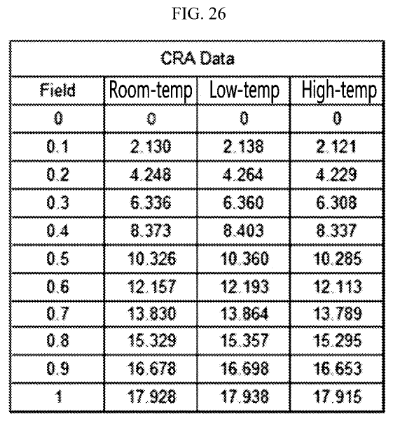

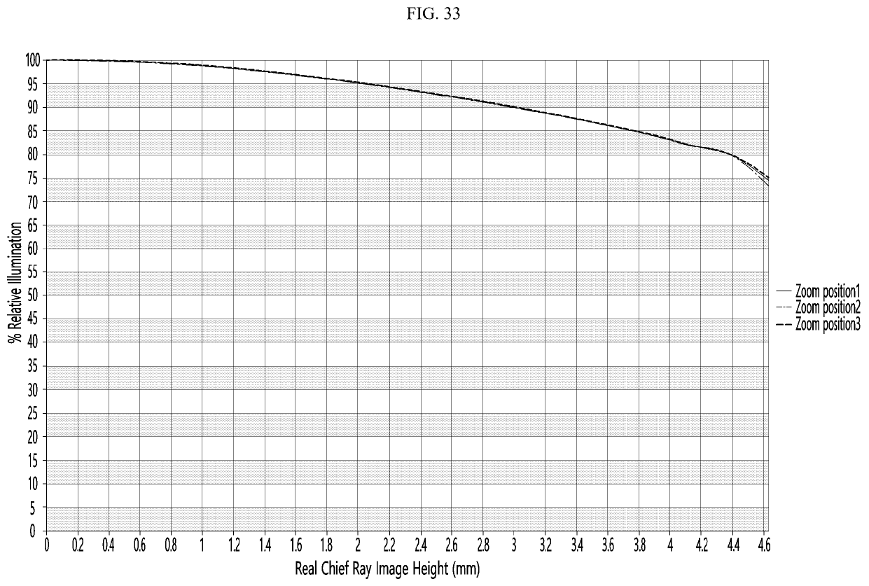

As shown in FIG. 26, CRA in the optical system and camera module of FIG. 21 may be 10 degrees or more, for example, in a range of 10 to 35 degrees or in a range of 10 to 25 degrees. As shown in FIG. 33, in the optical system according to the third embodiment, a graph showing the relative illumination according to the image height shows that the relative illumination is 70% or more, for example, 75% or more from the center of the image sensor to the diagonal end. That is, it may be seen that the difference in the relative illumination (Zoom position 1, 2, 3) according to the temperature is almost the same up to 4.4 mm from the optical axis.

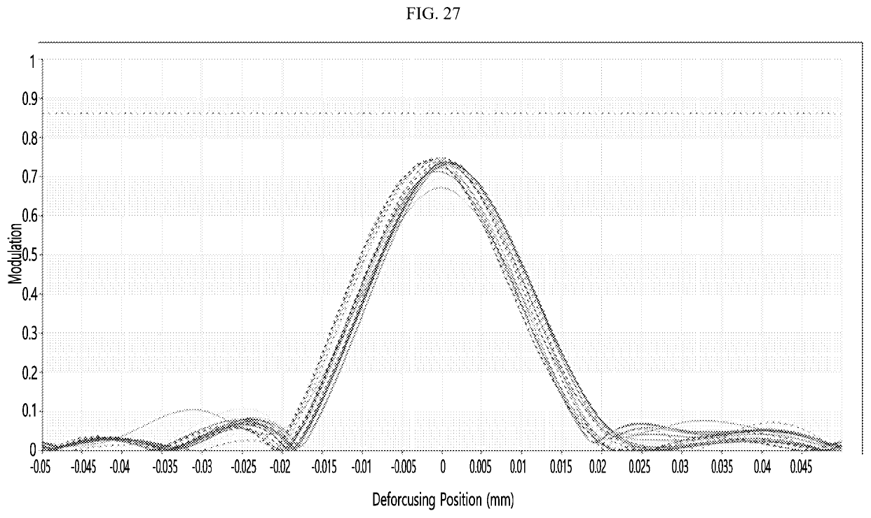

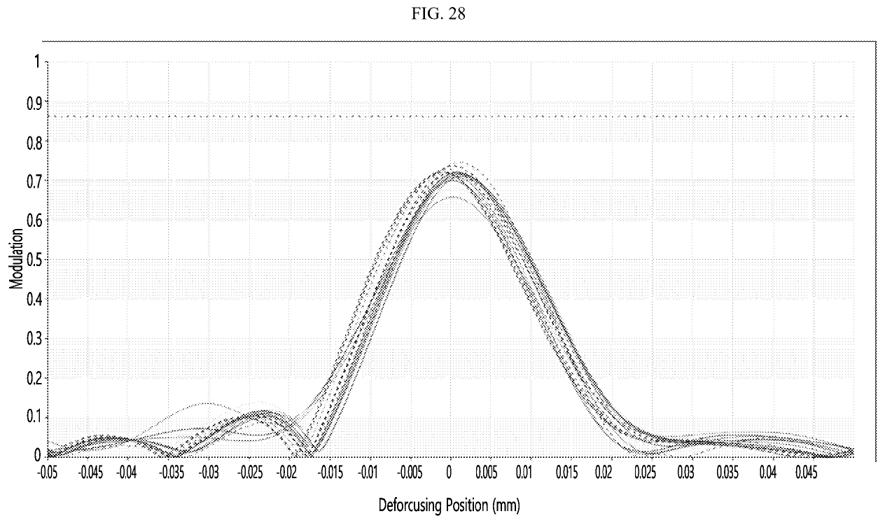

FIGS. 27 to 29 are graphs showing the diffraction MTF at room temperature, low temperature, and high temperature in the optical system of FIG. 21, and are graphs showing the modulation according to the spatial frequency. As in FIGS. 7 to 29, in the third embodiment of the invention, the deviation of the MTF at low temperature or high temperature based on room temperature may be less than 10%, that is, 7% or less.

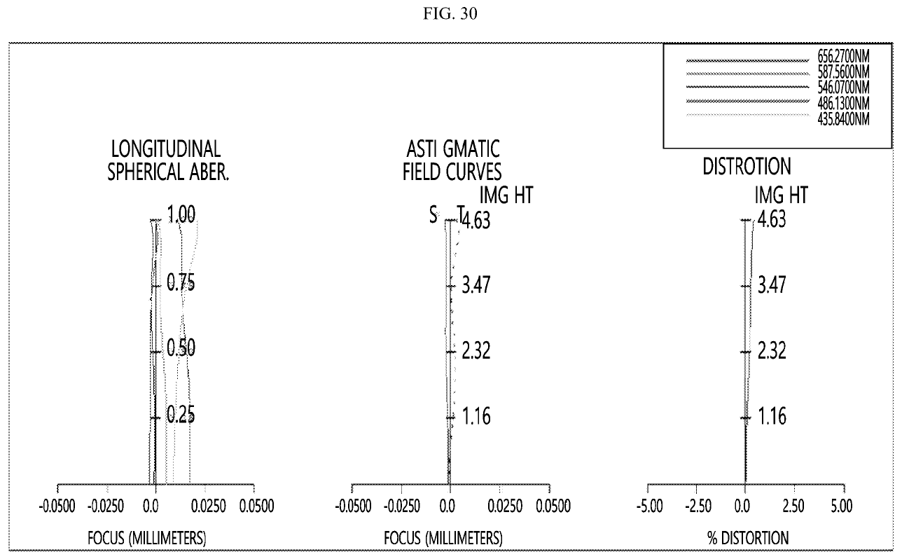

FIGS. 30 to 32 are graphs showing the aberration characteristics at room temperature, low temperature, and high temperature in the optical system of FIG. 21. The graphs of the aberration graphs of FIGS. 30 to 32 are graphs measuring spherical aberration (Longitudinal Spherical Aberration), astigmatic field curves, and distortion from left to right. In the aberration diagrams of FIGS. 30 to 32, the closer each curve at room temperature, low temperature, and high temperature is to the Y-axis, the better the aberration correction function may be interpreted. It may be seen that the optical system 1000 according to the third embodiment has measurement values close to the Y-axis in almost all areas. That is, the optical system 1000 according to the embodiment has improved resolution and may have good optical performance not only in the center portion of the FOV but also in the periphery portion. Here, the low temperature is −20 degrees or lower, for example, in the range of −20 to −40 degrees, the room temperature is in the range of 22 degrees±5 degrees or in the range of 18 degrees to 27 degrees, and the high temperature may be in the range of 85 degrees or higher, for example, in the range of 85 degrees to 105 degrees. Accordingly, it may be seen that the decrease in the luminance ratio (modulation) from the low temperature to the high temperature of FIGS. 30 to 32 is less than 10%, for example, 5% or lower, or is almost unchanged.

Table 2 compares the changes in optical characteristics such as EFL, BFL, F number, TTL, and FOV at room temperature, low temperature, and high temperature in the optical system according to the third embodiment, and it may be seen that the change rate of optical characteristics at low temperature is 5% or less, for example, 3% or less, based on room temperature, and it may be seen that the change rate of optical characteristics at low temperature is 5% or less, for example, 3% or less, based on room temperature.

TABLE 2

| | | | | Low | High |
|---|---|---|---|---|---|
| | Room | Low | High | temperature/Room | temperature/Room |
| | temperature | temperature | temperature | temperature | temperature |
| EFL(F) | 15.000 | 14.961 | 15.048 | 99.74% | 100.58% |
| BFL | 2.500 | 2.497 | 2.503 | 99.88% | 100.25% |
| F# | 1.600 | 1.596 | 1.605 | 99.73% | 100.61% |
| TTL | 34.875 | 34.833 | 34.926 | 99.88% | 100.27% |
| FOV | 34.168 | 34.273 | 34.044 | 100.31% | 99.33% |

Therefore, as shown in Table 2, the change in optical characteristics according to the temperature change from low temperature to high temperature, for example, the change rate of the EFL, TTL, BFL, F number, and the change rate of the FOV are 10% or less, that is, 5% or less, for example, in the range of 0 to 5%. This can prevent the reliability of optical characteristics from deteriorating by designing so that temperature compensation for the plastic lens is possible even when at least one or two or more plastic lenses are used.

The optical system 1000 according to the embodiment disclosed above may satisfy at least one or two or more of the mathematical equations described below. Accordingly, the optical system 1000 according to the embodiment may have improved optical characteristics. For example, when the optical system 1000 satisfies at least one mathematical equation, the optical system 1000 can effectively control aberration characteristics such as chromatic aberration and distortion aberration, and may have good optical performance not only at the center portion of the FOV but also at the periphery portion. In addition, the optical system 1000 may have improved resolution. In addition, the thickness of the lens on the optical axis OA and the spacing of the adjacent lenses on the optical axis OA described in the Equations can refer to the above-described embodiments.

$$0 < C T 1 / C T 2 < 9 \qquad [ Equation 1 ]$$

In Equation 1, CT1 means the center thickness of the first lens 101, 111, and 121, and CT2 means the center thickness of the second lens 102, 112, and 122. Equation 1 can improve the chromatic aberration of the optical system by setting the difference in the center thickness of the first and second lenses. Equation 1 may satisfy: 5<CT1/CT2<8. By increasing the thickness of the first lens 101, 111, and 121 made of glass, the change in optical characteristics due to temperature change may be suppressed, and the optical performance of the center and periphery portions of the FOV may be improved.

$$( CT 7 * CA 7 ) < ( CT 1 * CA 1 ) \qquad [ Equation 2 ]$$

CT7 is the center thickness of the seventh lens 107, 117, and 127, CA1 is the effective diameter of the first lens 101, 111, and 121, and CA7 is the effective diameter of the seventh lens. The effective diameter is the average of the effective diameters of the object-side surface and the sensor-side surface of each lens. Preferably, the following conditions may satisfy: CT7<CT1 and CA7<CA1. By setting the center thickness and effective diameter of the glass lens and the plastic lens, the optical system can improve spherical aberration, and a slim camera module may be provided.

$$Po 1 < 0 \qquad [ Equation 3 ]$$

In Equation 3, Po1 means the power of the first lens 101, 111, and 121, and may be set to have a short effective focal length F compared to TTL in the optical system for the performance of the optical system. Accordingly, TTL>F may be satisfied, and for example, TTL may be in the range of 1.5 times or more, for example, 1.5 times to 3 times the effective focal length F.

$$1.7 < Nd 5 < 2.2 \qquad [ Equation 4 ]$$

Nd5 is the refractive index of the d-line of the fifth lens 105, 115, and 125. Equation 4 sets the refractive index of the fifth lens high, so that it can control the factor affecting the reduction of the third-order aberration (Seidel aberration) of the optical system, and can reduce aberration that may occur when the TTL becomes somewhat longer. Equation 4 preferably satisfies: 1.75≤Nd5<2.0. If designed to be lower than the lower limit of Equation 4, aberration may be reduced to obtain performance, and the refractive power of the fifth lens may be weakened so that light cannot be collected efficiently, which may deteriorate the performance of the optical system. If designed to be higher than the upper limit of Equation 4, there is a disadvantage in that it becomes difficult to obtain materials. In addition, if the refractive index of the fifth lens 105, 115, and 125 is designed to be lower than the lower limit of Equation 4, in order to increase the refractive power of the sixth and seventh lenses, the curvature radius of the sixth and seventh lenses must be increased, in which case lens manufacturing becomes more difficult, the lens defect rate may increase, and the yield may decrease.

$$1.6 \leq Aver ( Nd 1 : Nd 7 ) \leq 1.7 \qquad [ Equation 4 - 1 ]$$

In Equation 4-1, Aver (Nd1:Nd7) is the average of the refractive index values of the d-line of the first to seventh lenses. When the optical system 1000 according to the embodiment satisfies Equation 4-1, the optical system 1000 can set the resolution and suppress the influence on TTL.

$$1. < SSL\_Nd \_Aver / ASL\_Nd \_Aver < 1.5 \qquad [ Equation 4 - 2 ]$$

SSL_Nd_Aver is the average of the refractive indices of the spherical lenses in the lens portion 100, 100A, and 100B, and ASL_Nd_Aver is the average of the refractive indices of the aspherical lenses. The aspherical lens is positioned on the sensor side of the glass lens having a high refractive index, thereby increasing the color dispersion.

$$1.6 \leq Nd 1 < 1.9 \qquad [ Equation 4 - 3 ]$$

Nd1 is the refractive index of the d-line of the first lens 101, 111, and 121. Equation 4-3 can increase the chromatic dispersion by setting the refractive index of the first lens high.

$$20 < FOV\_H < 40 \qquad [ Equation 5 ]$$

In Equation 5, FOV_H means the horizontal field of view and can set the range of the vehicle optical system. Equation 5 preferably satisfies: 25≤FOV_H≤35 or a range of 30 degrees±3 degrees, and in this case, the sensor length in the horizontal direction may be based on 8.064 mm±0.5 mm. In addition, if Equation 5 is satisfied, when the temperature changes from room temperature to high temperature, the change rate of the effective focal length and the change rate of the field of view may be set to 5% or less, for example, 0 to 5%. In addition, even if one or more aspherical lenses, for example, two or more aspherical lenses, are used in combination with a spherical lens in the optical system 1000, the deterioration of the optical characteristics may be prevented through temperature compensation of the glass lens. Here, when the vertical field of view is FOV_V, the following condition may satisfy: 10<FOV_V<FOV_H.

$$L 1 R 1 < 0 \qquad [ Equation 6 ]$$

L1R1 means the curvature radius of the optical axis of the first surface S1 of the first lens 101, and may be set to be smaller than 0. If Equation 6 is satisfied, the shape of the optical system may be limited. The object-side surface of the first lens 101 is formed concavely from the optical axis, so that when it comes into contact with an external structure, it can prevent surface damage and refract incident light away from the optical axis. In addition, the following condition may satisfy: L1R1*L1R2>0. Accordingly, the center thickness and edge thickness of the first lens 101, 111, and 121 may be increased, and the distance between the first lens 101, 111, and 121 and the second lens 102, 112, and 122 may be reduced.

$$0.8 < BFL / L 7 S 2 \_max \_sag to Sensor < 3 \qquad [ Equation 7 ]$$

L7S2_max_sag to Sensor may be the distance in the optical axis direction from the maximum Sag value of the seventh lens 107 to the image sensor 300. When the optical system satisfies Equation 7, the TTL may be reduced and the conditions for manufacturing the camera module may be set. In addition, L7S2_max_sag to Sensor can set the space in which the optical filter 500 and the cover glass 400 located between the image sensor 300 and the seventh lens 107, 117, and 127 may be disposed. When the range of Equation 7 is smaller than the lower limit, the space for placing circuit structures such as the optical filter and the image sensor becomes more restricted, and the process of assembling the circuit structures such as the filter and the image sensor into the optical system can become difficult. When the range of Equation 7 is larger than the upper limit, the process of assembling the circuit structures such as the filter and the image sensor into the optical system is easy, but the TTL becomes longer, making it difficult to miniaturize the optical system. That is, Equation 7 can set the minimum distance between the image sensor 300 and the last lens. The BFL is the center distance from the image sensor 300 to the center of the sensor-side surface of the last lens. In detail, if 2<BFL/L7S2_max_sag to Sensor<3 is satisfied, the manufacturing convenience and TTL reduction are easier.

$$1 < C T 1 / C T 7 < 15 \qquad [ Equation 8 ]$$

If Equation 8 is satisfied, the aberration characteristics may be improved and the influence on the reduction of the optical system may be set. In Equation 8, the first and second embodiments may satisfy: 5<CT1/CT7<12, and the third embodiment may satisfy: 0.5<CT1/CT7<2.5. Equation 8 can set the center thickness of the first lens having a spherical or aspherical surface and the seventh lens having an aspherical surface, and can limit the difference in their center thicknesses. Accordingly, the chromatic aberration of the optical system may be improved, good optical performance may be achieved at the set field of view, and TTL (total track length) may be controlled.

$$0.1 < CT 1 / CA 11 < 1.2 \qquad [ Equation 8 - 1 ]$$

In Equation 2, the center thickness CT1 of the first lens 101, 111, and 121 and the effective diameter CA11 of the object-side surface S1 of the first lens 101 may be set, and if this is satisfied, the strength and optical characteristics of the glass lens may be prevented from being deteriorated. If it is lower than the range of Equation 1, the lens may be damaged or difficult to process, and if it is larger than the range, the TTL may increase and the weight of the optical system may become heavier. Preferably, the first and second embodiments satisfy: 0.6<CT1/CA11<1, and the third embodiment may satisfy: 0.1<CT1/CA11<0.5.

$$0 < CT 1 / CT 6 < 3 \qquad [ Equation 9 ]$$

CT6 means the center thickness of the sixth lens 106. When the optical system satisfies Equation 9, the aberration characteristics may be improved and the influence on the reduction of the optical system may be set. In Equation 9, the first and second embodiments may satisfy: 1.5<CT1/CT6<2.2, and the third embodiment may satisfy: 0<CT1/CT6<2. Equation 9 sets the difference in the center thickness of the first and sixth lenses, so that the chromatic aberration of the optical system may be improved.

$$0 < CT 45 / CT 6 < 1 \qquad [ Equation 10 ]$$

In Equation 10, CT45 is the center thickness of the fourth and fifth lenses, for example, the center thickness of the cemented lens 145. That is, CT45 is the center distance from the center of the object-side surface of the fourth lens 104 and 114 to the center of the sensor-side surface of the fifth lens 105, 115, and 125. When the optical system satisfies Equation 10, the thickness of the cemented lens and the adjacent sixth lens 106, 116, and 126 may be set to improve the aberration characteristics, and preferably, the first and second embodiments may satisfy: 0.5<CT45/CT6<1, and the third embodiment can preferably satisfy 1<CT45/CT6<4 or 2<CT45/CT6≤3.5. Here, the following condition may satisfy: CT45>ET45, and ET45 is the edge thickness of the cemented lens.

$$0 < \vert L 2 R 1 / L 4 R2 \vert < 1 \qquad [ Equation 11 ]$$

In Equation 11, L2R1 means the curvature radius of the first surface S1 of the second lens 102, 112, and 122, and L4R2 means the curvature radius of the eighth surface S8 of the fourth lens 104 and 114. When the optical system 1000 according to the embodiment satisfies Equation 11, the optical system 1000 may have improved aberration characteristics.

$$0 < CT 45 - ET 45 < 2 mm \qquad [ Equation 12 ]$$

In Equation 12, ET45 is the center distance from the end of the effective region of the object-side surface of the fourth lens 104, 114, and 124 to the end of the effective region of the sensor-side surface of the fifth lens 105, 115, and 125. When the optical system satisfies Equation 12, the center thickness and the edge thickness of the cemented lens may be set to improve the aberration characteristics, and preferably 1 mm≤CT45/ET45<1.5 mm may be satisfied. The ET45 may be greater than the edge thickness ET1-ET7 of each of the second to seventh lenses.

$$0 < CA 11 / CA 31 < 2 \qquad [ Equation 13 ]$$

In Equation 13, CA11 means the effective diameter of the first surface S1 of the first lens 101, 111, and 121, and CA31 means the effective diameter of the fifth surface S5 of the third lens 103 and 113. When Equation 13 is satisfied, the optical system 1000 can control the incident light and set the factor affecting the aberration, and preferably, the first and second embodiments may satisfy: 1<CA11/CA31<1.5, and the third embodiment may satisfy: 0.5<CA11/CA31<1.5.

$$0 < CA 72 / CA 42 < 2 \qquad [ Equation 14 ]$$

In Equation 14, CA42 means the effective diameter of the 8th surface S8 of the fourth lens 104, 114, and 124, and CA72 means the effective diameter of the fourteenth surface S14 of the seventh lens 107, 117, and 127. When Equation 14 is satisfied, the optical system 1000 can control the incident light path and set elements for performance changes according to CRA and temperature. Preferably, the first and second embodiments may satisfy: 0.5<CA72/CA42<1.0, and the third embodiment may satisfy: 0.5<CA72/CA42<1.0.

$$0 < CA 12 / CA 21 < 2 \qquad [ Equation 15 ]$$

In Equation 15, CA12 means the effective diameter of the second surface S2 of the first lens 101, 111, and 121, and CA21 means the effective diameter of the third surface S3 of the second lens 102, 112, and 122. When the optical system 1000 according to the embodiment satisfies Equation 15, the optical system 1000 can control the light traveling to the first lens group LG1 and the second lens group LG2, and can set a factor affecting the decrease in lens sensitivity. The first and second embodiments may satisfy: 1≤CA12/CA21<1.5, and the third embodiment may satisfy: 0.5<CA12/CA21<1.5.

$$1 < CA 1 / CA 6 < 2 \qquad [ Equation 16 ]$$

CA1 means the effective diameter of the first lens 101, 111, and 121, and CA6 means the effective diameter of the sixth lens 106. When the optical system 1000 according to the embodiment satisfies Equation 16, the size of the spherical lens(es) may be set. The first and second embodiments may satisfy: 1<CA31/CA42<1.7, and the third embodiment may satisfy: 1≤CA41/CA52<1.8.

$$1 < CA 41 / CA 52 < 2 \qquad [ Equation 17 ]$$

CA42 means the effective diameter of the seventh surface S7 of the fourth lens 104, 114, and 124, and CA52 means the effective diameter of the tenth surface S10 of the fifth lens 105, 115, and 125. When the optical system 1000 according to the embodiment satisfies Equation 17, the optical system 1000 can improve chromatic aberration and set the size between the object-side surface and the sensor-side surface of the cemented lens 145. Accordingly, by setting the effective diameter size of the cemented lens, which is arranged closer to the object side than the aspherical lens, the light incident through the cemented lens may be effectively guided to the aspherical lens. The first and second embodiments may satisfy: 1<CA41/CA42<1.6, and the third embodiment may satisfy: 1<CA41/CA42<1.5.

$$0 < CA 52 / CA 61 < 2 \qquad [ Equation 18 ]$$

CA61 means the eleventh surface S11 of the sixth lens 106, 116, and 126. When the optical system 1000 according to the embodiment satisfies Equation 18, the relationship between the effective diameter of the sensor-side surface of the cemented lens 145 and the effective diameter of the object-side surface of the lens adjacent thereto may be set. Accordingly, the optical system 1000 can improve chromatic aberration and set the size and curvature radius between the sensor-side surfaces of the cemented lens. Accordingly, the effective diameter sizes of the aspherical lens and the spherical lens arranged on the object side more than the last lens may be set. The first and second embodiments may satisfy: 0.5<CA52/CA61<1, and the third embodiment may satisfy: 1.1≤CA51/CA52≤1.4.

$$CA 41 > ( ImgH * 2 ) \qquad [ Equation 18 - 1 ]$$

$$CA 51 \geq ( ImgH * 2 ) \qquad [ Equation 18 - 2 ]$$

$$CA 62 < ( ImgH * 2 ) \qquad [ Equation 18 - 3 ]$$

In Equations 18-1 to 18-3, the effective diameter of the object-side surface of the fifth lens 105, 115, and 125, the effective diameter of the object-side surface of the fourth lens 104, 114, and 124, and the effective diameter of the sensor-side surface of the sixth lens 106, 116, and 126 can set the light path to a region of the image sensor 300. In the embodiment, since the n-th lens is provided as an aspherical lens, the effective diameter ratio of the adjacent spherical lens and the cemented lens may satisfy Equations 18 to 18-3.

$$1 < SSL\_CA \_Aver / ASL\_CA \_Aver < 1.5 \qquad [ Equation 19 ]$$

In Equation 19, SSL_CA_Aver means the average effective diameter of lenses having a spherical surface, and ASL_CA_Aver means the average effective diameter of lenses having an aspherical surface. In Equation 19, the effective diameter size of the aspherical lens arranged on the object side is set to the maximum, so that the path of the incident light may be effectively guided. In addition, the difference in the effective diameters of the spherical lens and the aspherical lens may be set not to be large. Here, nGL>nASL>nPL>0 may be satisfied. The nGL is the number of glass lenses, nPL is the number of plastic lenses, and nASL is the number of aspherical lenses.

$$0 < SSL\_Nd \_Aver / ASL\_Nd \_Aver < 1.6 \qquad [ Equation 20 ]$$

In Equation 19, SSL_Nd_Aver is the average of the refractive indices of the spherical material lenses, for example, the average of the refractive indices of the first to fifth lenses. ASL_Nd_Aver is the average of the refractive indices of the sixth and seventh lenses. Preferably, the refractive indices of the spherical lens and the refractive indices of the aspherical lens may be set to satisfy the following condition may satisfy: 0.5<SSL_Nd_Aver/ASL_Nd_Aver<1.2.

The first and second embodiments may satisfy the equation: 0<ΣASL_Nd/ΣSSL_Nd<0.5. ΣASL_Nd is the sum of the refractive indices of the aspherical lens, and ΣSSL_Nd is the sum of the refractive indices of the spherical lens. Preferably, 0.2<ΣASL_Nd/ΣSSL_Nd<0.4 may be satisfied. The optical system can control the resolution and color dispersion by setting the difference in refractive index between the spherical lens and the aspherical lens.

$$CA 7 < ( ImgH * 2 ) \qquad [ Equation 21 ]$$

In Equation 21, CA7 is the average effective diameter of the object-side surface and the sensor-side surface of the plastic lens, and CT1 is the center thickness of the first lens. Since the diagonal length of the image sensor satisfies the Equation 21, a slim camera module may be provided. The first and second embodiments may satisfy: (ImgH*2)<CT1.

$$0 < CT 7 / CG 6 < 3 \qquad [ Equation 22 ]$$

In Equation 23, CG6 is the center distance between the sensor-side surface of the sixth lens 106 and the object-side surface of the seventh lens 107. In Equation 23, the center thickness CT7 of the seventh lens 107 and the center distance between the sixth and seventh lenses may be set to improve the optical performance at the periphery portion of the field of view. The first and second embodiments may satisfy: 0<CT7/CG6<1 or 0.5<CT7/CG6<1, and the third embodiment may satisfy: 1<CT7/CG6<3 or 1.1<CT7/CG6<2.

The first and second embodiments satisfy condition 1: (CT2+CT3+CT4)<CT1, and in condition 1, the center thickness of the first lens may be greater than the sum of the center thicknesses of the three adjacent lenses. In addition, the following conditions may satisfy: (CT3+CT4+CT5)<CT1, (CT4+CT5+CT6)<CT1, and (CT5+CT6+CT7)<CT1. If condition 1 is satisfied, the center thickness from the first lens to the seventh lens may be set, so that the optical performance of the peripheral part of the FOV may be improved.

The first and second embodiments may satisfy condition 1-1: G4<0.01 or CG4<0.01. In condition 1-1, G4 and CG4 are the distance and center distance between the fourth lens 104 and the fifth lens 105. If Equation 1-1 is satisfied, the fourth and fifth lenses may be set as cemented lenses.

The first and second embodiments may satisfy condition 2: CT3<(CT2*2)<CT1<F. Condition 2 can set the relationship between the center thickness of the first, second, and third lenses and the total effective focal length F. According to condition 2, the incident light may be guided to the aspherical lens by the thickness of the object-side spherical lenses, and thermal compensation according to temperature change is possible and the assembly characteristics may be improved.

The first and second embodiments may satisfy condition 3: (CT7*3)<CT1<(CT6*2)<F. In condition 3, when the center thicknesses of the first, sixth, and seventh lenses are satisfied, the light emitted by the thickness of the sensor-side aspherical lens may be refracted to the entire region of the image sensor, and the TTL may be reduced.

The first and second embodiments may satisfy condition 4:3<CT6/CT7<6. In condition 4, by setting the center thickness CT6 of the sixth lens to be thicker than the center thickness CT7 of the seventh lens, the factors affecting the aberration may be controlled. Preferably, condition 4 may satisfy: 4<CT6/CT7<6.

$$0 < \vert F 1 / F \vert < 20 \qquad [ Equation 23 ]$$

Equation 23 sets the relationship between the focal length F1 and the effective focal length F of the first lens, so that the TTL of the optical system may be set. In Equation 23, the first and second embodiments may satisfy: 1<|F1/F|<5, and the third embodiment may satisfy: 1<|F1|/F<5.

$$0 < \vert F 5 / F 6 \vert < 1 \qquad [ Equation 24 ]$$

In Equation 24, the relationship between the focal lengths F5 and F6 of the fifth and sixth lenses may be set, so that the refractive power and optical path of the spherical lens and the adjacent aspherical lens may be adjusted, and the resolution may be improved. Equation 24 may satisfy: 0<|F5/F6|<0.5.

$$0 < \vert F 5 / F 7 \vert < 1 \qquad [ Equation 25 ]$$

In Equation 25, by setting the relationship between the focal lengths F5 and F7 of the fifth and seventh lenses, the refractive power and optical path of the spherical lens and the last aspherical lens may be adjusted, and the resolution may be improved. Equation 25 preferably satisfies: 0<|F5/F7|<0.6.

$$0 < \vert F 6 / F 1 \vert < 2 \qquad [ Equation 26 ]$$

In Equation 26, by setting the relationship between the focal lengths F1 and F6 of the first and sixth lenses, the refractive power and optical path of the first spherical lens and the first aspherical lens may be adjusted, and the influence of TTL may be adjusted, and the resolution may be improved. In Equation 26, the first and second embodiments may satisfy: 0<|F6/F1|<1, and the 3rd embodiment may satisfy: 0.5<|F6/F1|<1.

$$10 < L 7 R 1 / CT 7 \qquad [ Equation 27 ]$$

L7R1 means the curvature radius of the thirteenth surface of the seventh lens on the optical axis. In Equation 27, by setting the curvature radius of the object-side surface of the seventh lens and the center thickness of the seventh lens, the refractive power of the seventh lens may be controlled. Accordingly, good optical performance may be achieved at the center and periphery portions of the field of view. Preferably, in Equation 27, the first and second embodiments may satisfy: 10<L7R1/CT7<30, and the third embodiment may satisfy: 100<L7R1/CT7<300.

$$L 5 R 2 / L 7 R 1 < 1 \qquad [ Equation 28 ]$$

L5R2 means the curvature radius of the tenth surface of the fifth lens on the optical axis. In Equation 28, the curvature radius of the sensor-side surface of the fifth lens and the curvature radius of the object-side surface of the seventh lens are set, so that the refractive power of the fifth and seventh lenses may be controlled. Accordingly, good optical performance may be achieved at the center and periphery portions of the field of view. Preferably, in Equation 28, the first and second embodiments may satisfy: 0<L5R2/L7R1<0.5, and the third embodiment may satisfy: 0<L5R2/L7R1<1.

$$\vert L 1 R 1 \times L 1 R 2 > 0 \qquad [ Equation 29 ]$$

L1R1 is the curvature radius of the object-side surface of the first lens on the optical axis, and L1R2 is the curvature radius of the sensor-side surface of the first lens on the optical axis. When Equation 29 is satisfied, the refractive power of the first lens is controlled to adjust the dispersion of the incident light, and the assemblability of the first lens may be improved.

$$0 < L 5 R 1 / L 4 R 2 < 2 \qquad [ Equation 30 ]$$

L5R1 is the curvature radius of the object-side surface of the fifth lens on the optical axis, and L4R2 is the curvature radius of the sensor-side surface of the fourth lens on the optical axis. If Equation 30 is satisfied, the fourth and fifth lenses may be expressed as a bonded lens. Preferably, L5R1/L4R2=1 may be satisfied.

The third embodiment may satisfy the condition: 1<L6R1/L5R2<10 or 1<L6R1/L5R2<6. Accordingly, by setting the curvature radius of the sensor-side surface of the fifth lens and the sensor-side surface of the sixth lens, light may be effectively refracted from the cemented lens toward the plastic lens. The third embodiment may satisfy the condition: |LR|Min<PL1_R1. Here, |LR|_Min represents the minimum curvature radius among all lenses, and PL1_R1 means the curvature radius of the object-side surface of the plastic lens closest to the object side. When the condition is satisfied, the plastic lens may be placed closer to the sensor than the sensor-side surface of the glass lens with the minimum curvature radius, thereby refracting light toward the incident surface of the plastic lens.

$$1 < L 6 R 2 / L 6 R 1 \qquad [ Equation 31 ]$$

L6R1 means the curvature radius of the object-side surface of the sixth lens on the optical axis, and L6R2 means the curvature radius of the sensor-side surface of the sixth lens on the optical axis. In Equation 31, by setting the curvature radius of the object-side surface and the sensor-side surface of the sixth lens, light may be refracted through the aspherical lens. In Equation 31, the first and second embodiments may satisfy: 1.5<L6R2/L6R1<3, and the third embodiment may satisfy the conditions: 3<L6R2/L6R1<50, L6R1>0, L6R2>0, and L6R1<L6R2. The object-side surface and the sensor-side surface of the sixth lens, which is a glass lens, are aspherical, and when the difference in the curvature radius of the aspherical object-side surface and the aspherical sensor-side surface satisfies the above range, the assemblability of the sixth lens may be improved, and the influence of the optical characteristics due to temperature change may be suppressed.

The first and second embodiments satisfy [Equation 31-1] 1<L7R1/L7R2<3, where L7R1 and L7R2 means the curvature radius of the object-side surface and the sensor-side surface of the seventh lens on the optical axis. In Equation 31-1, by setting the curvature radius of the aspherical object-side surface and the aspherical sensor-side surface of the plastic lens, light may be refracted to the entire region of the image sensor through the seventh lens. Accordingly, when the difference in the curvature radius between the object-side surface and the sensor-side surface of the seventh lens satisfies the above range, the assemblability of the seventh lens may be improved, and the influence on the optical characteristics due to temperature change may be suppressed. The third embodiment may satisfy [Equation 31-2] 1<|L7R1/L7R2|<100. Equation 31-2 may satisfy: 0<|L7R1/L7R2|<50. Here, the following conditions may satisfy: L7R1>0, L6R1>0, and L7R2<L7R1.

$$0 < CT\_Max / CG\_Max < 5 \qquad [ Equation 32 ]$$

In Equation 32, the maximum center thickness CT_Max among the lenses and the maximum center distance CG_Max between adjacent lenses may be set. If Equation 32 is satisfied, the optical system may have good optical performance at the focal length at the set field of view and can reduce TTL. Preferably, the first embodiment may satisfy: 0<CT_Max/CG_Max<0.5, and the third embodiment may satisfy: 1<CT_Max/CG_Max<3.

$$1 < \sum CT / \sum CG < 7 \qquad [ Equation 33 ]$$

ΣCT is the sum of the center thicknesses of the lenses, and ΣCG is the sum of the center distances between adjacent lenses. If Equation 33 is satisfied, the optical system may have good optical performance at the focal length at the set field of view and can reduce TTL. The third embodiment may satisfy: 2<ΣCT/ΣCG<4.5.

$$8 < \sum Nd < 30 \qquad [ Equation 34 ]$$

ΣNd means the sum of the refractive indices at the d-line of each of the plurality of lenses. If Equation 34 is satisfied, the optical system 1000 in which aspherical lenses and spherical lenses are mixed can control TTL and have improved resolution. In addition, if the number of spherical lenses is greater than the number of aspherical lenses, heat compensation is possible by a spherical lens having a relatively thick thickness, and the sum of the TTL and refractive index of the lenses may be set. Equation 34 can preferably satisfy: 10<ΣNd<13.

$$10 < \sum Vd / \sum Nd < 50 \qquad [ Equation 35 ]$$

ΣVd means the sum of the Abbe numbers of each of the plurality of lenses. If Equation 35 is satisfied, the optical system 1000 may have improved aberration characteristics and resolution. Equation 35 sets the sum of the Abbe number and the sum of the refractive index of the lenses to control the optical characteristics, and preferably satisfies: 20<ΣVd/ΣNd<35.

$$Distortion < 2 \qquad [ Equation 36 ]$$

Distortion means the maximum value of distortion or the absolute value of the maximum from the center (0.0F) of the image sensor to the diagonal end (1.0F) based on the optical characteristics detected by the image sensor 300. When the optical system 1000 satisfies Equation 36, the optical system 1000 can improve the distortion characteristics and set conditions for image processing. Preferably, Distortion<1 may be satisfied.

$$0 < \sum CT / \sum ET < 2 \qquad [ Equation 37 ]$$

ΣCT is the sum of the center thicknesses of the lenses, and SET is the sum of the edge thicknesses of the ends of the effective regions of the lenses. If Equation 37 is satisfied, the optical system may have good optical performance at the focal length at the set field of view, and can reduce the TTL. In Equation 37, the first and second embodiments may satisfy: 1<ΣCT/ΣET<1.5, and the third embodiment may satisfy: 0.5<ΣCT/ΣET<1.5.

$$1 < CA 11 / CA\_Min < 5 \qquad [ Equation 38 ]$$

CA11 is the effective diameter of the object-side surface of the first lens, and CA_Min represents the minimum effective diameter among the object-side surfaces and the sensor-side surfaces of the lenses. If Equation 38 is satisfied, the relationship between the maximum effective diameter of the glass lens and the minimum effective diameter of the plastic lens may be set, thereby providing a slimmer module while maintaining incident light control and optical performance. Equation 38 preferably satisfies: 1<CA11/CA_Min<2.5.

$$1 < CA\_Max / CA\_Min < 5 \qquad [ Equation 39 ]$$

CA_Max means the maximum effective diameter among the object-side surfaces and the sensor-side surfaces of the lenses. If Equation 39 is satisfied, the optical system can set the size for a slim and compact structure while maintaining optical performance. Equation 39 may preferably satisfy: 1.2<CA_Max/CA_Min<2.5.

$$1 < CA\_Max / CA\_Aver < 3 \qquad [ Equation 40 ]$$

CA_Aver means the average of the effective diameters of the object-side surfaces and the sensor-side surfaces of the lenses. If Equation 40 is satisfied, the optical system can set the size for a slim and compact structure while maintaining optical performance. Equation 40 may preferably satisfy: 1<CA_Max/CA_Aver<1.7.

$$0.5 < CA\_Min / CA\_Aver < 2 \qquad [ Equation 41 ]$$

If Equation 41 is satisfied, the optical system can set the size for a slim and compact structure while maintaining optical performance. Equation 41 may preferably satisfy: 0.5<CA_Min/CA_Aver<1.

$$1 < CA\_Max / ( 2 * ImgH ) < 3 \qquad [ Equation 42 ]$$

Equation 42 may be set by the maximum effective diameter CA_Max of lens surfaces and the diagonal length of the image sensor, and if it is satisfied, the optical system can maintain good optical performance and set the size for a slim and compact structure. Equation 42 may preferably satisfy: 1<CA_Max/(2*ImgH)<2.

$$1 < TD / CA\_Max < 4 \qquad [ Equation 43 ]$$

TD is the center distance from the center of the object-side surface of the first lens to the center of the sensor-side surface of the last lens. If Equation 43 is satisfied, the entire center distance and the maximum effective diameter of the lenses may be set, so that the size for good optical performance may be set. Equation 43 preferably satisfies: 2<TD/CA_Max<3.

$$TD > SD \qquad [ Equation 43 - 1 ]$$

The SD is the distance from the position of the aperture stop to the center of the sensor-side surface of the last lens.

$$1 < F / CA 61 < 10 \qquad [ Equation 44 ]$$

F means the EFL of the optical system, and may be 10 mm or more, for example, in the range of 10 mm to 20 mm. In Equation 44, the relationship between the effective focal length and the effective diameter of the object-side surface of the first aspherical lens is set, so that the influence on the optical system reduction, for example, TTL, may be controlled. Equation 44 may preferably satisfy: 1<F/CA61<2 or 1<F/CA61<5.

$$0 < F / \vert L 1 R 1 \vert < 1 \qquad [ Equation 45 ]$$

In Equation 45, the effective focal length of the optical system and the curvature radius of the object-side surface of the first lens on the optical axis may be set, so that the influence on the incident light and TTL may be controlled. Equation 45 may preferably satisfy: 0.3<F/|L1R1|<1 or 0.2≤F/|L1R1|≤0.85.

$$Max ( CT / ET ) < 3 \qquad [ Equation 46 ]$$

Max(CT/ET) means the maximum value of the ratio of the center thickness and the edge thickness of each lens. When Equation 46 is satisfied, the optical system can control the influence on the effective focal length. Equation 46 may preferably satisfy: 0.5<Max(CT/ET)<1. Accordingly, the assemblability of the entire lenses may be improved.

In the third embodiment, condition 1 satisfies: Max_th/Min_th<3, where Max_th is the thickness of the thickest region of the lens, and Min_th is the thickness of the thinnest region of the lens. Max_th/Min_th is a ratio of the thickest thickness Max_th and the thinnest thickness Min_th of each lens. The thickest thickness Max_th of the lens may be the center thickness CT of the lens, and the thinnest thickness Min_th of the lens may be the edge thickness ET of the lens. The condition 1 may satisfy: 1<Max_th/Min_th≤2.6. Here, the ratio of the maximum thickness and minimum thickness of the plastic lenses may satisfy the following conditions.

The following condition 2 according to the third embodiment may satisfy: 1.0<Max_PL_th/Min_Pl_th<2.5. If it is smaller than the lower limit of the range of Condition 2, it is difficult to manufacture the plastic lens. That is, if the high-temperature resin is injected and hardened at a low temperature to manufacture it, if the thickness difference is large, the lens may not shrink uniformly as it cools at a low temperature, which may result in a high surface defect rate. In addition, if it is larger than the range of Conditions 1 and 2, the plastic lens shrinks and expands as the temperature changes from −40 degrees to 105 degrees, and during this process, the rate of change in the shape of the lens appears significantly, which may deteriorate the optical performance. Preferably, the following condition 2 may satisfy: 1.0<Max_PL_th/Min_Pl_th<1.8 or 1.0<Max_PL_th/Min_Pl_th<1.5.

The third embodiment satisfies condition 3:3<MAX(EG/CG)<9, and MAX(EG/CG) may set a value at which the ratio of center distance CG and edge distance EG between adjacent lenses is the maximum. In addition, condition 4 may satisfies: 1<MIN(EG/CG)<1.5, and MIN(EG/CG) may set a value at which the ratio of center distance CG and edge distance EG between adjacent lenses is the minimum.

$$0 < EPD / \vert L 1 R 1 \vert < 1 \qquad [ Equation 47 ]$$

EPD means the size (mm) of the entrance pupil diameter of the optical system 1000, and L1R1 means the curvature radius of the first surface S1 of the first lens on the optical axis. When the optical system 1000 according to the embodiment satisfies Equation 47, the optical system 1000 can control incident light. Equation 47 may preferably satisfy: 0.2<EPD/|L1R1|<0.7 or 0<EPD/|L1R1|≤0.5.

$$- 10 < F 1 / F 3 < 0 \qquad [ Equation 48 ]$$

F1 is the focal length of the first lens, and F3 is the focal length of the third lens. When Equation 48 is satisfied, the refractive power of the first and third lenses may be controlled to improve the resolution, and the TTL and EFL may be affected. The third embodiment may satisfy: −5<F1/F3<0, and may also satisfy at least one of | F5|<F4, | F5|<F6, and | F5|<|F7|.

$$Po 4 * Po 5 < 0 \qquad [ Equation 49 ]$$

Po4 is a power value of the fourth lens, and Po5 is a power value of the fifth lens. That is, the refractive powers of the fourth and fifth lenses have opposite refractive powers, so they can improve aberrations and effectively guide light with an aspherical lens. If the Po4*Po5 value is greater than 0, the effect of improving chromatic aberration as a cemented lens does not appear significantly.

$$Po 1 ( Po 4 * Po 5 ) > 0 \qquad [ Equation 49 - 1 ]$$

$$F 45 < 0 \qquad [ Equation 49 - 2 ]$$

$$F 4 * F 5 < 0 \qquad [ Equation 49 - 3 ]$$

Po1 is the power value of the first lens, F45 is the composite focal length of the fourth and fifth lenses, F4 is the focal length of the fourth lens, and F5 is the focal length of the fifth lens. If Equations 49-1 to 49-3 are satisfied, it is easy to improve the aberration of the optical system with the fourth lens and the fifth lens, which are cemented lenses, and the incident light may be effectively guided to the aspherical lens.

$$15 < Vd 4 - Vd 5 < 50 \qquad [ Equation 50 ]$$

Vd4 is the Abbe number of the fourth lens, and Vd5 is the Abbe number of the fifth lens. If Equation 50 is satisfied, the difference in Abbe numbers of at least two lenses forming the cemented lens may be maintained above a certain value, and chromatic aberration may be improved. Equation 50 preferably satisfies: 20≤v4−v5≤40. If the cemented lens is less than the lower limit of Equation 50, it may be insignificant in improving the aberration characteristics of the optical system.

$$0 < F 6 / F < 5 \qquad [ Equation 51 ]$$

In Equation 51, the relationship between the focal length F6 and the effective focal length F of the sixth lens is set, so that the refractive power of the first aspherical lens and the entire focal length may be adjusted to improve the resolution, and the optical system may be provided in a slim and compact size. Equation 51 may preferably satisfy: 1<F6/F<3.5 or 1<F6/F<4.

$$0 < EPD / ImgH / FOV < 0.2 \qquad [ Equation 52 ]$$

Equation 52 can set the relationship between the entrance pupil diameter (EPD), the length (ImgH) of ½ of the diagonal length of the image sensor, and the diagonal field of view. Accordingly, the overall size and brightness of the optical system may be controlled. Equation 52 may preferably satisfy: 0<EPD/ImgH/FOV<0.1.

$$5 < FOV / F \# < 40 \qquad [ Equation 53 ]$$

Equation 53 can set the relationship between the diagonal field of view of the optical system and the F number. Preferably, Equation 53 may satisfy: 10<FOV/F #<30. Here, F # is provided as 1.8 or less, so as to provide a bright image.

$$1 < \sum SSL\_CT / F \# < 40 \qquad [ Equation 54 ]$$

Equation 54 can set the relationship between the sum ΣSSL_CT of the center thicknesses of the glass lenses of the optical system and the F number F #. Preferably, the first and second embodiments in Equation 54 may satisfy: 1<ΣSSL_CT/F #<20 or 10<ΣSSL_CT/F #<20. The third embodiment may satisfy: 1<ΣGL_CT/F #<10.

$$0 < \sum PL\_CT / F \# < 20 \qquad [ Equation 55 ]$$

Equation 55 can set the relationship between the sum ΣPL_CT of the center thicknesses of the plastic lenses of the optical system and the F number F #. In Equation 83, the first and second embodiments may satisfy: 0.5<ΣPL_CT/F #<1, and the third embodiment may satisfy: 1<ΣPL_CT/F #<10.

$$1 < \sum GL\_Nd / F \# < 20 \qquad [ Equation 56 ]$$

Equation 84 can set the relationship between the sum ΣGL_Nd of the refractive indices of the glass lenses of the optical system and the F number F #. In Equation 84, the first and second embodiments may satisfy: 3<ΣGL_Nd/F #<8, and the third embodiment may satisfy: 1<ΣGL_Index/F #<10.

$$1 < \sum PL\_Nd / F \# < 10 \qquad [ Equation 57 ]$$

Equation 84 can set the relationship between the sum ΣPL_Nd of the refractive indices and the F number F # of the plastic lens. In Equation 84, the first and second embodiments may satisfy: 1<ΣPL_Nd/F #<1.5, and the third embodiment may satisfy: 1<ΣPL_Index/F #<5.

$$\vert Max\_Sag62 \vert < \vert Max\_Sag52 \vert \qquad [ Equation 57 ]$$

Max_Sag62 is the maximum distance in the optical axis direction from a straight line perpendicular to the optical axis on the sensor-side surface of the sixth lens to the sensor-side surface of the sixth lens, and Max_Sag52 is the maximum distance in the optical axis direction from a straight line perpendicular to the optical axis on the sensor-side surface of the fifth lens to the sensor-side surface of the fifth lens. When Equation 86 is satisfied, light may be guided from the last spherical lens to the first aspherical lens by the curvature radius of the sensor-side surface of the fifth lens, and the effective diameters of the fifth and sixth lenses may be adjusted.

$$\vert Max\_Sag62 \vert < \vert Max\_Sag72 \vert \qquad [ Equation 58 ]$$

Max_Sag72 is the maximum distance in the optical axis direction from a straight line perpendicular to the optical axis on the sensor-side surface of the seventh lens to the sensor-side surface of the seventh lens. If the Equation 58 is satisfied, the light may be guided from the aspherical lens to the aspherical lens by the curvature radius of the sensor-side surface of the sixth lens, and the effective diameters of the sixth and seventh lenses may be adjusted.

The first and second embodiments may satisfy the condition: |Max_Sag52|<|Max_Sag41|. Max_Sag41 is the maximum distance in the optical axis direction from a straight line perpendicular to the optical axis on the object-side surface of the fourth lens to the object-side surface of the fourth lens. Max_Sag52 is the maximum distance in the optical axis direction from a straight line perpendicular to the optical axis on the sensor-side surface of the fifth lens to the sensor-side surface of the fifth lens.

The third embodiment may satisfy the following conditions.

$$0 < \vert L1S1\_sag \_max \vert < 1 or 0.5 < \vert L1S1\_sag \_max \vert < 1 \qquad Condition 1$$

$$0 < \vert L1S2\_sag \_max \vert < 1 or 0 < \vert L1S2\_sag \_max \vert < 0.5 \qquad Condition 2$$

$$0 < \vert L2S2\_sag \_max \vert < 2 or 0.8 < \vert L2S2\_sag \_max \vert < 1.5 \qquad Condition 3$$

$$1 < \vert L4S1\_sag \_max \vert < 3 or 1.5 < \vert L4S1\_sag \_max \vert < 2. \qquad Condition 4$$

$$1 < \vert L5S2\_sag \_max \vert < 3 or 1.2 < \vert L5S2\_sag \_max \vert < 2. \qquad Condition 5$$

Conditions 1 to 5 represent the maximum Sag value of each lens surface, and when the conditions are satisfied, the separation distance from the adjacent lens surfaces may be set.

The first and second embodiments may satisfy the following conditions.

$$0 < \vert F 37 \vert / F 12 < 3 or 0 < F 37 / F 12 < 1 \qquad Condition 1$$

$$0 < F 37 / F 6 < 1 or 0 < F 37 / F 6 < 1 \qquad Condition 2$$

$$0 < \vert F 37 / F 7 \vert < 1 or 0 < \vert F 37 / F 7 \vert < 0.7 \qquad Condition 3$$

$$F 37 < TTL \qquad Condition 4$$

In conditions 1 to 5 according to the first and second embodiments, the relationship between the composite focal length F37 of the third to seventh lenses and the composite focal length F12 of the first and second lenses or the focal lengths of other lenses is set, thereby controlling the refractive power of each lens and improving the resolution, and providing an optical system with a slim and compact size.

$$1 < nGL / nASL < 4 \qquad [ Equation 60 ]$$

nGL is the number of glass lenses, and nASL is the number of aspherical lenses.

$$1 < nGL / nPL \qquad [ Equation 61 ]$$

nGL is the number of glass lenses, and nPL means the number of plastic lenses. By arranging plastic lenses in Equation 60, the thickness of the optical system may be reduced and a wider range of refractive powers may be provided through the aspherical surface. The first and second embodiments may satisfy: 4<nGL/nPL<7, and the third embodiment may satisfy: 1<nGL/nPL<4.

The following condition may satisfy: 1<nSS/nASS<3. nSS is the number of lens surfaces having a spherical surface within the lens section, and nASS is the number of lens surfaces having an aspherical surface within the lens section. By setting the ratio of the spherical lens surface and the aspherical lens surface under the conditions, the thickness of the optical system may be reduced and a wider range of refractive powers may be provided through the aspherical surface.

The first and second embodiments may satisfy the condition: CA3<CA2<CA1, and by setting the relationship between the effective diameters CA1, CA2, and CA3 of the first, second, and third lenses, the optical paths of the lenses before and after the aperture stop may be controlled, and the optical paths of the entire lenses may be set. The third embodiment may satisfy the condition: CA_L2≤CA_L4<CA_L3, and the size relationship between the average effective diameters CA_L2, CA_L3, and CA_L4 of the object-side surface and the sensor-side surface of the second, third, and fourth lenses may be set.

$$0 < \sum PL\_CT / \sum GL\_CT < 0.5 \qquad [ Equation 62 ]$$

ΣPL_CT is the sum of the center thicknesses of the plastic lens(es), and ΣGL_CT is the sum of the center thicknesses of the glass lenses. If Equation 62 is satisfied, the entire TTL may be controlled by setting the relationship between the thickness of the aspherical lens and the thickness of the spherical lens compared to the TTL. Equation 62 preferably satisfies 0.1<ΣPL_CT/ΣGL_CT<0.5.

$$0 < \sum PL\_Nd / \sum GL\_Nd < 0.5 \qquad [ Equation 63 ]$$

ΣPL_Nd is the sum of the refractive indices of the plastic lens, and ΣGL_Nd is the sum of the refractive indices of the glass lens.

$$10 mm < TTL < 50 mm \qquad [ Equation 64 ]$$

TTL (Total track length) means the distance (mm) from the center of the first surface S1 of the first lens 101, 111, and 121 to the surface of the image sensor 300 on the optical axis OA. In Equation 64, the TTL may be set to exceed 10 mm or 20 mm to provide a vehicle optical system. Equation 64 may preferably satisfy the following condition: 30 mm<TTL<45 mm or TD<TTL.

$$2 mm < ImgH \qquad [ Equation 65 ]$$

Equation 65 may set the diagonal size (2*ImgH) of the image sensor 300 and provide an optical system having a vehicle sensor size. Equation 65 may preferably satisfy: 4 mm≤ImgH.

$$2 mm < BFL < 7 mm \qquad [ Equation 66 ]$$

In Equation 66, the BFL (Back focal length) is set to be greater than 2 mm and less than 7 mm, thereby securing the installation space of the optical filter 500 and the cover glass 400, improving the assemblability of the components through the gap between the image sensor 300 and the last lens, and improving the bonding reliability. Equation 66 preferably satisfies: 2.5 mm≤BFL≤3 mm. When the BFL is less than the range of Equation 66, some of the light that proceeds to the image sensor may not be transmitted to the image sensor, which may be a cause of resolution degradation. When the BFL exceeds the range of Equation 66, stray light may be introduced, which may deteriorate the aberration characteristics of the optical system.

$$3 < F < 40 \qquad [ Equation 67 ]$$

Equation 67 can set the overall effective focal length F to suit the vehicle optical system. Equation 69 may satisfy: 10<F<30.

$$FOV < 45 degrees \qquad [ Equation 68 ]$$

In Equation 68, FOV means the field of view (Degree) in the diagonal direction of the optical system 1000, and can provide a vehicle optical system of less than 45 degrees. The FOV may preferably satisfy: 20≤FOV≤40.

$$1 < TTL / CA\_Max < 5 \qquad [ Equation 69 ]$$

CA_Max means the largest effective diameter (mm) among the object-side and sensor-side surfaces of the plurality of lenses, and TTL (Total track length) means the distance (mm) from the apex of the first surface S1 of the first lens to the upper surface of the image sensor 300 on the optical axis OA. Equation 69 can provide an improved vehicle optical system by setting the relationship between the total optical axis length of the optical system and the maximum effective diameter. Equation 69 may preferably satisfy: 1.5<TTL/CA_Max<4.

$$2 < TTL / ImgH < 15 \qquad [ Equation 70 ]$$

Equation 60 can set the total optical axis length (TTL) of the optical system and the diagonal length (ImgH) from the optical axis of the image sensor 300. When the optical system 1000 according to the embodiment satisfies Equation 70, the optical system 1000 may have a TTL for application to the vehicle image sensor 300, thereby providing a more improved image quality. Equation 70 may preferably satisfy: 4<TTL/ImgH≤10.

$$0.1 < BFL / ImgH < 2 \qquad [ Equation 71 ]$$

Equation 71 can set the optical axis distance between the image sensor 300 and the last lens and the diagonal length from the optical axis of the image sensor 300. When the optical system 1000 according to the embodiment satisfies Equation 71, the optical system 1000 can secure the BFL (Back focal length) for applying the size of the vehicle image sensor 300, can set the distance between the last lens and the image sensor 300, and may have good optical characteristics at the center and periphery of the FOV. Equation 71 may preferably satisfy: 0.3<BFL/ImgH<1.

$$5 < TTL / BFL < 20 \qquad [ Equation 72 ]$$

Equation 72 can set the total optical axis length (TTL) of the optical system and the optical axis distance (BFL) between the image sensor 300 and the last lens (unit: mm). When the optical system 1000 according to the embodiment satisfies Equation 72, the optical system 1000 can secure BFL. Equation 72 can preferably satisfy 10<TTL/BFL<20.

$$1 < TTL / F < 3 \qquad [ Equation 73 ]$$

Equation 73 can set the total focal length F and the total optical axis length (TTL) of the optical system 1000. Accordingly, an optical system for a driver assistance system may be provided. Equation 73 may preferably satisfy: 1.5≤TTL/F≤2.8. When the optical system 1000 according to the embodiment satisfies the Equation 73, the optical system 1000 may have an appropriate focal length in the set TTL range, and can provide an optical system that can form an image while maintaining an appropriate focal length even when the temperature changes from low to high temperatures. When it is less than the lower limit of the Equation 75, it is necessary to increase the refractive power of the lenses, so that correction of spherical aberration or distortion aberration becomes difficult, and when it exceeds the upper limit of the Equation 73, the effective diameter or TTL of the lenses becomes longer, which may cause a problem of the enlargement of the photographing lens system.

$$1 < F / BFL < 10 \qquad [ Equation 74 ]$$

Equation 74 may set the total effective focal length F of the optical system 1000 and the optical axis distance (BFL) between the image sensor 300 and the last lens. When the optical system 1000 according to the embodiment satisfies the Equation 74, the optical system 1000 may have a set field of view and an appropriate focal length, and can provide a vehicle optical system. In addition, the optical system 1000 can minimize the distance between the last lens and the image sensor 300, so that it may have good optical characteristics in the periphery portion of the FOV. The Equation 74 may preferably satisfy: 3<F/BFL<8.

$$1 < F / ImgH < 5 \qquad [ Equation 75 ]$$

The Equation 75 can set the total effective focal length (F) of the optical system 1000 and the diagonal length (ImgH) from the optical axis of the image sensor 300. This optical system 1000 may have improved aberration characteristics in the size of the vehicle image sensor 300. Equation 75 may preferably satisfy: 2<F/ImgH<4.1.

$$1 < F / EPD < 5 \qquad [ Equation 76 ]$$

Equation 76 can set the overall effective focal length F and the entrance pupil diameter of the optical system 1000. Accordingly, the overall brightness of the optical system may be controlled. Equation 76 may preferably satisfy: 1<F/EPD<3.

$$0 < BFL / TD < 0.3 \qquad [ Equation 77 ]$$

Equation 77 can set the relationship between the back focal length BFL and the optical axis distance TD of the lenses of the optical system 1000. Accordingly, the resolution of the optical system may be maintained and the overall size may be controlled. Equation 77 may preferably satisfy: 0<BFL/TD<0.2. When the conditional value of BFL/TD is 0.2 or more, since the BFL is designed to be large compared to the TD, the size of the entire optical system becomes large, making it difficult to miniaturize the optical system, and the distance between the seventh lens and the image sensor becomes long, which may increase the amount of unnecessary light between the seventh lens and the image sensor, resulting in a problem of lowering the resolution, such as deterioration of aberration characteristics.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 78 ]$$

In the Equation 78, Z may mean a distance in the direction of the optical axis from an arbitrary position on the aspherical surface to the vertex of the aspherical surface. The Y may mean a distance in the direction perpendicular to the optical axis from an arbitrary position on the aspherical surface to the optical axis. The c may mean the curvature of the lens, and K may mean the conic constant. In addition, A, B, C, D, E, and F may mean aspheric coefficients.

The optical system 1000 according to the embodiment may satisfy at least one or two or more Equations among the Equations 1 to 40. At least one or two or more of the Equations 1 to 40 may satisfy at least one or two or more of the Equations 40 to 77. In this case, the optical system 1000 may have improved optical characteristics, improved resolution, and improved aberration and distortion characteristics. In addition, the optical system 1000 can secure the BFL for applying a vehicle image sensor 300, compensate for the deterioration of optical characteristics due to temperature change, and minimize the gap between the last lens and the image sensor 300, thereby providing good optical performance at the center and periphery of the FOV.

Table 3 shows the items of the Equations described above in the optical system 1000 of the embodiment, including the TTL (mm), BFL, effective focal length F (mm), ImgH (mm), effective diameter CA (mm), thickness (mm), TD (mm), which is the center distance from the first surface S1 to the fourteenth surface S14, the focal lengths F1, F2, F3, F4, F5, F6, and F7 (mm) of each of the first to seventh lenses, the sum of the refractive indices of each lens, the sum of the Abbe numbers of each lens, the sum (mm) of the center thicknesses of each lens, the sum of the center distances between adjacent lenses, the effective diameter, the diagonal FOV (Degree), the edge thickness ET, the focal lengths of the first and second lens groups, the F number, etc. of the optical system 1000.

TABLE 3

| Items | Embodiment 1 | Embodiment 2 | Embodiment 3 |
|---|---|---|---|
| F | 15.137 | 15.133 | 15.000 |
| F1 | −63.819 | −63.771 | −67.709 |
| F2 | 42.527 | 42.854 | 51.301 |
| F3 | 24.845 | 36.053 | 21.324 |
| F4 | 15.930 | 17.763 | 15.151 |
| F5 | −8.678 | −10.520 | −7.841 |
| F6 | 38.205 | 26.794 | 39.604 |
| F7 | −58.766 | −47.824 | −41.255 |
| F_LG1 | 73.760 | 73.559 | −53.004 |
| F_LG2 | 26.829 | 27.846 | 11.510 |
| ET1 | 11.706 | 13.970 | 3.964 |
| ET2 | 1.297 | 1.002 | 4.198 |
| ET3 | 1.298 | 1.172 | 3.258 |
| ET4 | 1.332 | 1.643 | 2.503 |
| ET5 | 2.804 | 2.478 | 4.513 |
| ET6 | 5.213 | 5.948 | 2.078 |
| ET7 | 1.556 | 1.653 | 2.299 |
| F-number | 1.600 | 1.604 | 1.600 |
| ΣNd | 11.534 | 11.534 | 11.739 |
| ΣVd | 356.551 | 356.551 | 340.322 |
| ΣCT | 27.273 | 29.762 | 25.040 |
| ΣCG | 5.981 | 6.638 | 7.335 |
| FOV | 34.475 | 34.426 | 34.168 |
| EPD | 9.461 | 9.436 | 9.375 |
| BFL | 2.700 | 2.600 | 2.500 |
| TD | 33.254 | 36.400 | 32.375 |
| ImgH | 4.626 | 4.626 | 4.630 |
| SD | 18.009 | 20.468 | 21.701 |
| TTL | 35.954 | 39.000 | 34.875 |

| | |
|---|---|
| Image sensor | 3840*2160 |

Table 4 shows the result values for the Equations 1 to 40 described above in the optical system 1000 of the embodiment. Referring to Table 4, the optical system 1000 satisfies at least one, two or more, or three or more of the Equations 1 to 44, and the optical system 1000 may have good optical performance and excellent optical characteristics at the center and periphery portions of the FOV.

TABLE 4

| Equations | | Embodiment 1 | Embodiment 2 | Embodiment 3 |
|---|---|---|---|---|
| 1 | 0 < CT1/CT2 < 9 | 5.096 | 7.500 | 0.727 |
| 2 | (CT7*CA7) < (CT1*CA1) | Satisfaction | Satisfaction | Satisfaction |
| 3 | Pol < 0 | Satisfaction | Satisfaction | Satisfaction |
| 4 | 1.7 < Nd5 < 2.2 | Satisfaction | Satisfaction | Satisfaction |
| 5 | 20 < FOV_H < 40 | 30.00 | 30.00 | 29.800 |
| 6 | L1R1 < 0 | −18.376 | −21.495 | −22.967 |
| 7 | 0.8 < BFL/Max_Sag72 | 2.667 | 2.418 | 2.454 |
| | to Sensor < 3 | | | |
| 8 | 1 < CT1/CT7 < 15 | 8.455 | 10.188 | 1.731 |
| 9 | 1 < CT1/CT6 < 3 | 1.922 | 1.916 | 1.271 |
| 10 | 0 < CT45/CT6 < 5 | 0.787 | 0.643 | 2.606 |
| 11 | 0 < \|L2R1/L4R2\| < 1 | 0.141 | 0.301 | 0.800 |
| 12 | 0 < (CT45 − ET45) < 2 | 1.088 | 1.079 | 1.011 |
| 13 | 0 < CA11/CA31 < 2 | 1.120 | 1.115 | 0.947 |
| 14 | 0 < CA72/CA42 < 2 | 0.885 | 0.841 | 0.817 |
| 15 | 0 < CA12/CA21 < 2 | 1.042 | 1.032 | 1.049 |
| 16 | 1 < CA1/CA6 < 2 | 1.575 | 1.136 | 1.443 |
| 17 | 1 < CA41/CA52 < 2 | 1.316 | 1.241 | 1.127 |
| 18 | 0 < CA52/CA61 < 2 | 0.993 | 0.953 | 0.986 |
| 19 | 1 < SSL CA Aver/ | 1.345 | 1.309 | 1.370 |
| | ASL CA Aver < 1.5 | | | |
| 20 | 0 < SSL Nd Aver/ | 1.057 | 1.057 | 0.991 |
| | ASL Nd Aver < 1.60 | | | |
| 21 | CA7 < (ImgH*2) | Satisfaction | Satisfaction | Satisfaction |
| 22 | 0 < CT7/CG6 < 3 | Satisfaction | Satisfaction | Satisfaction |
| 23 | 0 < \|F1/F\| < 20 | 4.216 | 4.214 | 4.514 |
| 24 | 0 < \| F5 /F6 \| < 1 | 0.227 | 0.393 | 0.198 |
| 25 | 0 < \| F5 /F7 \| < 1 | 0.148 | 0.220 | 0.190 |
| 26 | 0 < \| F6/F1 \| < 2 | 0.599 | 0.420 | 0.747 |
| 27 | 10 < L7R1/CT7 | Satisfaction | Satisfaction | Satisfaction |
| 28 | L5R2/L7R1 < 1 | Satisfaction | Satisfaction | Satisfaction |
| 29 | L1R1*L1R2 > 0 | Satisfaction | Satisfaction | Satisfaction |
| 30 | 0 < L5R1/L4R2 < 2 | Satisfaction | Satisfaction | Satisfaction |
| 31 | 1 < L6R2/L6R1 | 2.515 | 2.006 | 8.490 |
| 32 | 0 < CT_Max/CG_Max < 5 | 0.189 | 0.170 | 2.039 |
| 33 | 1 < ΣCT/ΣCG < 7 | 4.560 | 4.483 | 3.414 |
| 34 | 8 < ΣNd < 30 | 11.534 | 11.534 | 11.739 |
| 35 | 10 < ΣVd/ΣNd < 50 | 30.912 | 30.912 | 28.991 |
| 36 | Distortion < 2 | Satisfaction | Satisfaction | Satisfaction |
| 37 | 0 < ΣCT/ΣET < 2 | 1.082 | 1.068 | 1.098 |
| 38 | 1 < CA11/CA_Min < 5 | 1.602 | 1.603 | 1.529 |
| 39 | 1 < CA_Max/CA_Min < 5 | 1.602 | 1.603 | 1.626 |
| 40 | 1 < CA_Max/CA_Aver < 3 | 1.251 | 1.241 | 1.220 |

Table 5 shows the result values for the Equations 41 to 77 described above in the optical system 1000 of the embodiment. Referring to Table 5, it may be seen that the optical system 1000 satisfies at least one, two or more, or three or more of the Equations 40 to 77. The optical system 1000 may have good optical performance at the center and periphery portions of the FOV and may have excellent optical characteristics.

TABLE 5

| Equations | | Embodiment 1 | Embodiment 2 | Embodiment 3 |
|---|---|---|---|---|
| 41 | 0.5 < CA_Min/CA_Aver < 2 | 0.781 | 0.774 | 0.750 |
| 42 | 1 < CA_Max/(2*ImgH) < 3 | 1.490 | 1.503 | 1.441 |
| 43 | 1 < TD/CA_Max < 4 | 2.412 | 2.617 | 2.427 |
| 44 | 1 < F/CA61 < 10 | 1.717 | 1.499 | 1.695 |
| 45 | 0 < F/\|L1R1\| < 1 | 0.824 | 0.704 | 0.653 |
| 46 | Max (CT/ET) < 3 | 0.939 | 0.948 | 1.190 |
| 47 | 0 < EPD/\|L1R1\| < 1 | 0.515 | 0.439 | 0.408 |
| 48 | −10 < F1/F3 < 0 | −2.569 | −1.769 | −3.175 |
| 49 | Po4 * Po5 < 0 | Satisfaction | Satisfaction | Satisfaction |
| 50 | 15 < Vd4-Vd5 < 60 | 30.126 | 30.126 | 24.938 |
| 51 | 0 < F6/F < 5 | 2.524 | 1.771 | 2.640 |
| 52 | 0 < EPD/ImgH/FOV < 0.2 | 0.0142 | 0.0142 | 0.0593 |
| 53 | 5 < FOV/F# < 40 | 21.547 | 21.465 | 21.355 |
| 54 | 1 < ΣGL_CT/F# < 20 | 16.233 | 17.746 | 7.406 |
| 55 | 0 < ΣPL_CT/F# < 1 | 0.813 | 0.811 | 5.406 |
| 56 | 1 < ΣGL_Nd/F# < 10 | 6.166 | 6.152 | 5.336 |
| 57 | 1 < ΣPL_Nd/F# < 2 | 1.043 | 1.040 | 2.001 |
| 58 | Max_Sag62 < Max_Sag52 | Satisfaction | Satisfaction | Satisfaction |
| 59 | \|Max_Sag62\| < Max_Sag72 | Satisfaction | Satisfaction | Satisfaction |
| 60 | 1 < nGL/nASL < 4 | 3.000 | 6.000 | 2.500 |
| 61 | 1 < nGL/nPL | 6.000 | 6.000 | 2.500 |
| 62 | 0 < ΣPL_CT/ΣGL_CT < 0.5 | Satisfaction | Satisfaction | Satisfaction |
| 63 | 0 < ΣPL_Nd/ΣGL_Nd < 0.5 | Satisfaction | Satisfaction | Satisfaction |
| 64 | 10 < TTL < 50 | 35.954 | 39.000 | 34.875 |
| 65 | 2 < ImgH | 4.626 | 4.626 | 4.630 |
| 66 | 2 < BFL < 7 | 2.700 | 2.600 | 2.500 |
| 67 | 3 < F < 40 | 15.137 | 15.133 | 15.000 |
| 68 | FOV < 45 | 34.475 | 34.426 | 34.168 |
| 69 | 1 < TTL/CA_max < 5 | 2.608 | 2.804 | 2.614 |
| 70 | 2 < TTL/ImgH < 15 | 7.772 | 8.430 | 7.532 |
| 71 | 0.1 < BFL/ImgH < 2 | 0.584 | 0.562 | 0.540 |
| 72 | 5 < TTL/BFL < 20 | 13.316 | 15.000 | 13.950 |
| 73 | 1 < TTL/F < 3 | 2.375 | 2.577 | 2.325 |
| 74 | 1 < F/BFL < 10 | 5.606 | 5.821 | 6.000 |
| 75 | 1 < F/ImgH < 5 | 3.272 | 3.271 | 3.240 |
| 76 | 1 < F/EPD < 5 | 1.600 | 1.604 | 1.600 |
| 77 | 0 < BFL/TD < 0.3 | 0.0812 | 0.0714 | 0.0772 |

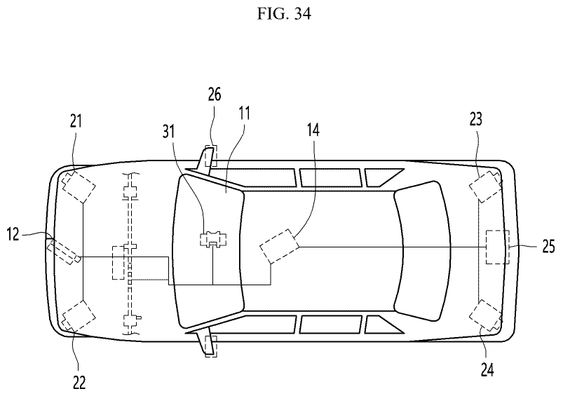

FIG. 34 is an example of a plan view of a vehicle to which a camera module or optical system according to an embodiment of the invention is applied.

Referring to FIG. 34, a vehicle camera system according to an embodiment of the invention includes an image generating unit 11, a first information generating unit 12, a second information generating unit 21, 22, 23, 24, 25, and 26, and a control unit 14. The image generating unit 11 may include at least one camera module 31 disposed in the vehicle, and may capture images of the front of the vehicle and/or the driver to generate images of the front or interior of the vehicle. The image generating unit 11 may capture images of the front of the vehicle as well as the surroundings of the vehicle in one or more directions using the camera module 31, to generate images of the surroundings of the vehicle. Here, the front and surrounding images may be digital images, and may include color images, black and white images, and infrared images. In addition, the front and surrounding images may include still images and moving images. The image generating unit 11 provides the driver image, the front image, and the surrounding image to the control unit 14. Next, the first information generating unit 12 may include at least one radar and/or camera placed in the own vehicle, and detects the front of the own vehicle to generate the first detection information. Specifically, the first information generating unit 12 is placed in the own vehicle and detects the position and speed of vehicles located in front of the own vehicle, whether there is a pedestrian, and the position, etc. to generate the first detection information.

Using the first detection information generated by the first information generating unit 12, the distance between the own vehicle and the vehicle in front may be controlled to be maintained at a constant level, and the stability of vehicle operation may be increased in specific cases set in advance, such as when the driver wants to change the driving lane of the own vehicle or when parking in reverse. The first information generating unit 12 provides the first detection information to the control unit 14. The second information generating unit 21, 22, 23, 24, 25, and 26 detects each side of the own vehicle based on the front image generated by the image generating unit 11 and the first detection information generated by the first information generating unit 12 to generate the second detection information. Specifically, the second information generating unit 21, 22, 23, 24, 25, and 26 may include at least one radar and/or camera disposed on the own vehicle, and may detect the position and speed of vehicles located on the side of the own vehicle or capture images. Here, the second information generating unit 21, 22, 23, 24, 25, and 26 may be disposed on each of the front corners, side mirrors, and the rear center and rear corners of the own vehicle.

At least one information generating unit of these vehicle camera systems may be equipped with an optical system and a camera module having the same as described in the above-described embodiments, and may provide or process information acquired through the front, rear, each side, or corner region of the vehicle to a user to enable autonomous driving or to protect the vehicle and objects from surrounding safety.

The optical system of the camera module according to the embodiment of the invention may be installed in multiple units in a vehicle to enhance safety regulations, autonomous driving functions, and increase convenience. The optical system of the camera module is applied in a vehicle as a component for control such as a lane keeping assistance system (LKAS), a lane departure warning system (LDWS), and a driver monitoring system (DMS). This vehicle camera module can implement stable optical performance even under ambient temperature changes and can provide a module with price competitiveness, thereby ensuring the reliability of vehicle components.

Features, structures, effects, etc. described in the embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It may be seen that various modifications and applications that have not been made are possible. For example, each component specifically shown in the embodiment may be implemented by modification. And the differences related to these modifications and applications should be construed as being included in the scope of the invention defined in the appended claims.

1. An optical system comprising:
first to seventh lenses aligned along an optical axis from an object side toward a sensor side,
wherein a refractive power of the first lens is negative,
wherein a composite refractive power of the third to seventh lenses is positive,
wherein the first lens has a meniscus shape convex toward the sensor side on the optical axis,
wherein a center thickness of the first lens is greater than a center thickness of each of the second to seventh lenses,
wherein the first to seventh lenses include a plurality of spherical lenses and a plurality of aspherical lenses,
wherein the spherical lenses are lenses whose object-side surface and sensor-side surface are spherical on the optical axis,
wherein the aspherical lenses are lenses whose object-side surface and sensor-side surface are aspherical on the optical axis, and
wherein at least one of the plurality of aspherical lenses is made of a different material from the spherical lens.

2. The optical system of claim 1, wherein a number of spherical lenses is at least twice a number of aspherical lenses.

3. The optical system of claim 1, wherein at least one of the plurality of aspherical lenses is made of a same glass material as the spherical lenses, and at least one other of the plurality of aspherical lenses is made of a plastic material.

4. The optical system of claim 1, wherein the first to sixth lenses are made of glass, and
wherein the seventh lens is made of a plastic material.

5. The optical system of claim 4, wherein the first to fifth lenses are spherical lenses, and
wherein the sixth and seventh lenses are aspherical lenses.

6. The optical system of claim 1,
wherein an effective diameter of the first lens is larger than effective diameters of the fourth to seventh lenses.

7. The optical system of claim 1, comprising:
an aperture stop disposed on a periphery between the second lens and the third lens.

8. The optical system of claim 1,
wherein a sensor-side surface of the fourth lens and an object-side surface of the fifth lens are bonded.

9. The optical system of claim 1,
wherein a center distance between an i-th lens and an i+1 lens is CGi,
wherein a center thickness of the i-th lens is CTi,
wherein a value of CTi/CGi is minimum when i is 6, and
wherein a value of CTi/CGi is maximum when i is 1.

10. The optical system of claim 1,
wherein the center thickness of the first lens is greater than a sum of center distances of two adjacent lenses among the second to seventh lenses.

11. An optical system comprising:
an image sensor; and
an optical system including first to seventh lenses aligned along an optical axis from an object side toward a sensor side,
wherein the first lens has negative refractive power,
wherein an object-side surface of the first lens is concave on the optical axis,
wherein a composite refractive power of the second to seventh lenses is positive,
wherein at least one of the sixth lens and the seventh lens is a plastic lens,
wherein a lens closest to the plastic lens is made of glass, and
wherein the glass lens closest to the plastic lens is a lens having a maximum difference in effective diameter between an object-side surface and a sensor-side surface of each of the first to seventh lenses.

12. The optical system of claim 11,
wherein the lens having a maximum difference in effective diameter between the object-side surface and the sensor-side surface is the fifth lens.

13. The optical system of claim 11,
wherein the sensor-side surface of the first lens is convex on the optical axis,
wherein the object-side surface and the sensor-side surface of the first lens have aspherical shapes.

14. The optical system of claim 13,
wherein a surface having a minimum absolute value of a curvature radius on the optical axis among the object-side surface and the sensor-side surface of each of the first lens to the seventh lens is the sensor-side surface of the fifth lens.

15. The optical system of claim 1,
wherein the object-side surface of the seventh lens has a maximum absolute value of a curvature radius of the object-side surface and the sensor-side surface of each of the first lens to the seventh lens.

16. The optical system of claim 11,
wherein the sixth lens and the seventh lens are made of a plastic material,
wherein an average of curvature radii of the object-side surface and the sensor-side surface of the sixth lens is larger than an absolute value of average curvature radii of the object-side surface and the sensor-side surface of each of the first to fifth lenses.

17. The optical system of claim 1,
wherein the sixth lens and the seventh lens are made of a plastic material,
wherein an average of curvature radii of an object-side surface and a sensor-side surface of each of the sixth and seventh lenses is larger than an absolute value of average curvature radii of an object-side surface and a sensor-side surface of each of the first to fifth lenses.

18. A camera module comprising:
an image sensor; and
first to seventh lenses aligned along an optical axis from an object side toward a sensor side;
an aperture stop disposed between spherical lenses of the first to seventh lenses; and
an optical filter between the seventh lens and the image sensor,
wherein the first lens has a meniscus shape convex toward the sensor on the optical axis,
wherein a refractive power of the first and seventh lenses is negative,
wherein a composite refractive power of the third to seventh lenses is positive,
wherein the first to seventh lenses have at least one aspherical lens,
wherein there is a cemented lens disposed between the aperture stop and the image sensor in the first to seventh lenses and in which two different lenses are bonded, and
wherein the aspherical lens is disposed between the cemented lens and the image sensor.

19. The optical system of claim 1,
wherein an absolute value of a curvature radius of a sensor-side surface of the fifth lens is larger than an absolute value of curvature radii of object-side and sensor-side surfaces of the first to fourth lenses.

20. The optical system of claim 1,
wherein a curvature radius of a sensor-side surface of the fifth lens and a curvature radius of an object-side surface of the sixth lens are equal to each other.
